(19) United States
(12) Patent Application Publication
(10) Pub. No.: US 2025/0348568 A1
(43) Pub. Date: Nov. 13, 2025

(54) Devices, Methods, and Graphical User Interfaces for Protecting Applications

(71) Applicant: Apple Inc., Cupertino, CA (US)

(72) Inventors: Donald W. Pitschel, San Francisco, CA (US); Elizabeth C. Cranfill, San Francisco, CA (US); Candice L. Roe, Palo Alto, CA (US); Grant R. Paul, San Francisco, CA (US); Kevin C. Milden, San Jose, CA (US); Peter W. Roman, Los Altos, CA (US); William M. Tyler, San Francisco, CA (US); Russell E. Snediker, Aptos, CA (US); Ryan D. Shelby, Mountain View, CA (US); Tiffany S. Jon, San Jose, CA (US)

(21) Appl. No.: 19/095,494

(22) Filed: Mar. 31, 2025

Related U.S. Application Data
(60) Provisional application No. 63/646,424, filed on May 13, 2024.
(60) Provisional application No. 63/657,072, filed on Jun. 6, 2024.

(51) Int. Cl. G06F 21/32; G06F 3/0481; G06F 3/0484; G06F 3/0487; G06F 21/62

(52) U.S. Cl. CPC G06F 21/32; G06F 3/0481; G06F 3/0484; G06F 21/62; G06F 3/0487

(57) ABSTRACT

A computer system, in response to detecting a request to access content corresponding to a first application: in accordance with a determination that the first application is in a locked state: requests authentication information from a user of the computer system; and in response to receiving, via the one or more input devices, the authentication information and in accordance with a determination that the received authentication information is consistent with authorized authentication information, allows access to the content corresponding to the first application without opening the first application; in accordance with a determination that the first application is in an unlocked state, allows access to the content corresponding to the first application without requesting the authentication information from the user of the computer system and without opening the first application.

### RELATED APPLICATIONS

This application claims priority to U.S. Provisional Patent Application No. 63/657,072, filed Jun. 6, 2024, and to U.S. Provisional Patent Application No. 63/646,424, filed May 13, 2024, each of which is incorporated by reference in its entirety.

### TECHNICAL FIELD

This relates generally to electronic devices with touch-sensitive surfaces, including but not limited to electronic devices with touch-sensitive surfaces that include applications.

### BACKGROUND

Computers and other electronic computing devices include many applications. Many electronic computing devices provide a way to authenticate a user, such as via passwords, before granting the user with access to the device.

### SUMMARY

Using passwords to gain access to an electronic device provides a first level of security, but does not provide an additional level of security to one or more particular applications, for example, by allowing the user to require authentication before the user is granted access to the application. Further, there is a need to provide the user with an option to hide one or more applications from one or more system-level functions in order to keep the user's content and data more secure.

The above deficiencies and other problems associated with user interfaces for electronic devices (or more generally, computer systems) with touch-sensitive surfaces are reduced or eliminated by the disclosed devices. In some embodiments, the device is a desktop computer. In some embodiments, the device is portable (e.g., a notebook computer, tablet computer, or handheld device). In some embodiments, the device is a personal electronic device (e.g., a wearable electronic device, such as a watch). In some embodiments, the device has a touchpad. In some embodiments, the device has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the device has a graphical user interface (GUI), one or more processors, memory and one or more modules, programs or sets of instructions stored in the memory for performing multiple functions. In some embodiments, the user interacts with the GUI primarily through stylus and/or finger contacts and gestures on the touch-sensitive surface. In some embodiments, the functions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a non-transitory computer readable storage medium or other computer program product configured for execution by one or more processors.

In accordance with some embodiments, a method is performed at a computer system with one or more input devices and one or more output generation components. The method includes detecting, via the one or more input devices, one or more inputs corresponding to a request from outside of a first application to access content corresponding to the first application. The method includes, in response to detecting the request to access the content corresponding to the first application: in accordance with a determination that the first application is in a locked state: requesting authentication information from a user of the computer system; and in response to receiving, via the one or more input devices, the authentication information and in accordance with a determination that the received authentication information is consistent with authorized authentication information, allowing access to the content corresponding to the first application without opening the first application; in accordance with a determination that the first application is in an unlocked state, allowing access to the content corresponding to the first application without requesting the authentication information from the user of the computer system and without opening the first application.

In accordance with some embodiments, a method is performed at a computer system with one or more input devices and one or more output generation components. The method includes detecting, via the one or more input devices, one or more inputs corresponding to a request to perform a system operation for which content corresponding to a first application is contextually relevant. The method includes, in response to detecting the one or more inputs corresponding to a request to perform the system operation, outputting, via the one or more output generation components, a result of the system operation, including: in accordance with a determination that the first application is in a hidden state, outputting, via the one or more output generation components, a result of the system operation using content from one or more sources other than the first application without using the content corresponding to the first application; and in accordance with a determination that the first application is in an unhidden state, outputting, via the one or more output generation components, a result of the system operation using content from the one or more sources other than the first application and also using the content corresponding to the first application.

In accordance with some embodiments, an electronic device (or computer system more generally) includes a display, a touch-sensitive surface, optionally one or more sensors to detect intensities of contacts with the touch-sensitive surface, optionally one or more tactile output generators, one or more processors, and memory storing one or more programs; the one or more programs are configured to be executed by the one or more processors and the one or more programs include instructions for performing or causing performance of the operations of any of the methods described herein. In accordance with some embodiments, a computer readable storage medium has stored therein instructions that, when executed by an electronic device with a display, a touch-sensitive surface, optionally one or more sensors to detect intensities of contacts with the touch-sensitive surface, and optionally one or more tactile output generators, cause the device to perform or cause performance of the operations of any of the methods described herein. In accordance with some embodiments, a graphical user interface on an electronic device with a display, a touch-sensitive surface, optionally one or more sensors to detect intensities of contacts with the touch-sensitive surface, optionally one or more tactile output generators, a memory, and one or more processors to execute one or more programs stored in the memory includes one or more of the elements displayed in any of the methods described herein, which are updated in response to inputs, as described in any of the methods described herein. In accordance with some embodiments, an electronic device includes: a display, a touch-sensitive surface, optionally one or more sensors to detect intensities of contacts with the touch-sensitive surface, and optionally one or more tactile output generators; and means for performing or causing performance of the operations of any of the methods described herein. In accordance with some embodiments, an information processing apparatus, for use in an electronic device with a display, a touch-sensitive surface, optionally one or more sensors to detect intensities of contacts with the touch-sensitive surface, and optionally one or more tactile output generators, includes means for performing or causing performance of the operations of any of the methods described herein.

Thus, electronic devices and other computer systems with displays, touch-sensitive surfaces, optionally one or more sensors to detect intensities of contacts with the touch-sensitive surface, optionally one or more tactile output generators, optionally one or more device orientation sensors, and optionally an audio system, are provided with improved methods and interfaces for providing increased privacy and security to applications, thereby increasing the effectiveness, efficiency, and user satisfaction with such devices. Such methods and interfaces may complement or replace conventional methods for providing increased privacy and security to applications.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

Figure (“FIG.”) 1A is a block diagram illustrating a portable multifunction device with a touch-sensitive display in accordance with some embodiments.

FIG. 1B is a block diagram illustrating example components for event handling in accordance with some embodiments.

FIG. 2 illustrates a portable multifunction device having a touch screen in accordance with some embodiments.

FIG. 3A is a block diagram of an example multifunction device with a display and a touch-sensitive surface in accordance with some embodiments.

FIGS. 3B-3G illustrate the use of Application Programming Interfaces (APIs) to perform operations.

FIG. 4A illustrates an example user interface for a menu of applications on a portable multifunction device in accordance with some embodiments.

FIG. 4B illustrates an example user interface for a multifunction device with a touch-sensitive surface that is separate from the display in accordance with some embodiments.

FIGS. 4C1-4C2 illustrate an example state diagram of navigation between various user interfaces of the multifunction devices in accordance with some embodiments.

FIGS. 5A-5F and 6A-6G illustrate example user interfaces for accessing content associated with a locked application from another application in accordance with some embodiments.

FIGS. 7A-7T illustrate example user interfaces for locking an application and viewing notifications associated with locked applications in accordance with some embodiments.

FIG. 8A-8D illustrate example user interfaces for unlocking a file in accordance with some embodiments.

FIGS. 9A-9F illustrate example user interfaces for using a virtual assistant to access a locked application in accordance with some embodiments.

FIGS. 10A-10AE illustrate example user interfaces for interacting with hidden applications in accordance with some embodiments.

FIGS. 11A-11F illustrate example user interfaces for interacting with settings for hidden applications in accordance with some embodiments.

FIGS. 12A-12G illustrate example user interfaces for unhiding hidden applications in accordance with some embodiments.

FIGS. 13A-13F illustrate a flow diagram of a process for requiring authentication for a locked application in accordance with some embodiments.

FIGS. 14A-14J illustrate a flow diagram of a process for determining whether or not to provide a system function with access an application based on its hidden state in accordance with some embodiments.

### DESCRIPTION OF EMBODIMENTS

A computer system is provided for enabling a user to lock an application of the computer system, whereby a locked application requires authentication before allowing the user and/or other applications of the computer system to access content of the locked application. For example, in response to detecting a request from a user and/or from an application of the computer system to access (e.g., view and/or control) content that is stored by or otherwise associated with a locked application, the computer system initiates an authentication process to authenticate the user before enabling the user and/or application of the computer system to access the content of the locked application. Additionally, a computer system is provided for enabling the user to hide one or more applications of the computer system, whereby a hidden application requires authentication before allowing the user, other applications, and/or one or more system functions of the computer system to access content of the hidden application. For example, one or more system functions are unable to access the content of the hidden application such that, upon execution of the one or more system functions, the results of the one or more system functions do not include results that use and/or are based on the hidden application.

The processes described below enhance the operability of the devices and make the user-device interfaces more efficient (e.g., by helping the user to provide proper inputs and reducing user mistakes when operating/interacting with the device) through various techniques, including by providing improved visual, audio, and/or tactile feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

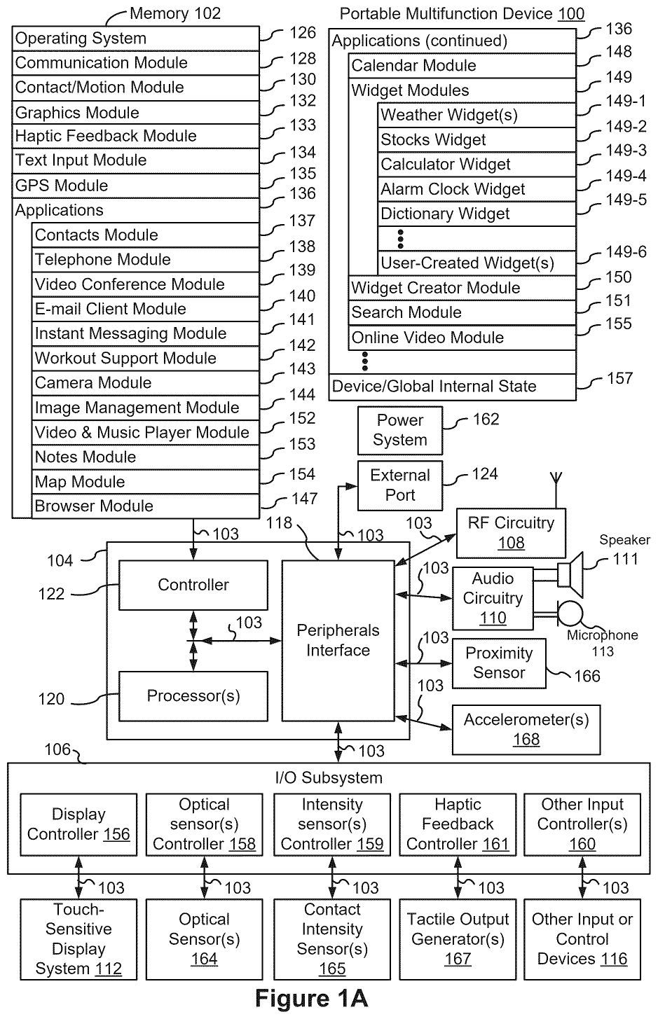

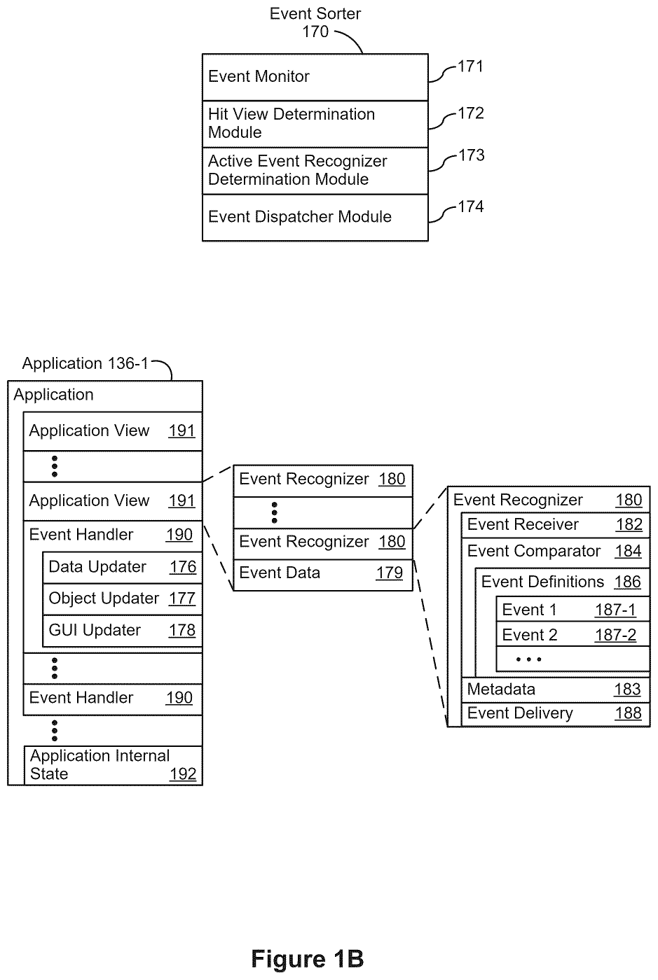

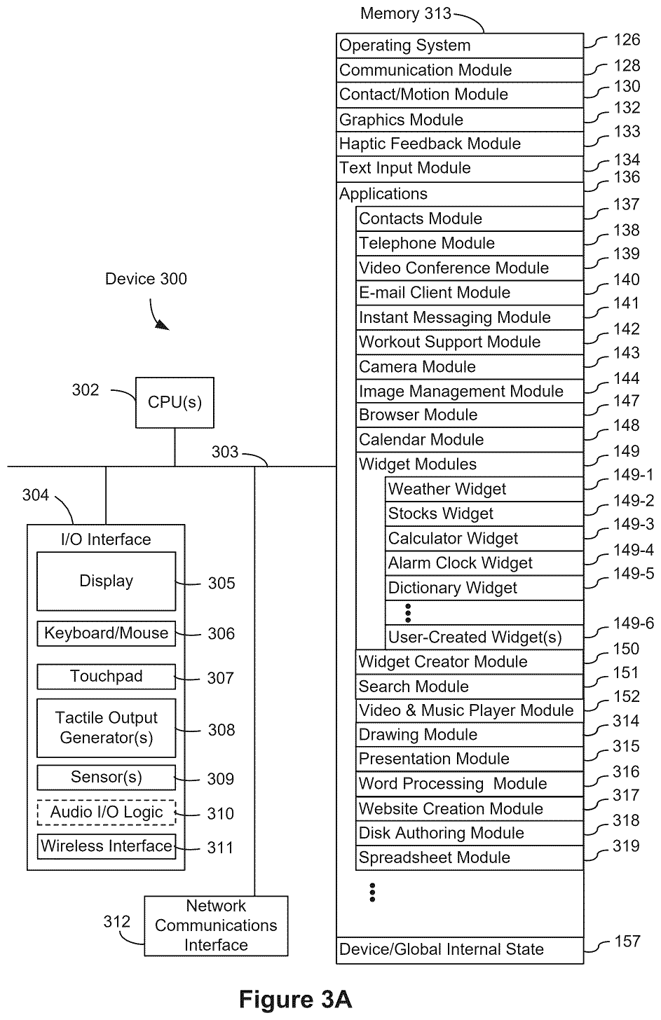

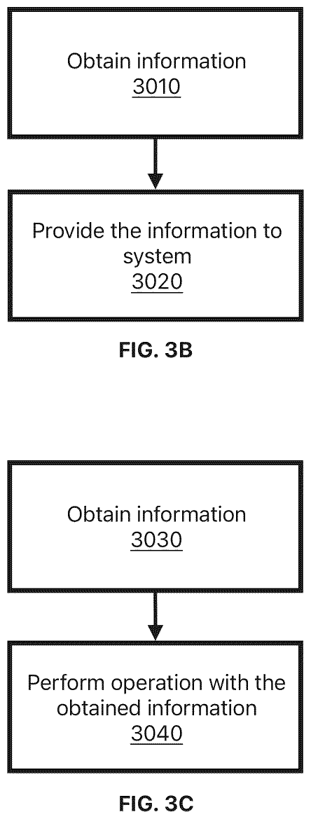

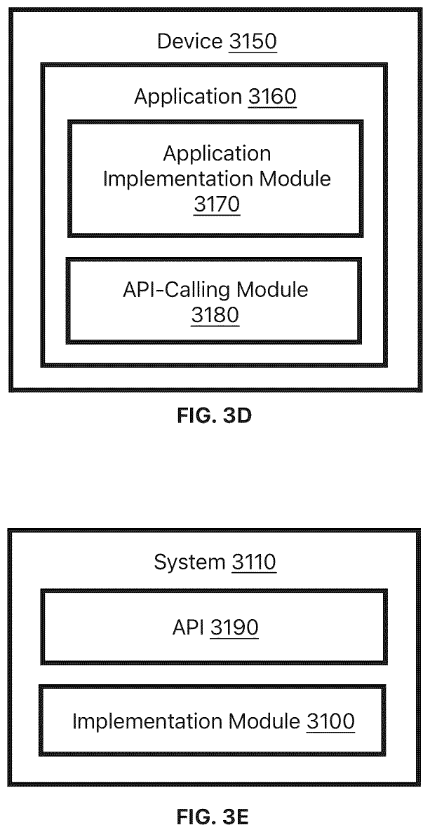

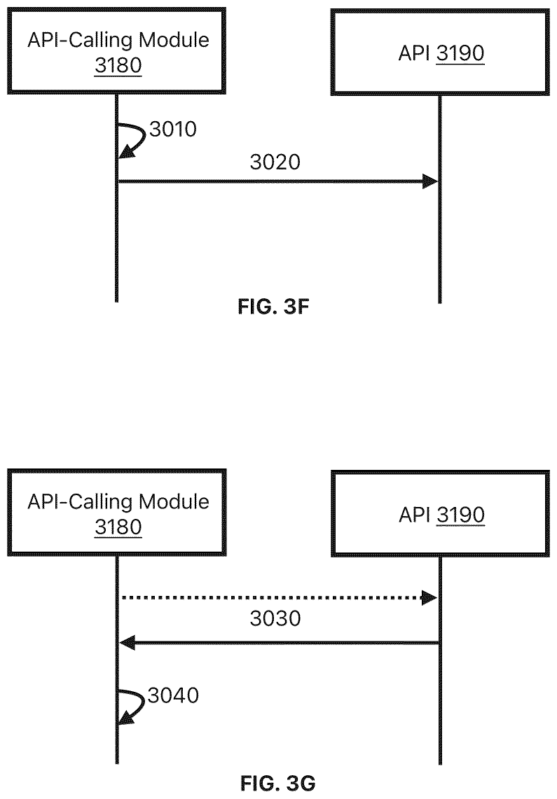

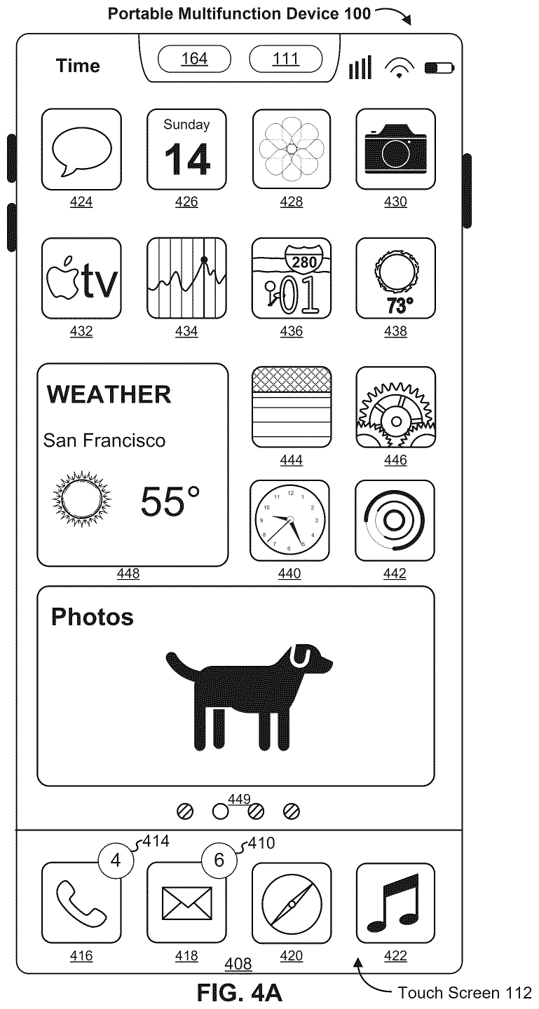

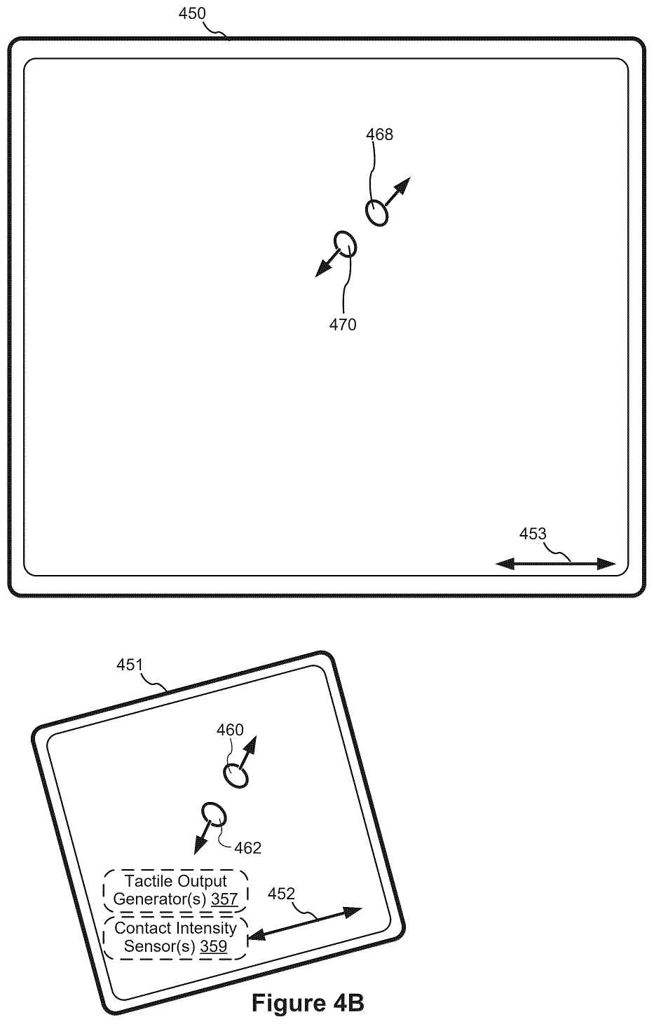

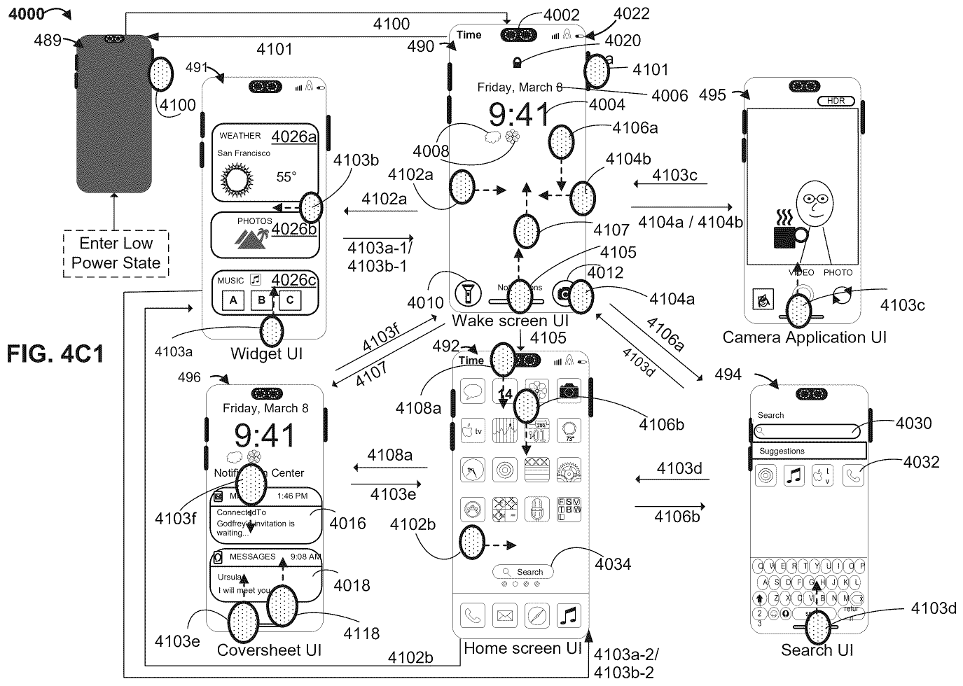

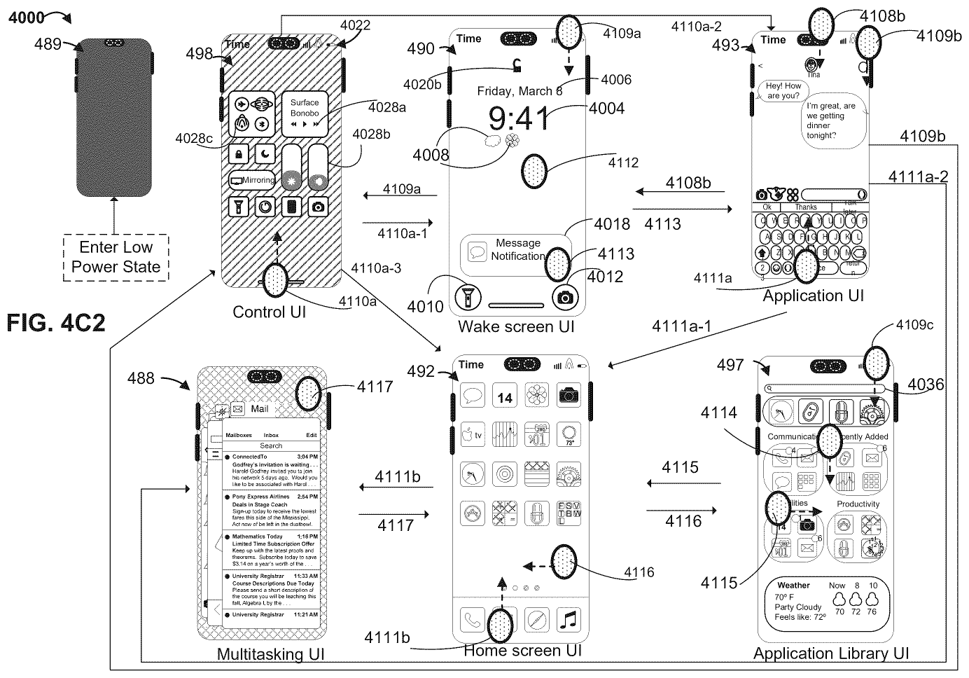

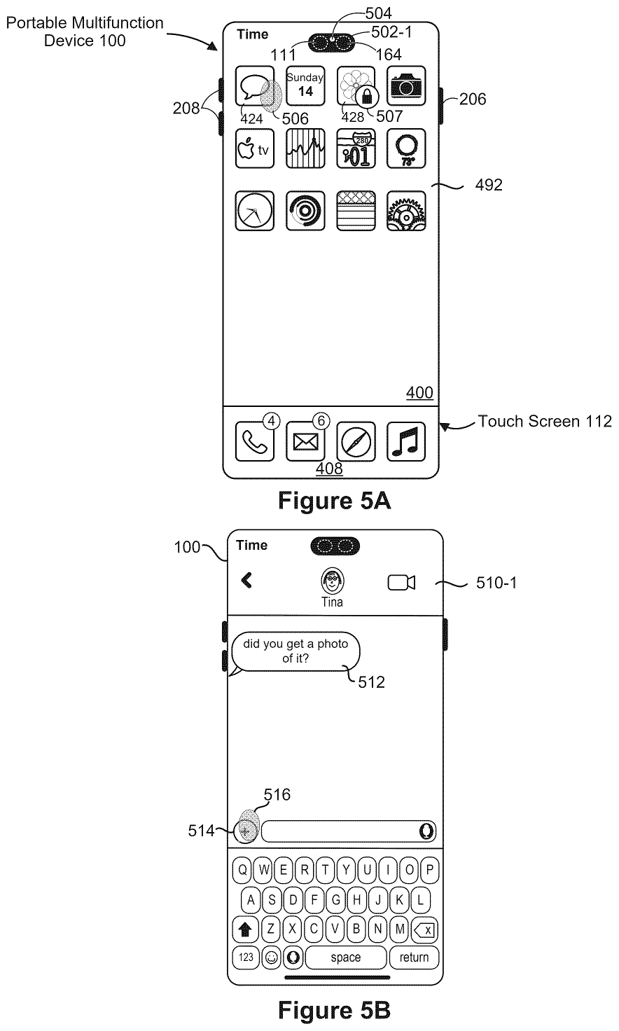

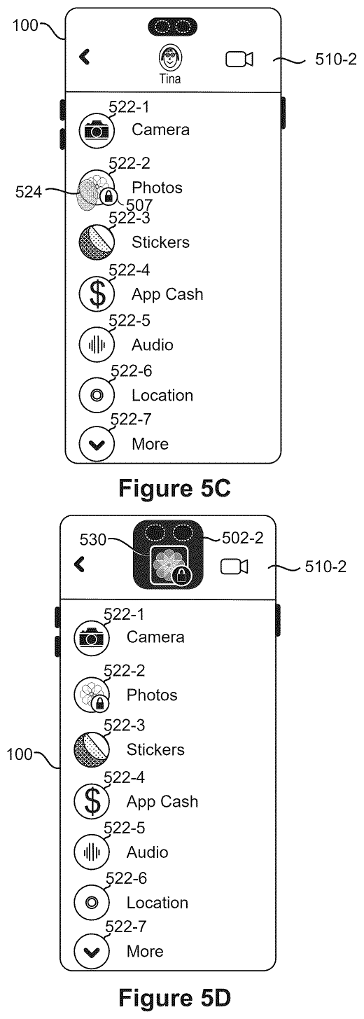

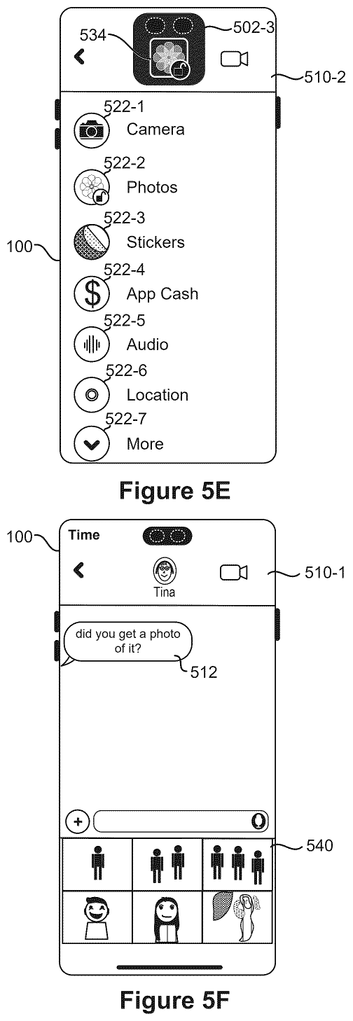

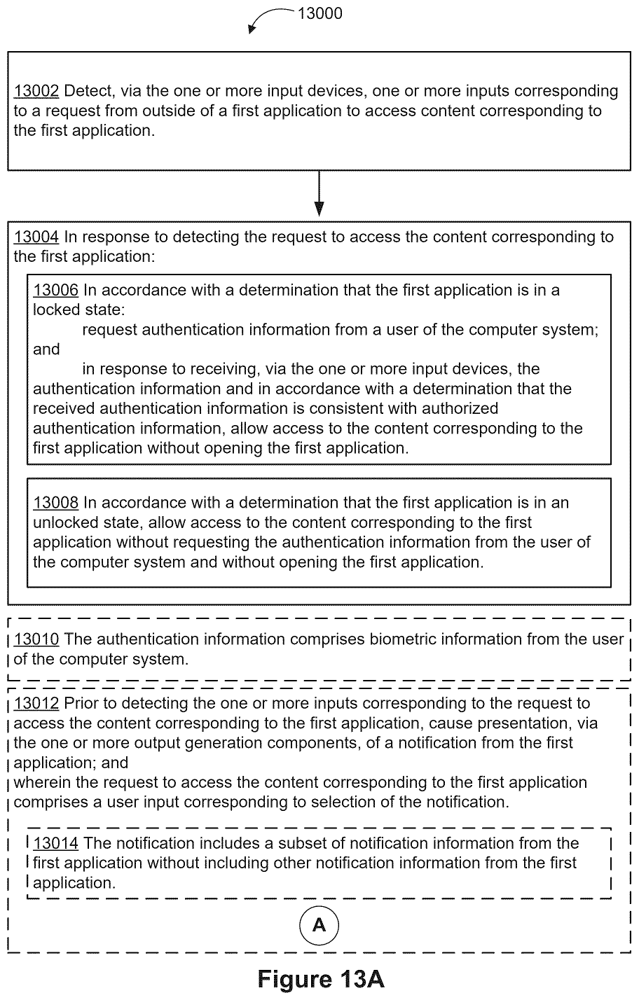

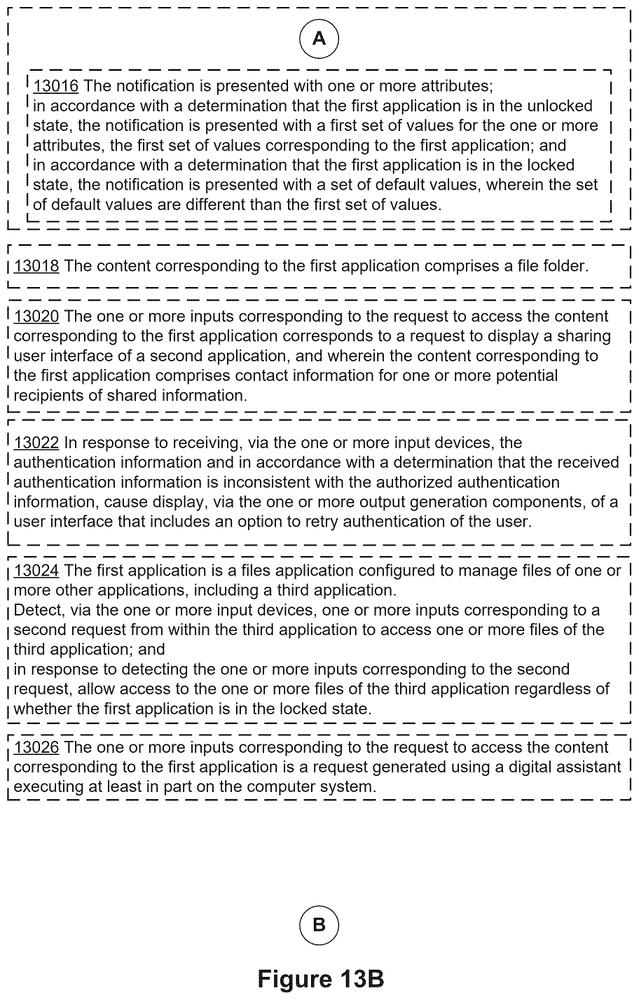

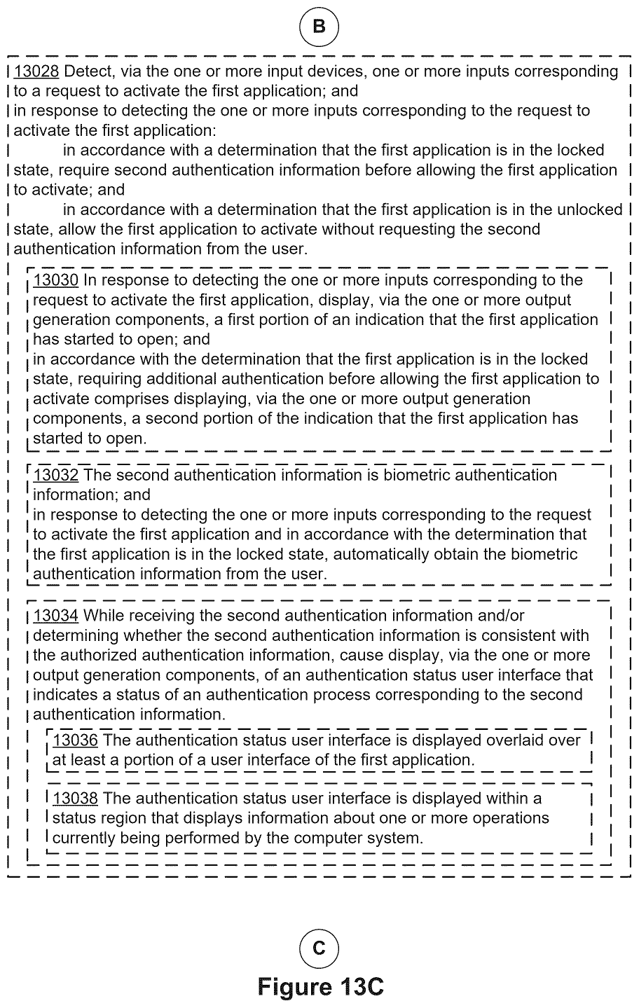

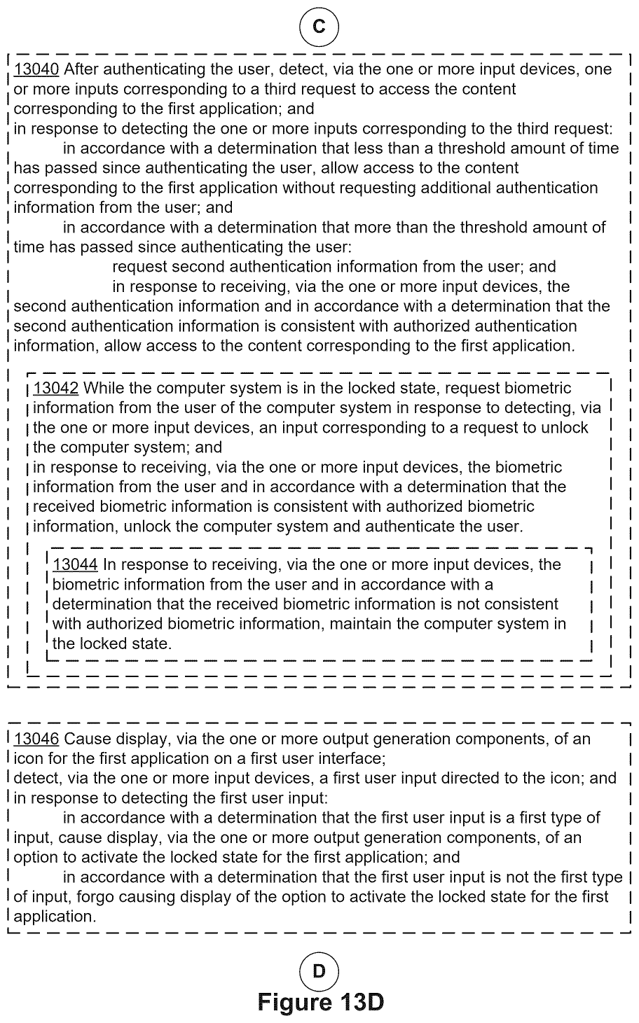

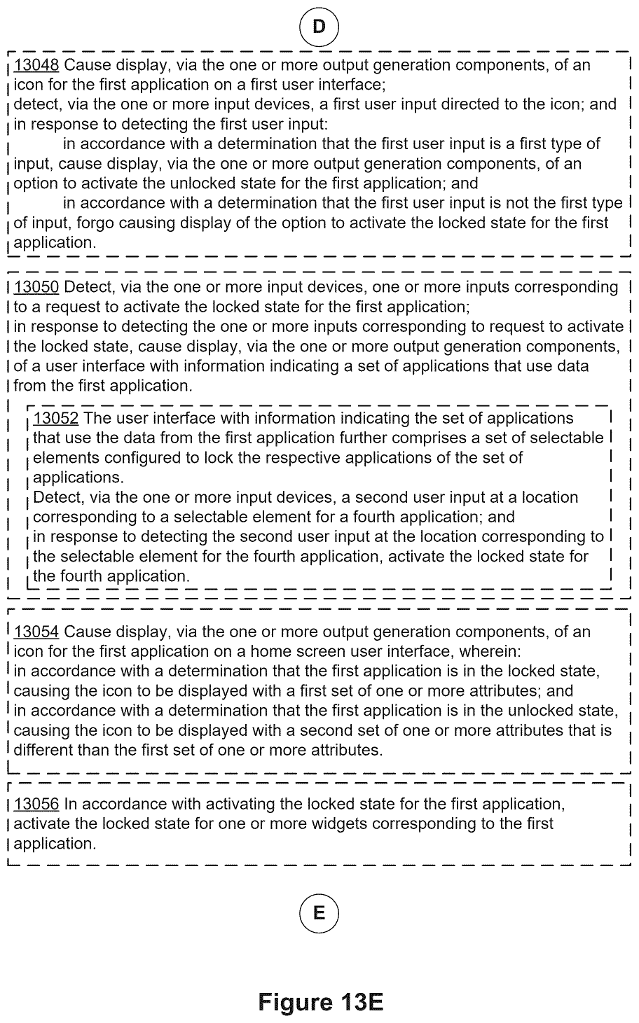

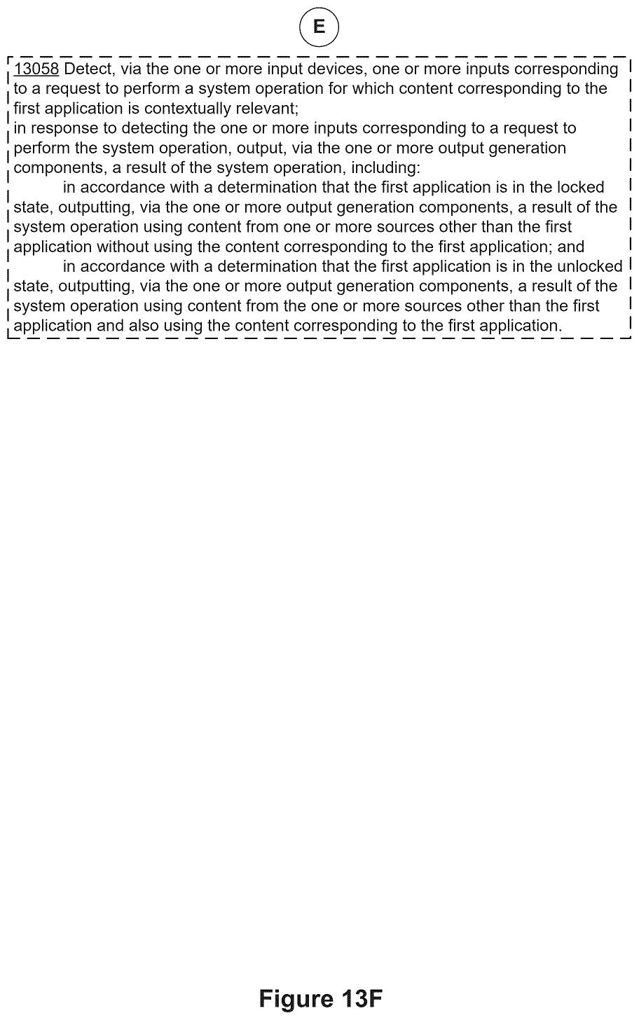

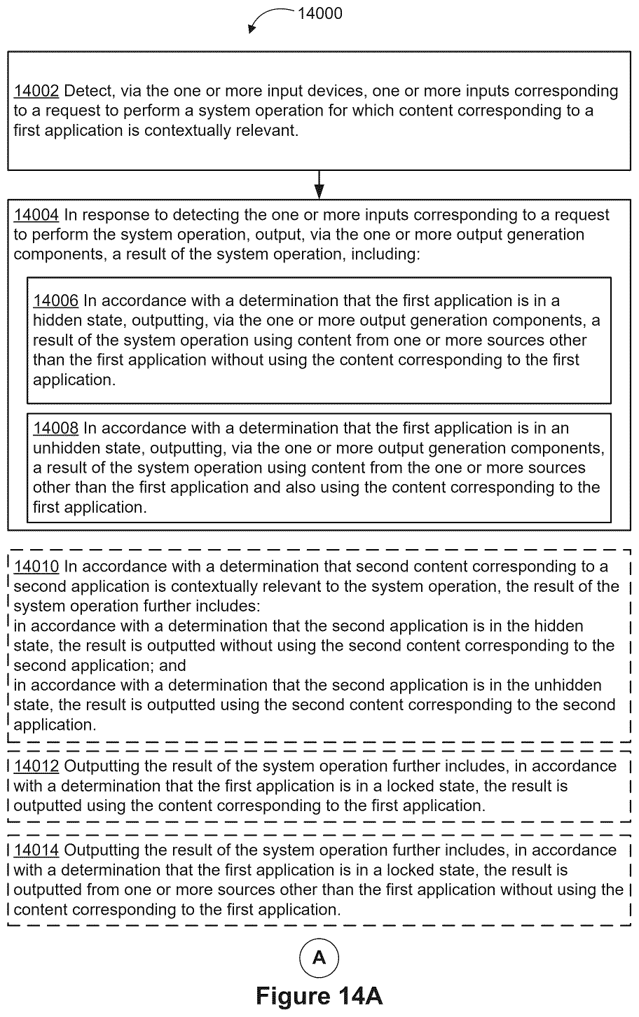

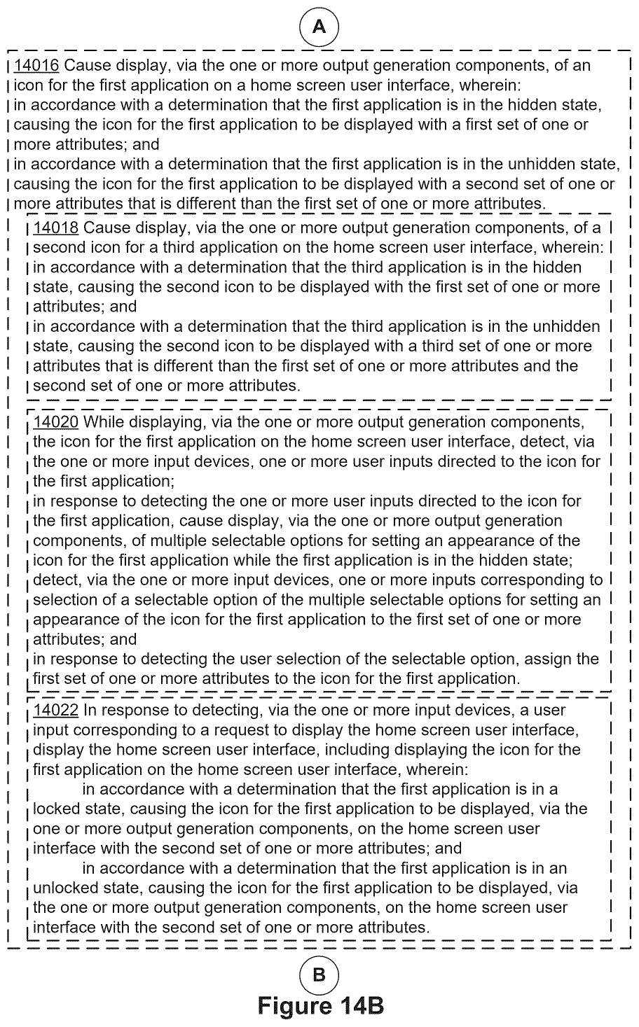

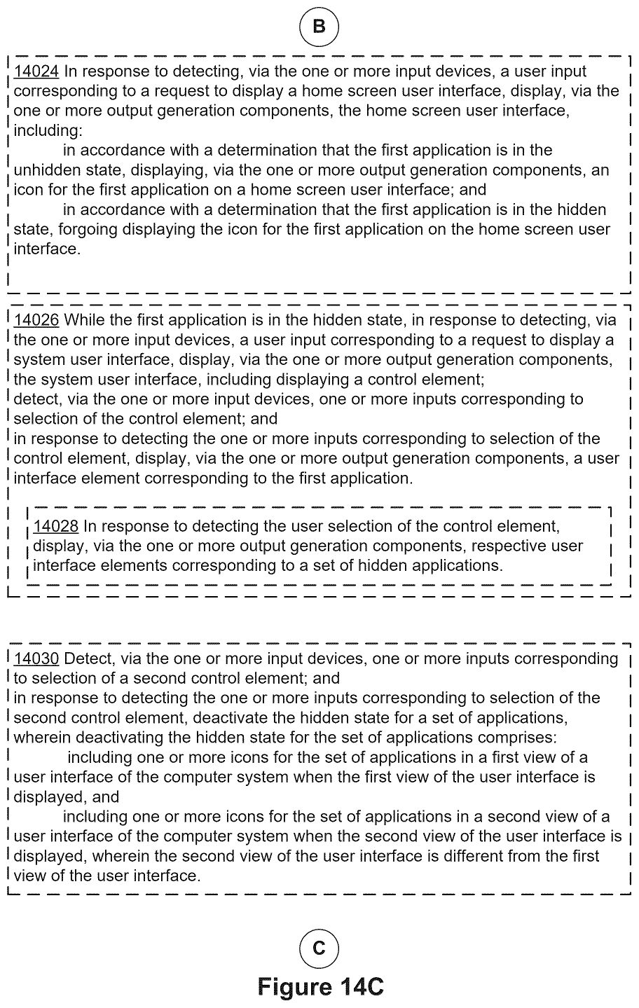

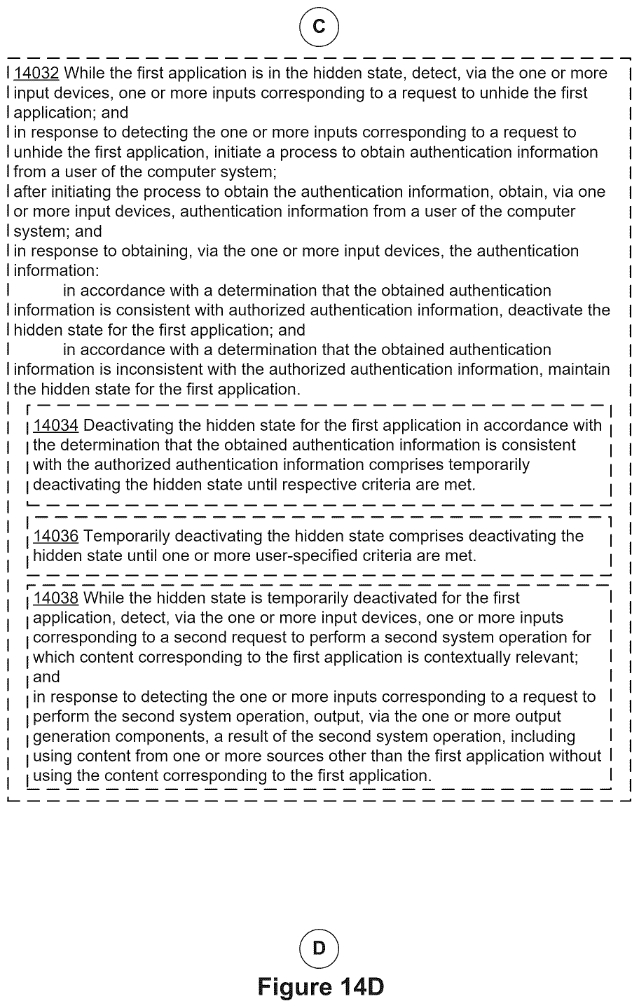

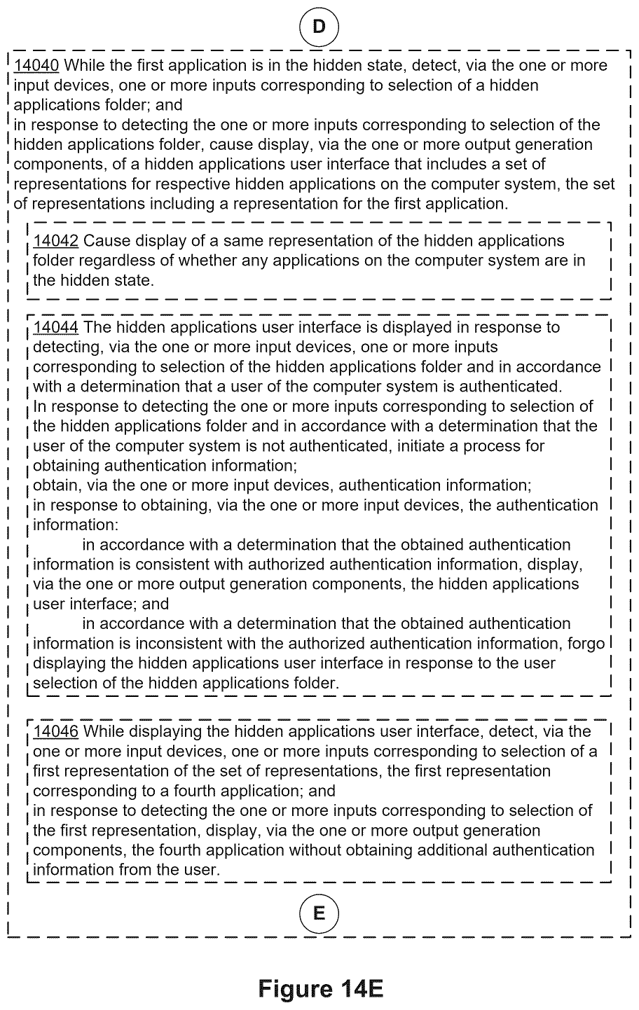

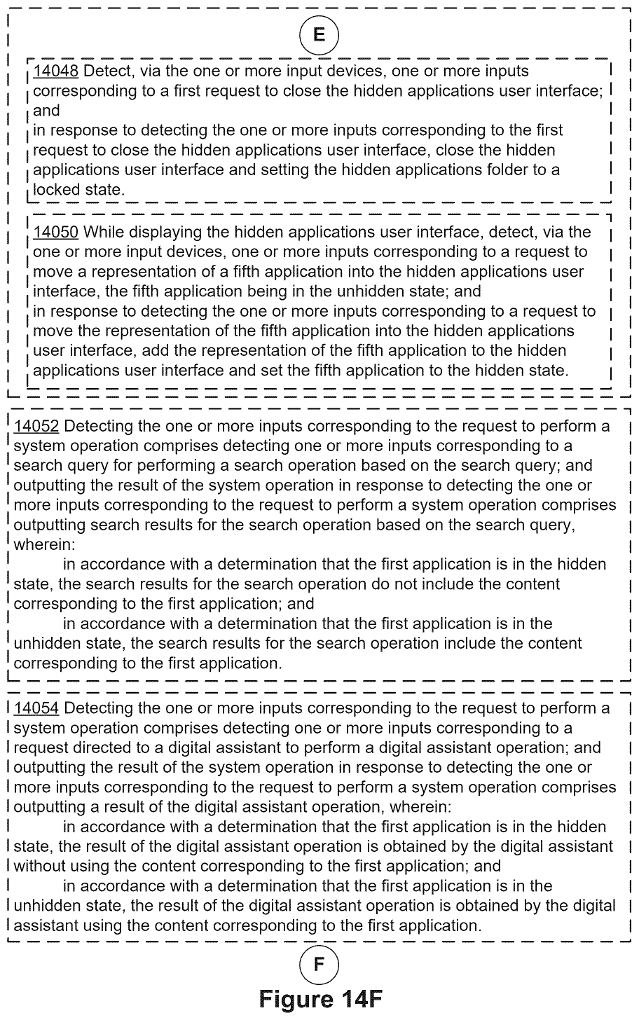

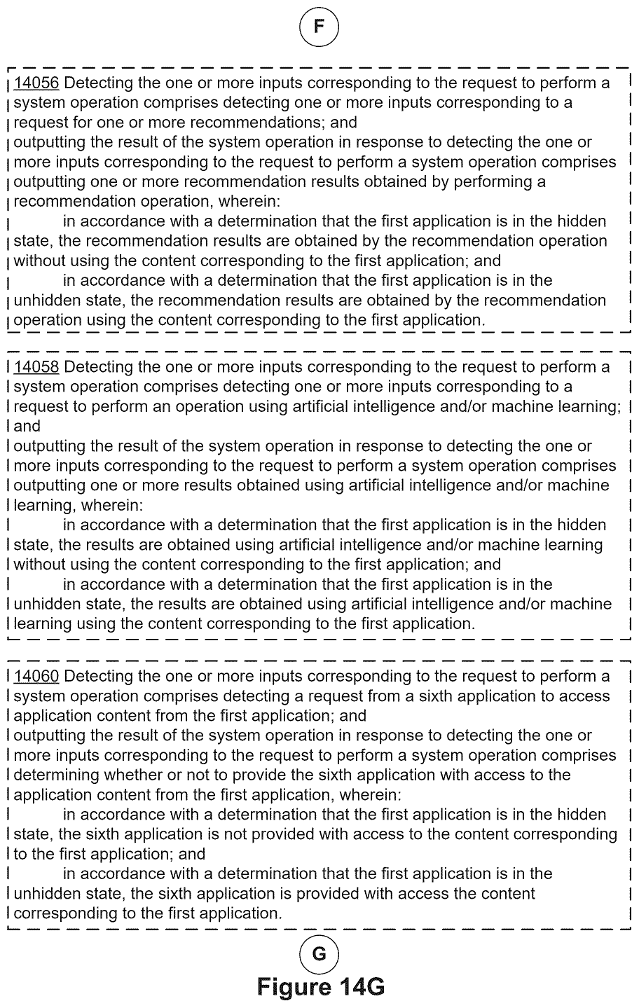

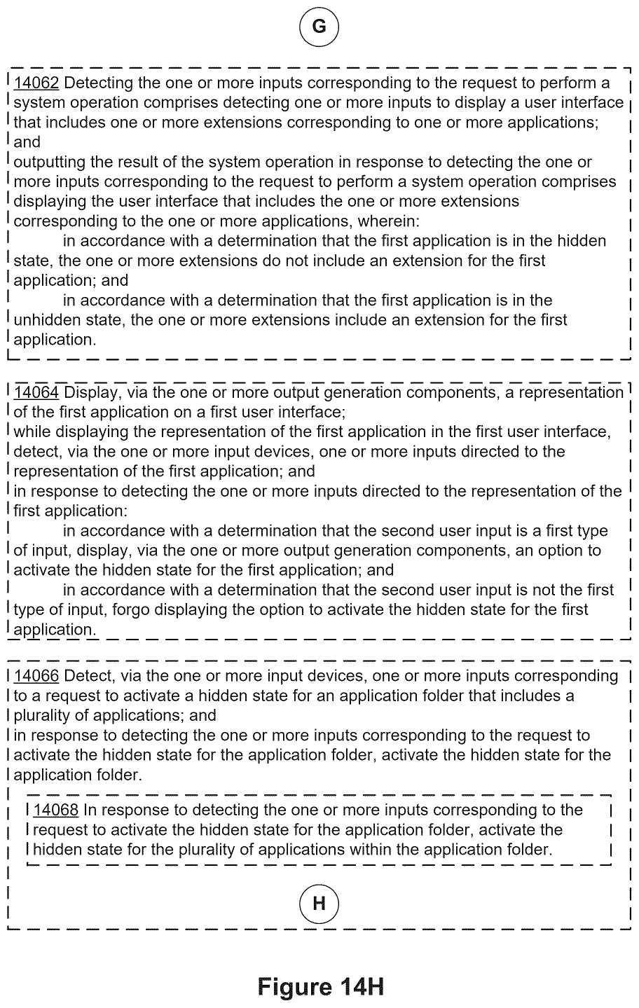

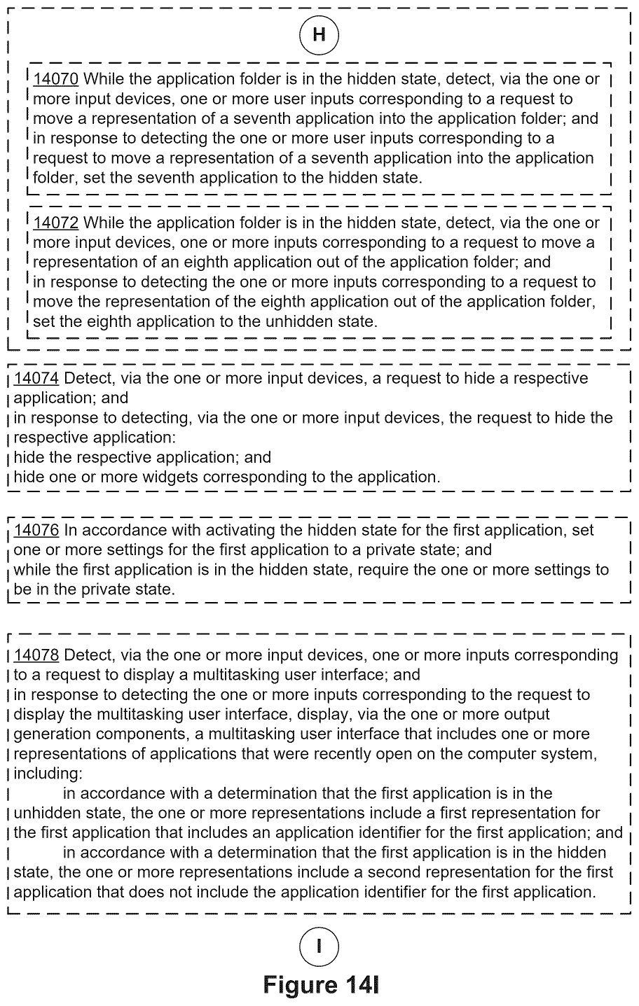

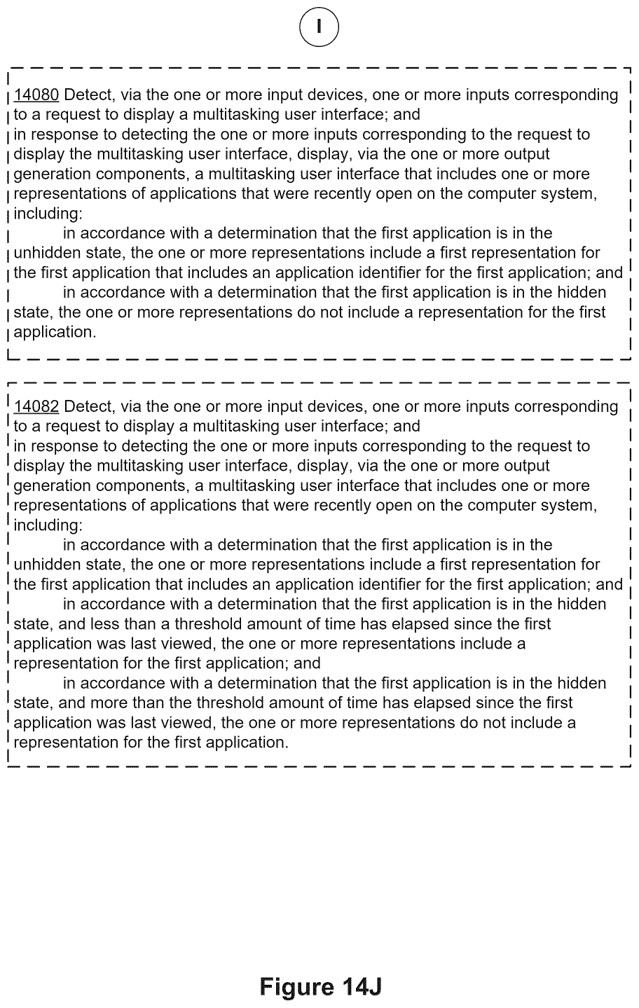

Below, FIGS. 1A-1B, 2, and 3A provide a description of example devices. FIGS. 3B-3G describe the use of Application Programming Interfaces (APIs) to perform operations. FIGS. 4A-4C2 and 5A-5F, 6A-6G, 7A-7T, 8A-8D, 9A-9F, 10A-10AE, 11A-11F, and 12A-12G illustrate example user interfaces for locking and/or hiding applications. FIGS. 13A-13F illustrate a flow diagram of a method of requiring authentication for a locked application. FIGS. 14A-14F illustrate a flow diagram of a method of determining whether or not to provide a system function with access an application based on its hidden state. The user interfaces in FIGS. 5A-5F, 6A-6G, 7A-7T, 8A-8D, 9A-9F, 10A-10AE, 11A-11F, and 12A-12G used to illustrate the processes in FIGS. 13A-13F and 14A-14J.

### EXAMPLE DEVICES

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices (and computer systems more generally), user interfaces for such devices, and associated processes for using such devices are described. In some embodiments, the device is a portable communications device, such as a mobile telephone, that also contains other functions, such as PDA and/or music player functions. Example embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch-screen displays and/or touchpads), are, optionally, used. It should also be understood that, in some embodiments, the device is not a portable communications device, but is a desktop computer with a touch-sensitive surface (e.g., a touch-screen display and/or a touchpad).

In the discussion that follows, a computer system in the form of an electronic device that includes a display and a touch-sensitive surface is described. It should be understood, however, that the electronic device optionally includes one or more other physical user-interface devices, such as a physical keyboard, a mouse and/or a joystick.

The device typically supports a variety of applications, such as one or more of the following: a note taking application, a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of computer systems such as portable devices with touch-sensitive displays. FIG. 1A is a block diagram illustrating portable multifunction device 100 with touch-sensitive display system 112 in accordance with some embodiments. Touch-sensitive display system 112 is sometimes called a “touch screen” for convenience, and is sometimes simply called a touch-sensitive display. Device 100 includes memory 102 (which optionally includes one or more computer readable storage mediums), memory controller 122, one or more processing units (CPUs) 120, peripherals interface 118, RF circuitry 108, audio circuitry 110, speaker 111, microphone 113, input/output (I/O) subsystem 106, other input or control devices 116, and external port 124. Device 100 optionally includes one or more optical sensors 164. Device 100 optionally includes one or more intensity sensors 165 for detecting intensities of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user. Using tactile outputs to provide haptic feedback to a user enhances the operability of the device and makes the user-device interface more efficient (e.g., by helping the user to provide proper inputs and reducing user mistakes when operating/interacting with the device) which, additionally, reduces power usage and improves battery life of the device by enabling the user to use the device more quickly and efficiently.

In some embodiments, a tactile output pattern specifies characteristics of a tactile output, such as the amplitude of the tactile output, the shape of a movement waveform of the tactile output, the frequency of the tactile output, and/or the duration of the tactile output.

When tactile outputs with different tactile output patterns are generated by a device (e.g., via one or more tactile output generators that move a moveable mass to generate tactile outputs), the tactile outputs may invoke different haptic sensations in a user holding or touching the device. While the sensation of the user is based on the user's perception of the tactile output, most users will be able to identify changes in waveform, frequency, and amplitude of tactile outputs generated by the device. Thus, the waveform, frequency and amplitude can be adjusted to indicate to the user that different operations have been performed. As such, tactile outputs with tactile output patterns that are designed, selected, and/or engineered to simulate characteristics (e.g., size, material, weight, stiffness, smoothness, etc.); behaviors (e.g., oscillation, displacement, acceleration, rotation, expansion, etc.); and/or interactions (e.g., collision, adhesion, repulsion, attraction, friction, etc.) of objects in a given environment (e.g., a user interface that includes graphical features and objects, a simulated physical environment with virtual boundaries and virtual objects, a real physical environment with physical boundaries and physical objects, and/or a combination of any of the above) will, in some circumstances, provide helpful feedback to users that reduces input errors and increases the efficiency of the user's operation of the device. Additionally, tactile outputs are, optionally, generated to correspond to feedback that is unrelated to a simulated physical characteristic, such as an input threshold or a selection of an object. Such tactile outputs will, in some circumstances, provide helpful feedback to users that reduces input errors and increases the efficiency of the user's operation of the device.

In some embodiments, a tactile output with a suitable tactile output pattern serves as a cue for the occurrence of an event of interest in a user interface or behind the scenes in a device. Examples of the events of interest include activation of an affordance (e.g., a real or virtual button, or toggle switch) provided on the device or in a user interface, success or failure of a requested operation, reaching or crossing a boundary in a user interface, entry into a new state, switching of input focus between objects, activation of a new mode, reaching or crossing an input threshold, detection or recognition of a type of input or gesture, etc. In some embodiments, tactile outputs are provided to serve as a warning or an alert for an impending event or outcome that would occur unless a redirection or interruption input is timely detected. Tactile outputs are also used in other contexts to enrich the user experience, improve the accessibility of the device to users with visual or motor difficulties or other accessibility needs, and/or improve efficiency and functionality of the user interface and/or the device. Tactile outputs are optionally accompanied with audio outputs and/or visible user interface changes, which further enhance a user's experience when the user interacts with a user interface and/or the device, and facilitate better conveyance of information regarding the state of the user interface and/or the device, and which reduce input errors and increase the efficiency of the user's operation of the device. It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, firmware, or a combination thereof, including one or more signal processing and/or application specific integrated circuits.

Memory 102 optionally includes high-speed random access memory and optionally also includes non-volatile memory, such as one or more magnetic disk storage devices, flash memory devices, or other non-volatile solid-state memory devices. Access to memory 102 by other components of device 100, such as CPU(s) 120 and the peripherals interface 118, is, optionally, controlled by memory controller 122.

Peripherals interface 118 can be used to couple input and output peripherals of the device to CPU(s) 120 and memory 102. The one or more processors 120 run or execute various software programs and/or sets of instructions stored in memory 102 to perform various functions for device 100 and to process data.

In some embodiments, peripherals interface 118, CPU(s) 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication optionally uses any of a plurality of communications standards, protocols and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPA), long term evolution (LTE), near field communication (NFC), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11ac, IEEE 802.11ax, IEEE 802.11b, IEEE 802.11g and/or IEEE 802.11n), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

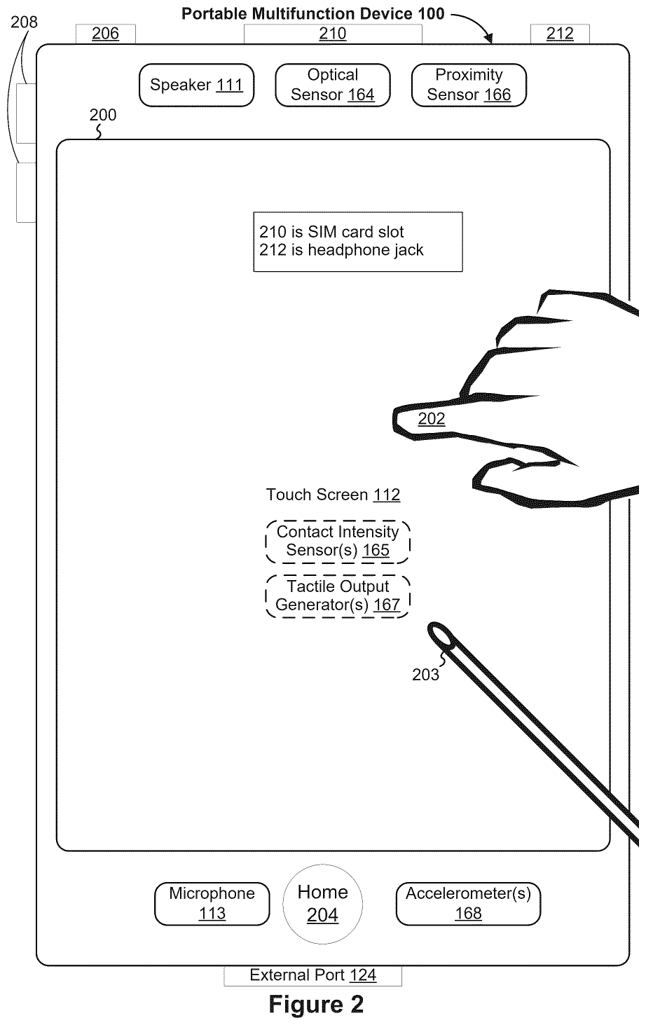

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both cars) and input (e.g., a microphone).

I/O subsystem 106 couples input/output peripherals on device 100, such as touch-sensitive display system 112 and other input or control devices 116, with peripherals interface 118. I/O subsystem 106 optionally includes display controller 156, optical sensor controller 158, intensity sensor controller 159, haptic feedback controller 161, and one or more input controllers 160 for other input or control devices. The one or more input controllers 160 receive/send electrical signals from/to other input or control devices 116. The other input or control devices 116 optionally include physical buttons (e.g., push buttons, rocker buttons, etc.), dials, slider switches, joysticks, click wheels, and so forth. In some alternate embodiments, input controller(s) 160 are, optionally, coupled with any (or none) of the following: a keyboard, infrared port, USB port, stylus, and/or a pointer device such as a mouse. The one or more buttons (e.g., 208, FIG. 2) optionally include an up/down button (e.g., a single button that rocks in opposite directions, or separate up button and down button) for volume control of speaker 111 and/or microphone 113. The one or more buttons optionally include a push button (e.g., 206, FIG. 2).

Touch-sensitive display system 112 provides an input interface and an output interface between the device and a user. Display controller 156 receives and/or sends electrical signals from/to touch-sensitive display system 112. Touch-sensitive display system 112 displays visual output to the user. The visual output optionally includes graphics, text, icons, video, and any combination thereof (collectively termed “graphics”). In some embodiments, some or all of the visual output corresponds to user interface objects. As used herein, the term “affordance” refers to a user-interactive graphical user interface object (e.g., a graphical user interface object that is configured to respond to inputs directed toward the graphical user interface object). Examples of user-interactive graphical user interface objects include, without limitation, a button, slider, icon, selectable menu item, switch, hyperlink, or other user interface control.

Touch-sensitive display system 112 has a touch-sensitive surface, sensor or set of sensors that accepts input from the user based on haptic and/or tactile contact. Touch-sensitive display system 112 and display controller 156 (along with any associated modules and/or sets of instructions in memory 102) detect contact (and any movement or breaking of the contact) on touch-sensitive display system 112 and converts the detected contact into interaction with user-interface objects (e.g., one or more soft keys, icons, web pages or images) that are displayed on touch-sensitive display system 112. In some embodiments, a point of contact between touch-sensitive display system 112 and the user corresponds to a finger of the user or a stylus.

Touch-sensitive display system 112 optionally uses LCD (liquid crystal display) technology, LPD (light emitting polymer display) technology, or LED (light emitting diode) technology, although other display technologies are used in other embodiments. Touch-sensitive display system 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch-sensitive display system 112. In some embodiments, projected mutual capacitance sensing technology is used, such as that found in the iPhone®, iPod Touch®, and iPad® from Apple Inc. of Cupertino, California.

Touch-sensitive display system 112 optionally has a video resolution in excess of 100 dpi. In some embodiments, the touch screen video resolution is in excess of 400 dpi (e.g., 500 dpi, 800 dpi, or greater). The user optionally makes contact with touch-sensitive display system 112 using any suitable object or appendage, such as a stylus, a finger, and so forth. In some embodiments, the user interface is designed to work with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch-sensitive display system 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164 (e.g., as part of one or more cameras). FIG. 1A shows an optical sensor coupled with optical sensor controller 158 in I/O subsystem 106. Optical sensor(s) 164 optionally include charge-coupled device (CCD) or complementary metal-oxide semiconductor (CMOS) phototransistors. Optical sensor(s) 164 receive light from the environment, projected through one or more lens, and converts the light to data representing an image. In conjunction with imaging module 143 (also called a camera module), optical sensor(s) 164 optionally capture still images and/or video. In some embodiments, an optical sensor is located on the back of device 100, opposite touch-sensitive display system 112 on the front of the device, so that the touch screen is enabled for use as a viewfinder for still and/or video image acquisition. In some embodiments, another optical sensor is located on the front of the device so that the user's image is obtained (e.g., for selfies, for videoconferencing while the user views the other video conference participants on the touch screen, etc.).

Device 100 optionally also includes one or more contact intensity sensors 165. FIG. 1A shows a contact intensity sensor coupled with intensity sensor controller 159 in I/O subsystem 106. Contact intensity sensor(s) 165 optionally include one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor(s) 165 receive contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch-screen display system 112 which is located on the front of device 100.

Device 100 optionally also includes one or more proximity sensors 166. FIG. 1A shows proximity sensor 166 coupled with peripherals interface 118. Alternately, proximity sensor 166 is coupled with input controller 160 in I/O subsystem 106. In some embodiments, the proximity sensor turns off and disables touch-sensitive display system 112 when the multifunction device is placed near the user's ear (e.g., when the user is making a phone call).

Device 100 optionally also includes one or more tactile output generators 167. FIG. 1A shows a tactile output generator coupled with haptic feedback controller 161 in I/O subsystem 106. In some embodiments, tactile output generator(s) 167 include one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Tactile output generator(s) 167 receive tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch-sensitive display system 112, which is located on the front of device 100.

Device 100 optionally also includes one or more accelerometers 168. FIG. 1A shows accelerometer 168 coupled with peripherals interface 118. Alternately, accelerometer 168 is, optionally, coupled with an input controller 160 in I/O subsystem 106. In some embodiments, information is displayed on the touch-screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

In some embodiments, the software components stored in memory 102 include operating system 126, communication module (or set of instructions) 128, contact/motion module (or set of instructions) 130, graphics module (or set of instructions) 132, haptic feedback module (or set of instructions) 133, text input module (or set of instructions) 134, Global Positioning System (GPS) module (or set of instructions) 135, and applications (or sets of instructions) 136. Furthermore, in some embodiments, memory 102 stores device/global internal state 157, as shown in FIGS. 1A and 3A. Device/global internal state 157 includes one or more of: active application state, indicating which applications, if any, are currently active; display state, indicating what applications, views or other information occupy various regions of touch-sensitive display system 112; sensor state, including information obtained from the device's various sensors and other input or control devices 116; and location and/or positional information concerning the device's location and/or attitude.

Operating system 126 (e.g., iOS, Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with the 30-pin connector used in some iPhone®, iPod Touch®, and iPad® devices from Apple Inc. of Cupertino, California. In some embodiments, the external port is a Lightning connector that is the same as, or similar to and/or compatible with the Lightning connector used in some iPhone®, iPod Touch®, and iPad® devices from Apple Inc. of Cupertino, California. In some embodiments, the external port is a USB Type-C connector that is the same as, or similar to and/or compatible with the USB Type-C connector used in some electronic devices from Apple Inc. of Cupertino, California.

Contact/motion module 130 optionally detects contact with touch-sensitive display system 112 (in conjunction with display controller 156) and other touch-sensitive devices (e.g., a touchpad or physical click wheel). Contact/motion module 130 includes various software components for performing various operations related to detection of contact (e.g., by a finger or by a stylus), such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts or stylus contacts) or to multiple simultaneous contacts (e.g., “multitouch”/multiple finger contacts). In some embodiments, contact/motion module 130 and display controller 156 detect contact on a touchpad.

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (lift off) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (lift off) event. Similarly, tap, swipe, drag, and other gestures are optionally detected for a stylus by detecting a particular contact pattern for the stylus.

In some embodiments, detecting a finger tap gesture depends on the length of time between detecting the finger-down event and the finger-up event, but is independent of the intensity of the finger contact between detecting the finger-down event and the finger-up event. In some embodiments, a tap gesture is detected in accordance with a determination that the length of time between the finger-down event and the finger-up event is less than a predetermined value (e.g., less than 0.1, 0.2, 0.3, 0.4 or 0.5 seconds), independent of whether the intensity of the finger contact during the tap meets a given intensity threshold (greater than a nominal contact-detection intensity threshold), such as a light press or deep press intensity threshold. Thus, a finger tap gesture can satisfy particular input criteria that do not require that the characteristic intensity of a contact satisfy a given intensity threshold in order for the particular input criteria to be met. For clarity, the finger contact in a tap gesture typically needs to satisfy a nominal contact-detection intensity threshold, below which the contact is not detected, in order for the finger-down event to be detected. A similar analysis applies to detecting a tap gesture by a stylus or other contact. In cases where the device is capable of detecting a finger or stylus contact hovering over a touch sensitive surface, the nominal contact-detection intensity threshold optionally does not correspond to physical contact between the finger or stylus and the touch sensitive surface.

The same concepts apply in an analogous manner to other types of gestures. For example, a swipe gesture, a pinch gesture, a depinch gesture, and/or a long press gesture are optionally detected based on the satisfaction of criteria that are either independent of intensities of contacts included in the gesture, or do not require that contact(s) that perform the gesture reach intensity thresholds in order to be recognized. For example, a swipe gesture is detected based on an amount of movement of one or more contacts; a pinch gesture is detected based on movement of two or more contacts towards each other; a depinch gesture is detected based on movement of two or more contacts away from each other; and a long press gesture is detected based on a duration of the contact on the touch-sensitive surface with less than a threshold amount of movement. As such, the statement that particular gesture recognition criteria do not require that the intensity of the contact(s) meet a respective intensity threshold in order for the particular gesture recognition criteria to be met means that the particular gesture recognition criteria are capable of being satisfied if the contact(s) in the gesture do not reach the respective intensity threshold, and are also capable of being satisfied in circumstances where one or more of the contacts in the gesture do reach or exceed the respective intensity threshold. In some embodiments, a tap gesture is detected based on a determination that the finger-down and finger-up event are detected within a predefined time period, without regard to whether the contact is above or below the respective intensity threshold during the predefined time period, and a swipe gesture is detected based on a determination that the contact movement is greater than a predefined magnitude, even if the contact is above the respective intensity threshold at the end of the contact movement. Even in implementations where detection of a gesture is influenced by the intensity of contacts performing the gesture (e.g., the device detects a long press more quickly when the intensity of the contact is above an intensity threshold or delays detection of a tap input when the intensity of the contact is higher), the detection of those gestures does not require that the contacts reach a particular intensity threshold so long as the criteria for recognizing the gesture can be met in circumstances where the contact does not reach the particular intensity threshold (e.g., even if the amount of time that it takes to recognize the gesture changes).

Contact intensity thresholds, duration thresholds, and movement thresholds are, in some circumstances, combined in a variety of different combinations in order to create heuristics for distinguishing two or more different gestures directed to the same input element or region so that multiple different interactions with the same input element are enabled to provide a richer set of user interactions and responses. The statement that a particular set of gesture recognition criteria do not require that the intensity of the contact(s) meet a respective intensity threshold in order for the particular gesture recognition criteria to be met does not preclude the concurrent evaluation of other intensity-dependent gesture recognition criteria to identify other gestures that do have criteria that are met when a gesture includes a contact with an intensity above the respective intensity threshold. For example, in some circumstances, first gesture recognition criteria for a first gesture-which do not require that the intensity of the contact(s) meet a respective intensity threshold in order for the first gesture recognition criteria to be met—are in competition with second gesture recognition criteria for a second gesture-which are dependent on the contact(s) reaching the respective intensity threshold. In such competitions, the gesture is, optionally, not recognized as meeting the first gesture recognition criteria for the first gesture if the second gesture recognition criteria for the second gesture are met first. For example, if a contact reaches the respective intensity threshold before the contact moves by a predefined amount of movement, a deep press gesture is detected rather than a swipe gesture. Conversely, if the contact moves by the predefined amount of movement before the contact reaches the respective intensity threshold, a swipe gesture is detected rather than a deep press gesture. Even in such circumstances, the first gesture recognition criteria for the first gesture still do not require that the intensity of the contact(s) meet a respective intensity threshold in order for the first gesture recognition criteria to be met because if the contact stayed below the respective intensity threshold until an end of the gesture (e.g., a swipe gesture with a contact that does not increase to an intensity above the respective intensity threshold), the gesture would have been recognized by the first gesture recognition criteria as a swipe gesture. As such, particular gesture recognition criteria that do not require that the intensity of the contact(s) meet a respective intensity threshold in order for the particular gesture recognition criteria to be met will (A) in some circumstances ignore the intensity of the contact with respect to the intensity threshold (e.g. for a tap gesture) and/or (B) in some circumstances still be dependent on the intensity of the contact with respect to the intensity threshold in the sense that the particular gesture recognition criteria (e.g., for a long press gesture) will fail if a competing set of intensity-dependent gesture recognition criteria (e.g., for a deep press gesture) recognize an input as corresponding to an intensity-dependent gesture before the particular gesture recognition criteria recognize a gesture corresponding to the input (e.g., for a long press gesture that is competing with a deep press gesture for recognition).

Graphics module 132 includes various known software components for rendering and displaying graphics on touch-sensitive display system 112 or other display, including components for changing the visual impact (e.g., brightness, transparency, saturation, contrast or other visual property) of graphics that are displayed. As used herein, the term “graphics” includes any object that can be displayed to a user, including without limitation text, web pages, icons (such as user-interface objects including soft keys), digital images, videos, animations and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions (e.g., instructions used by haptic feedback controller 161) to produce tactile outputs using tactile output generator(s) 167 at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing, to camera module 143 as picture/video metadata, and to applications that provide location-based services such as weather widgets, local yellow page widgets, and map/navigation widgets).

Applications 136 optionally include the following modules (or sets of instructions), or a subset or superset thereof:
contacts module 137 (sometimes called an address book or contact list);
telephone module 138;
video conferencing module 139;
e-mail client module 140;
instant messaging (IM) module 141;
workout support module 142;
camera module 143 for still and/or video images;
image management module 144;
browser module 147;
calendar module 148;
widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
widget creator module 150 for making user-created widgets 149-6;
search module 151;
video and music player module 152, which is, optionally, made up of a video player module and a music player module;
notes module 153;
map module 154; and/or
online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch-sensitive display system 112, display controller 156, contact module 130, graphics module 132, and text input module 134, contacts module 137 includes executable instructions to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers and/or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch-sensitive display system 112, display controller 156, contact module 130, graphics module 132, and text input module 134, telephone module 138 includes executable instructions to enter a sequence of characters corresponding to a telephone number, access one or more telephone numbers in address book 137, modify a telephone number that has been entered, dial a respective telephone number, conduct a conversation and disconnect or hang up when the conversation is completed. As noted above, the wireless communication optionally uses any of a plurality of communications standards, protocols and technologies.

In conjunction with RF circuitry 108, audio circuitry 110, speaker 111, microphone 113, touch-sensitive display system 112, display controller 156, optical sensor(s) 164, optical sensor controller 158, contact module 130, graphics module 132, text input module 134, contact list 137, and telephone module 138, videoconferencing module 139 includes executable instructions to initiate, conduct, and terminate a video conference between a user and one or more other participants in accordance with user instructions.

In conjunction with RF circuitry 108, touch-sensitive display system 112, display controller 156, contact module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch-sensitive display system 112, display controller 156, contact module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, Apple Push Notification Service (APNs) or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, APNs, or IMPS).

In conjunction with RF circuitry 108, touch-sensitive display system 112, display controller 156, contact module 130, graphics module 132, text input module 134, GPS module 135, map module 154, and video and music player module 152, workout support module 142 includes executable instructions to create workouts (e.g., with time, distance, and/or calorie burning goals); communicate with workout sensors (in sports devices and smart watches); receive workout sensor data; calibrate sensors used to monitor a workout; select and play music for a workout; and display, store and transmit workout data.

In conjunction with touch-sensitive display system 112, display controller 156, optical sensor(s) 164, optical sensor controller 158, contact module 130, graphics module 132, and image management module 144, camera module 143 includes executable instructions to capture still images or video (including a video stream) and store them into memory 102, modify characteristics of a still image or video, and/or delete a still image or video from memory 102.

In conjunction with touch-sensitive display system 112, display controller 156, contact module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch-sensitive display system 112, display controller 156, contact module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch-sensitive display system 112, display controller 156, contact module 130, graphics module 132, text input module 134, c-mail client module 140, and browser module 147, calendar module 148 includes executable instructions to create, display, modify, and store calendars and data associated with calendars (e.g., calendar entries, to do lists, etc.) in accordance with user instructions.

In conjunction with RF circuitry 108, touch-sensitive display system 112, display controller 156, contact module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch-sensitive display system 112, display controller 156, contact module 130, graphics module 132, text input module 134, and browser module 147, the widget creator module 150 includes executable instructions to create widgets (e.g., turning a user-specified portion of a web page into a widget).

In conjunction with touch-sensitive display system 112, display controller 156, contact module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch-sensitive display system 112, display controller 156, contact module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present or otherwise play back videos (e.g., on touch-sensitive display system 112, or on an external display connected wirelessly or via external port 124). In some embodiments, device 100 optionally includes the functionality of an MP3 player, such as an iPod (trademark of Apple Inc.).

In conjunction with touch-sensitive display system 112, display controller 156, contact module 130, graphics module 132, and text input module 134, notes module 153 includes executable instructions to create and manage notes, to do lists, and the like in accordance with user instructions.

In conjunction with RF circuitry 108, touch-sensitive display system 112, display controller 156, contact module 130, graphics module 132, text input module 134, GPS module 135, and browser module 147, map module 154 includes executable instructions to receive, display, modify, and store maps and data associated with maps (e.g., driving directions; data on stores and other points of interest at or near a particular location; and other location-based data) in accordance with user instructions.

In conjunction with touch-sensitive display system 112, display controller 156, contact module 130, graphics module 132, audio circuitry 110, speaker 111, RF circuitry 108, text input module 134, e-mail client module 140, and browser module 147, online video module 155 includes executable instructions that allow the user to access, browse, receive (e.g., by streaming and/or download), play back (e.g., on the touch screen 112, or on an external display connected wirelessly or via external port 124), send an e-mail with a link to a particular online video, and otherwise manage online videos in one or more file formats, such as H.264. In some embodiments, instant messaging module 141, rather than e-mail client module 140, is used to send a link to a particular online video.

Each of the above identified modules and applications correspond to a set of executable instructions for performing one or more functions described above and the methods described in this application (e.g., the computer-implemented methods and other information processing methods described herein). These modules (e.g., sets of instructions) need not be implemented as separate software programs, procedures or modules, and thus various subsets of these modules are, optionally, combined or otherwise re-arranged in various embodiments. In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating example components for event handling in accordance with some embodiments. In some embodiments, memory 102 (in FIG. 1A) or 370 (FIG. 3A) includes event sorter 170 (e.g., in operating system 126) and a respective application 136-1 (e.g., any of the aforementioned applications 136, 137-155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display system 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display system 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display system 112 or a touch-sensitive surface.

In some embodiments, event monitor 171 sends requests to the peripherals interface 118 at predetermined intervals. In response, peripherals interface 118 transmits event information. In other embodiments, peripheral interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views, when touch-sensitive display system 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver module 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177 or GUI updater 178 to update the application internal state 192. Alternatively, one or more of the application views 191 includes one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170, and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event 187 include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first lift-off (touch end) for a predetermined phase, a second touch (touch begin) on the displayed object for a predetermined phase, and a second lift-off (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display system 112, and lift-off of the touch (touch end). In some embodiments, the event also includes information for one or more associated event handlers 190.

In some embodiments, event definition 187 includes a definition of an event for a respective user-interface object. In some embodiments, event comparator 184 performs a hit test to determine which user-interface object is associated with a sub-event. For example, in an application view in which three user-interface objects are displayed on touch-sensitive display system 112, when a touch is detected on touch-sensitive display system 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event 187 also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video and music player module 152. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input-devices, not all of which are initiated on touch screens. For example, mouse movement and mouse button presses, optionally coordinated with single or multiple keyboard presses or holds; contact movements such as taps, drags, scrolls, etc., on touch-pads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen (e.g., touch-sensitive display system 112, FIG. 1A) in accordance with some embodiments. The touch screen optionally displays one or more graphics within user interface (UI) 200. In these embodiments, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also includes one or more physical buttons, such as “home” or menu button 204. As described previously, menu button 204 is, optionally, used to navigate to any application 136 in a set of applications that are, optionally executed on device 100. Alternatively, in some embodiments, the menu button is implemented as a soft key in a GUI displayed on the touch-screen display, or as a system gesture such as an upward edge swipe.

In some embodiments, device 100 includes the touch-screen display, menu button 204 (sometimes called home button 204), push button 206 for powering the device on/off and locking the device, volume adjustment button(s) 208, Subscriber Identity Module (SIM) card slot 210, head set jack 212, and/or docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In some embodiments, device 100 also accepts verbal input for activation or deactivation of some functions through microphone 113. Device 100 also, optionally, includes one or more contact intensity sensors 165 for detecting intensities of contacts on touch-sensitive display system 112 and/or one or more tactile output generators 167 for generating tactile outputs for a user of device 100.

FIG. 3A is a block diagram of an example multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPU's) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch-screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (e.g., in FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (e.g., in FIG. 1A) optionally does not store these modules.

Each of the above identified elements in FIG. 3A are, optionally, stored in one or more of the previously mentioned memory devices. Each of the above identified modules corresponds to a set of instructions for performing a function described above. The above identified modules or programs (e.g., sets of instructions) need not be implemented as separate software programs, procedures or modules, and thus various subsets of these modules are, optionally, combined or otherwise re-arranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API calling modules (e.g., including API-calling module 3180) that communicate with implementation module 3100. In some embodiments, API 3190 allows multiple API calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first party application). In some embodiments, the application is an application that is provided via an application store. In some embodiments, the application store is pre-installed on the first computer system at purchase (e.g., a first party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 13000 (FIGS. 13A-13F) and/or method 14000 (FIGS. 14A-14J) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, a contact transfer API, a photos API, a camera API, and/or an image processing API.

In some embodiments, at least one API is a software module (e.g., a collection of computer-readable instructions) that provides an interface that allows a different module (e.g., an API calling module) to access and use one or more functions, methods, procedures, data structures, classes, and/or other services provided by an implementation module of the system process. The API can define one or more parameters that are passed between the API calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces (“UI”) that are, optionally, implemented on portable multifunction device 100.

FIG. 4A illustrates an example user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) for wireless communication(s), such as cellular and Wi-Fi signals;
Time;
a Bluetooth indicator;
a Battery status indicator;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser”; and
   Icon 422 for video and music player module 152, labeled “Music”; and
   Icons for other applications, such as:
   Icon 424 for IM module 141, labeled “Messages”;
   Icon 426 for calendar module 148, labeled “Calendar”;
   Icon 428 for image management module 144, labeled “Photos”;
   Icon 430 for camera module 143, labeled “Camera”;
   Icon 432 for online video module 155, labeled “Online Video”;
   Icon 434 for stocks widget 149-2, labeled “Stocks”;
   Icon 436 for map module 154, labeled “Maps”;
   Icon 438 for weather widget 149-1, labeled “Weather”;
   Icon 440 for alarm clock widget 149-4, labeled “Clock”;
   Icon 442 for workout support module 142, labeled “Workout Support”;
   Icon 444 for notes module 153, labeled “Notes”; and
   Icon 446 for a settings application or module, which provides access to settings for device 100 and its various applications 136; and
Widgets that include content from respective applications that is updated from time to time without user intervention, such as:
   Widget 448 associated with a weather application; and
   Widget 449 associated with a photos application.

It should be noted that the icon labels illustrated in FIG. 4A are merely examples. For example, other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an example user interface on a device (e.g., device 300, FIG. 3A) with a touch-sensitive surface 451 (e.g., a tablet or touchpad 355, FIG. 3A) that is separate from the display 450. Although many of the examples that follow will be given with reference to inputs on touch screen display 112 (where the touch sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, contact 460 corresponds to 468 and contact 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures, etc.), it should be understood that, in some embodiments, one or more of the finger inputs are replaced with input from another input device (e.g., a mouse based input or a stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

As used herein, the term “focus selector” refers to an input element that indicates a current part of a user interface with which a user is interacting. In some implementations that include a cursor or other location marker, the cursor acts as a “focus selector,” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider or other user interface element), the particular user interface element is adjusted in accordance with the detected input. In some implementations that include a touch-screen display (e.g., touch-sensitive display system 112 in FIG. 1A or the touch screen in FIG. 4A) that enables direct interaction with user interface elements on the touch-screen display, a detected contact on the touch-screen acts as a “focus selector,” so that when an input (e.g., a press input by the contact) is detected on the touch-screen display at a location of a particular user interface element (e.g., a button, window, slider or other user interface element), the particular user interface element is adjusted in accordance with the detected input. In some implementations, focus is moved from one region of a user interface to another region of the user interface without corresponding movement of a cursor or movement of a contact on a touch-screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch-screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

FIGS. 4C1-4C2 illustrate an example state diagram 4000 of navigation between various user interfaces of the multifunction device 100 in accordance with some embodiments. In some embodiments, the multifunction device 100 displays a respective user interface from a plurality of different user interfaces, including a wake screen user interface 490 (also referred to as a coversheet user interface 496), a home screen user interface 492, a widget user interface 491, a control user interface 498, a search user interface 494, an application library user interface 497, and an application user interface 493 of a respective application (e.g., a camera application (e.g., camera application user interface 495), a flashlight application, a settings application, a messaging application (e.g., application user interface 493), a telephony application, a maps application, a browser application, or another type of application) of a plurality of applications. In some embodiments, the multifunction device operates in a standby mode that provides a simplified set of user interfaces and functions, when a set of conditions are met (e.g., device is charging, placed on a docking station, and/or is oriented in a landscape orientation). FIGS. 4C1-4C2 illustrate the navigation states in the normal, non-standby mode. In some embodiments, the multifunction device utilizes various portions of the display (e.g., touch-screen display 112, display 340 associated with a touch-sensitive surface, a head-mounted display, or another type of display) to display persistent content across multiple user interfaces. For example, in some embodiments, the display includes a dynamic status region 4002 for displaying alerts, status updates, and/or current states for various subscribed and/or ongoing events, and/or for various application activities, in real-time or substantially real-time. In some embodiments, the display includes a static status region 4022 for displaying status information for one or more system functions that is relatively stable over a period of time. In some embodiments, the dynamic status region 4002 changes (e.g., expands and/or shrinks) from a region that accommodate one or more hardware elements of the multifunction device (e.g., the camera lenses, microphone, and/or speakers). As described herein, although examples below are given with touch-gestures on a touch-screen display, similar functions can be implemented with a display that is associated with a touch-sensitive surface, where a location (e.g., a location on a top edge, a bottom edge, a left edge, a right edge, a top left portion, a bottom right portion, an interior portion, and/or another portion) on the touch-sensitive surface has a corresponding location (e.g., a location on a top edge, a bottom edge, a left edge, a right edge, a top left portion, a bottom right portion, an interior portion, and/or another portion) on the display (and/or on the user interface presented on the display). Furthermore, although the examples below are given with touch-gestures on a touch-screen display, similar functions can be implemented with a display that is associated with another type of input, such as a mouse inputs, a pointer inputs, gaze inputs (e.g., gazes with time and location characteristics that are directed to various portions of the displayed user interface and/or user interface elements) in conjunction with air gesture inputs (e.g., air tap, air swipe, air pinch, pinch and hold, pinch-hold and drag, and/or another type of air gestures). As described herein, although examples below are given with touch-gestures on a touch-screen display, similar functions can be implemented with a head-mounted display that displays the user interfaces in a three-dimensional environment and that is controlled with various input devices and sensors for detecting various types of user inputs (e.g., touch gestures, inputs provided by a pointer or controller, gaze inputs, voice inputs, and/or air gestures).

As shown in FIG. 4C1, when the multifunction device 100 is initially powered on (e.g., in response to a long press or other activation input 4100 on a power button 116a (e.g., in FIG. 4A) of the multifunction device 100), the multifunction device displays (4100) the wake screen user interface 490 that is the initially displayed system user interface of the multifunction device 100 when the multifunction device transitions from a power off state to a power on state.

In some embodiments, while the wake screen user interface 490 is displayed after a period of time, the multifunction device 100 optionally transitions (4101) to a low power state, where the display of the multifunction device 100 is optionally turned off, or dimmed, as illustrated by user interface 489. In some embodiments, the wake screen user interface 490 remains displayed in a dimmed, always on state, while the multifunction device 100 is in the low power state. For example, in the low power state illustrated by user interface 489, the time indication and/or date indication continues to be displayed.

In some embodiments, the multifunction device 100 transitions (4101) into the low power state (e.g., turns off the display or displays the wake screen user interface 490 in the dimmed, always-on state) in response to activation of the power button 116a of the multifunction device 100 by a user input 4101 (e.g., while displaying the wake screen user interface 490, and/or any of the other user interfaces described herein).

In some embodiments, the multifunction device transitions (e.g., automatically after a period of inactivity, and/or in response to detecting a user input activating the power button 116a) into the low power state from the normal operating state in which any of a number of user interfaces (e.g., the wake screen user interface 490, the home screen user interface 492, the application user interface 493 of a respective application, or another system and/or application user interface) may be the last displayed user interface before the transition into the low power state.

In some embodiments, when the multifunction device 100 is in the low power state, the multifunction device continues to detect inputs via one or more sensors and input devices of the multifunction device (e.g., movement of the device, touch gestures (e.g., swipe, tap, or other touch input), gaze input, air gestures, impact on the device, press on the power button, rotation of a crown, or other types of inputs). In some embodiments, in response to detecting a user input via the one or more sensors and input devices of the multifunction device, the multifunction device transitions (4100) from the low power state to the normal operating state, and displays the wake screen user interface 490 in a normal, undimmed state.

In some embodiments, when the multifunction device 100 is in the low power state illustrated in user interface 489, the multifunction device continues to detect events, such as arrival of notifications and status updates (e.g., notification for messages, incoming communication requests, and/or other application-generated events and system-generated events, and status updates for sessions, subscribed events, and/or other status changes that require the user's attention). In some embodiments, in response to detecting an event that generates an alert, a notification, and/or a status update, the multifunction device transitions from the low power state to the normal operating state, and displays the alert, notification, and/or status update on the wake screen user interface 490 in the normal, undimmed state. In some embodiments, the multifunction device automatically returns to the low power mode after a short period of time after displaying the alert, notification, and/or the status update.

In some embodiments, the wake screen user interface 490 displayed in the dimmed always-on state includes the same or substantially the same set of user interface elements as the wake screen user interface 490 displayed in the normal operating state (e.g., as opposed to the dark screen shown in FIGS. 4C1 and 4C2). In some embodiments, the wake screen user interface 490 displayed in the dimmed, always-on state has fewer user interface elements than the wake screen user interface 490 displayed in the normal operating state. For example, in some embodiments, the wake screen user interface 490 displayed in the normal operating state includes a time element 4004 showing the current time, a date element 4006 showing the current date, one or more widgets 4008 that include content from respective applications that is updated from time to time without user intervention. In some embodiments, the wake screen user interface 490 displayed in the normal operating state includes one or more application icons corresponding to respective applications, such as an application icon 4010 for the flashlight application, an application icon 4012 for the camera application, or another system-recommended or user selected application. In some embodiments, the wake screen user interface 490 displayed in the normal operating state includes one or more shortcuts for accessing respective operations in one or more system-recommended and/or user-selected applications (e.g., shortcuts to play music using a media player application, to send a quick message using the messaging application, or turn on the DND or sleep mode using a system application). In some embodiments, the wake screen user interface 490 includes the dynamic status region 4002 that displays status updates or current state of an ongoing activity for one or more applications, such as a communication session, a charging session, a running timer, music playing session, delivery updates, navigation instructions, location sharing status, and/or status updates for subscribed application and system events. In some embodiments, the wake screen user interface 490 includes the static status region 4022 that displays status for one or more system functions, such as the network connection status, battery status, location sharing status, cellular signal and carrier information, and other system status information. In some embodiments, a dynamic status update (e.g., battery charging, screen recording, location sharing, and other status updates) is displayed in the dynamic status region 4002 first, and then moved to the static status region 4022 after a period of time. In some embodiments, in a dimmed always on state, the wake screen user interface 490 omits the dynamic status region 4002, static status region 4022, the application icons 4010 and 4012, and/or the shortcuts for application and/or system operations, and optionally disables interaction with remaining user interface elements (e.g., the wallpaper, the time element 4004, the date element 4006, and/or the widgets 4008) of the wake screen user interface 490.

In some embodiments, the wake screen user interface includes one or more recently received notifications (e.g., notifications 4016, or other newly received notification(s)) that correspond to one or more applications. In some embodiments, the wake screen user interface displayed in the dimmed always on state transitions into the wake screen user interface 490 in response to detecting receipt or generation of a new notification (e.g., notification 4018, FIG. 4C2, or another one or more newly received notification(s)) In some embodiments, the notifications 4016 are grouped or coalesced based on event types and/or applications corresponding to the notifications. In some embodiments, user can interact with the notifications to dismiss the notifications, sent the notifications to notification history, and/or expand the notifications to see additional notification content (e.g., optionally after valid authentication data has been requested and/or obtained). In some embodiments, the notifications displayed in the wake screen user interface may, at various times, include un-summarized notifications where the notification content of an un-summarized notification includes application content corresponding to a respective event that triggered the notification, without including a summary of the application content, and/or summaries of notifications, where the summary content of a summary for a single event includes automatically generated summary of application content corresponding to a respective event that triggered the notification, and the summary of multiple related events includes automatically generated summary of application content corresponding to multiple related events that triggered multiple notifications.

In some embodiments, the wake screen user interface 490 may be displayed while the multifunction device is in a locked state or an unlocked state. In some embodiments, when the wake screen user interface 490 is displayed while the multifunction device is in the locked state, a locked symbol 4020a is optionally displayed in the status region (e.g., dynamic status region 4002, static status region in the upper right corner of the display) or elsewhere (e.g., below the dynamic status region 4002, in the upper left corner, or in another portion of the display) in the wake screen user interface 490 to indicate that the multifunction device is in the locked state (e.g., shown in wake screen user interface 490 in FIG. 4C1), and that authentication data is required to dismiss the wake screen user interface 490 to navigate to the home screen user interface 492 or last-displayed application user interface. In some embodiments, the multifunction device automatically attempts to obtain authentication data via biometric scan (e.g., facial, fingerprint, voiceprint, and/or iris) when the wake screen user interface 490 is displayed (e.g., in the low power state, and/or the normal operating state), and automatically transitions into the unlocked state if valid authentication data is successfully obtained. In some embodiments, in conjunction with transitioning into the unlocked state, the multifunction device replaces the locked symbol 4020a with an unlocked symbol 4020b to indicate that the multifunction device is now in the unlocked state (e.g., shown in wake screen user interface 490 in FIG. 4C2).

In some embodiments, the multifunction device allows user interaction with the user interface elements of the wake screen user interface 490 when the wake screen user interface 490 is displayed in the normal operating mode.

For example, in some embodiments, selecting (e.g., by tapping, clicking, and/or air tapping) on a user interface element, such as one of the widgets 4008, status region 4002, notification 4018, and/or application icons 4010 or 4012, causes the multifunction device to navigate away from the wake screen user interface 490 and displays a respective user interface of the application that corresponds to the selected user interface element, or an enlarged version of the user interface element to show additional information and/or controls related to the initially displayed content in the selected user interface element. For example, as shown in FIG. 4C2, in response to a user input 4113 selecting message notification 4018, the computer system displays (4113) the application user interface 493 for the messaging application.

In another example, in some embodiments, an enhanced selection input 4112 (e.g., a touch and hold gesture, a light press input, or another type of input) on a respective user interface element, such as the time element 4004, the date element 4006, or a wallpaper of the wake screen user interface 490, causes the multifunction device to display a configuration user interface for configuring one or more aspects of the wake screen user interface 490 (e.g., selecting a wallpaper, configuring a color or font scheme of the user interface element, configuring how to layout the different elements of the wake screen user interface, configuring additional wake screen, selecting a previously configured wake screen, and view additional customization options for the wake screen user interface). In some embodiments, configuration of the wake screen user interface 490 is partially applied to the home screen user interface 492, and vice versa.

In some embodiments, an enhanced selection input (e.g., a touch and hold gesture, a light press input, or another type of input) on the flashlight application icon 4010 or the camera application icon 4012 causes the multifunction device to activate the flashlight of the multifunction device or display the camera user interface 495 of the camera application. For example, in response to detecting selection input 4104a on the camera application icon 4012 in the wake screen user interface 490, the multifunction device activates the camera application and displays (4104a) the camera application UI 495 (e.g., as shown in FIG. 4C1).

In some embodiments, if the multifunction device detects user interaction with the user interface elements shown in the wake screen user interface 490 and determines that the wake screen user interface is in the locked state, the multifunction device attempts to obtain authentication data from the user by displaying an authentication user interface (e.g., a passcode entry interface, a password entry user interface, and/or a biometric scan user interface). The multifunction device proceeds to navigate away from the wake screen user interface 490 and performs the operation in accordance with the user's interaction after valid authentication data has been obtained from the user.

In some embodiments, in addition to performing operations (e.g., navigating to application user interfaces, displaying expanded versions of user interface elements that show additional information, and/or displaying configuration options for a respective user interface element or the wake screen user interface), the multifunction device allows the user to navigate from the wake screen user interface 490 to other user interfaces (optionally, after valid authentication data has been obtained) in response to navigation inputs (e.g., swipe gestures or other types of navigation inputs that are directed to regions of the wake screen user interface that are not occupied by a user interface element, and/or regions of the wake screen user interface that are occupied by user interface element (e.g., widgets, application icons, and/or time elements) that do not respond to swipe gestures or said other types of navigation inputs).

For example, in some embodiments, an upward swipe gesture 4105 that starts from the bottom edge of the wake screen user interface 490 causes (4105) the multifunction device to navigate away from the wake screen user interface 490 and display the home screen user interface 492 or the last-displayed application user interface (optionally, after requesting and obtaining valid authentication data).

In some embodiments, the upward swipe gesture 4105 is a representative example of a home gesture or dismissal gesture (e.g., other examples include upward swipe gestures 4103a, 4103c, 4103d, 4103c, 4110a, and 4111a) that causes the multifunction device to dismiss the currently displayed user interface (e.g., the wake screen user interface 490, an application user interface (e.g., camera user interface 495, messages user interface 493, or another application user interface), the control user interface 498, the search user interface 494, the application library user interface 497, or the home screen configuration user interface) and navigate to the home screen user interface 492 or a last-displayed user interface (e.g., the wake screen user interface 490, the wake screen configuration user interface, the search user interface 494, an application user interface, or the home screen user interface 492).

In some embodiments, a downward swipe from a top edge (e.g., the central portion of the top edge, or any portion of the top edge) or an interior region of the wake screen user interface 490 (e.g., downward swipe 4106a, or another downward swipe) causes (4106a) the multifunction device to display the search user interface 494 that includes a search input region 4030 and one or more applications icons 4032 for recommended applications (e.g., recently used applications, and/or relevant applications based on the current context), as shown in FIG. 4C1. In some embodiments, in response to detecting a search input in the search input region 4030, the multifunction device retrieves and displays search results that include relevant application content (e.g., messages, notes, media files, and/or documents) from the different applications that are installed on the multifunction device, relevant applications (e.g., applications that are installed on the multifunction device and/or applications that are available in the app store), relevant webpages (e.g., bookmarked webpages and/or webpages newly retrieved from the Internet), and/or search results from other sources (e.g., news, social media platforms, and/or reference websites). In some embodiments, different sets of search results are provided depending on the locked and unlocked state of the multifunction device, and more details or additional search results may be displayed if the multifunction device is in the unlocked state when the search is performed. In some embodiments, the multifunction device attempts to obtain valid authentication data in response to receiving the search input, and displays different sets of search results depending on whether valid authentication data is obtained. In some embodiments, an upward swipe gesture 4103d that starts from the bottom edge of the search user interface (or another type of dismissal input) causes (4103d) the multifunction device to dismiss the search user interface 494 and redisplays the wake screen user interface 490 (e.g., since the wake screen user interface was the last displayed user interface), as shown in FIG. 4C1. In some embodiments, in response to a downward swipe 4106b from an interior region of the home screen user interface 492 causes (4106b) the multifunction device to display the search user interface 494; and in response to a subsequent upward swipe gesture 4103d from the bottom edge of the search user interface 494, the home screen user interface 492 is (4103d) redisplayed (e.g., since the home screen user interface was the last displayed user interface), as shown in FIG. 4C1.

In some embodiments, as shown in FIG. 4C1, a rightward swipe gesture 4102a that starts from a left edge or interior region of the wake screen user interface 490 causes (4102a) the multifunction device to navigate from the wake screen user interface 490 to a widget user interface 491 (or another system user interface other than the home screen user interface, such as a control user interface, a search user interface, or a notification history user interface). In some embodiments, the widget user interface 491 includes a plurality of widgets 4026 (e.g., including widget 4026a, widget 4026b and widget 4026c) that are automatically selected by the operating system and/or selected by the user for inclusion in the widget user interface 491. In some embodiments, the widgets 4026 displayed in the widget user interface 491 have form factors that are larger than the widgets 4008 displayed under the time element 4004 in the wake screen user interface 490. In some embodiments, the widgets 4026 displayed in the widget user interface 491 and the widgets 4008 displayed in the wake screen user interface 490 are independently selected and/or configured from each other. In some embodiments, the widgets 4026 in the widget user interface 491 include content from their respective applications and the content is automatically updated from time to time as the updates to the content becomes available in the respective applications. In some embodiments, selection of a respective widget (e.g., tapping on the respective widget, or providing other selection input directed to the respective widget) in the widget user interface causes the multifunction device to navigate away from the widget user interface 491 and displays a user interface of the application that corresponds to the respective widget (optionally, after valid authentication data is requested and/or obtained).

In some embodiments, an upward swipe gesture 4103a that starts from the bottom edge of the widget user interface 491 and/or a leftward swipe gesture 4103b that starts from the right edge or the interior region of the widget user interface 491 causes (4103a-1/4103b-1) the multifunction device to dismiss the widget user interface 491 and redisplay the wake screen user interface 490, as shown in FIG. 4C1.

In some embodiments, a leftward swipe gesture 4104b that starts from the right edge or interior portion of the wake screen user interface 490 causes (4104b) the multifunction device to navigate from the wake screen user interface 490 to a camera user interface 495 of the camera application. In some embodiments, access to the photo library through the camera application is restricted in the camera user interface 495 unless valid authentication data has been obtained. In some embodiments, as shown in FIG. 4C1, an upward swipe gesture 4103c that starts from the bottom edge of the camera user interface 495 or another dismissal input causes (4103c) the multifunction device to navigate away from the camera user interface 495 and redisplay the wake screen user interface 490 (e.g., since the wake screen user interface 490 is the last displayed user interface prior to displaying the camera user interface 495).

In some embodiments, a downward swipe gesture 4109a that starts from the right portion (and/or the left portion) of the top edge of the wake screen user interface (e.g., as illustrated in FIG. 4C2) causes (4109a) the multifunction device to display the control user interface 498 overlaying or replacing display of the wake screen user interface 490. In some embodiments, the control user interface 498 includes status information for one or more static status indicators displayed in the static status region 4022, and respective sets of controls 4028 (e.g., including control 4028a, control 4028b, and control 4028c) for various system functions, such as network connections (WiFi, cellular data, airplane mode, Bluetooth, and other connection types), media playback controls, display controls (e.g., display brightness, color temperature, night shift, true tone, and dark mode controls), audio controls (e.g., volume, and/or mute/unmute controls, focus mode controls (e.g., DND, work, study, sleep, and other modes in which generation of alerts and notifications are moderated based on context and configurations, and application icons (e.g., flashlight, timer, calculator, camera, screen recording, and/or other user-selected or system recommended applications))). In some embodiments, an upward swipe gesture 4110a that starts from the bottom edge of the control user interface 498 (or another dismissal input) causes the multifunction device to dismiss the control user interface 498 and redisplay (4110a-1) the wake screen user interface 490 (e.g., since the wake screen user interface 490 is the last displayed user interface prior to displaying the control user interface 498). Additional features and details regarding the control user interface 498 and user interactions related to the control user interface 498 are disclosed in other parts of this specification.

In some embodiments, an upward swipe gesture 4107 that starts from the interior region of the wake screen user interface 490 and/or an upward swipe gesture that starts from the interior of the coversheet user interface 496 (e.g., optionally, when there are no unread notifications displayed in the coversheet user interface) causes (4107) the multifunction device to display the notification history user interface that includes a plurality of previously saved notifications and notifications that have been sent directly to notification history without first being displayed on the wake screen user interface 490. In some embodiments, the notification history user interface can be scrolled to reveal additional notifications in response to an upward swipe gesture 4118 directed to the notification history in the wake screen user interface 490 and/or the coversheet user interface 496. In some embodiments, the notification history is displayed as part of the wake screen user interface 490 and/or coversheet user interface 496, and a downward swipe gesture 4103f that is directed to the interior portion of the notification history causes the notification history to cease to be displayed and causes the wake screen user interface 490 and/or coversheet user interface 496 to be redisplayed without the notification history.

As described above, after navigating from the wake screen user interface 490 to a respective user interface other than the home screen user interface (e.g., in response to a swipe gesture in the downward, leftward, or rightward directions), an upward swipe gesture 4103 (e.g., 4103a, and 4103c through 4103f) that starts from a bottom edge of the respective user interface (e.g., an upward swipe gesture that starts from the bottom edge of the touch-sensitive display that displays a respective user interface in full screen mode, or an upward swipe gesture that starts from the bottom edge of a touch-sensitive surface that corresponds to the display that displays the respective user interface) causes the multifunction device to dismiss the respective user interface and returns to the wake screen user interface 490. In contrast, an upward swipe gesture 4105 that starts from the bottom edge of the wake screen user interface 490 causes (4105) the multifunction device to navigate away from the wake screen user interface 490 and displays the home screen user interface 492, and another upward swipe gesture that starts from the bottom edge of the home screen user interface 492 does not cause the multifunction device to dismiss the home screen user interface 492 and return to the wake screen user interface 490. In other words, once the navigation from the wake screen user interface 490 to the home screen user interface 492 is completed, the multifunction device is no longer in the restricted state, and access to the application icons displayed on the home screen user interface 492 and access to the content and functions of the computer system are unrestricted to the user. The upward swipe gesture that starts from the bottom edge of the currently displayed user interface is a representative example of a dismissal input that dismisses the currently displayed user interface and redisplays the last displayed user interface. The upward swipe gesture that starts from the bottom edge of the currently displayed user interface is also a representative example of a home gesture that dismisses the currently displayed user interface and displays the home screen user interface (e.g., irrespective of whether the home screen user interface was the last displayed user interface prior to displaying the currently displayed user interface).

As shown in FIG. 4C2, once the multifunction device navigates away from the wake screen user interface 490 and displays the home screen user interface 492, the user can access the functions and applications of the multifunction device without restriction. For example, in some embodiments, the home screen user interface 492 includes multiple pages, and a respective page of the home screen user interface includes a respective set of application icons and/or widgets corresponding to different applications, and user selection of (e.g., by tapping on, clicking on, or otherwise selecting) a respective widget or application icon causes the multifunction device to display an application user interface of the application that corresponds to the respective widget or application icon.

In some embodiments, the home screen user interface 492 displays a search affordance 4034 (e.g., as illustrated in FIG. 4C1), and a tap on the search affordance 4034 causes the search user interface 494 described above to be displayed overlaying the home screen user interface 492. In some embodiments, in response to detecting an upward swipe gesture 4103d that starts from the bottom edge of the search user interface (or another dismissal input), the multifunction device dismisses the search user interface 494 and redisplays (4103d) the home screen user interface 492 (e.g., not the wake screen user interface 490, as the upward edge swipe gesture dismisses the currently displayed user interface and redisplays the last displayed system user interface).

In some embodiments, as shown in FIG. 4C1, a rightward swipe gesture 4102b that starts from the left edge of the first page of the home screen user interface 492 causes (4102b) the multifunction device to display the widget user interface 491 described above. In some embodiments, a leftward swipe gesture (e.g., gesture 4103b, or another leftward swipe gesture) that starts from the right edge or the interior region of the widget user interface or an upward swipe gesture (e.g., gesture 4103a, or another upward swipe gesture) that starts from the bottom edge of the widget user interface 491 causes (4103a-2/4103b-2) the multifunction device to navigate away from the widget user interface 491 and redisplays the first page of the home screen user interface 492 (e.g., when the home screen user interface 492 was the last displayed user interface prior to displaying the widget user interface 491).

In some embodiments, consecutive leftward swipe gestures 4116 on the home screen user interface 492, as shown in FIG. 4C2, navigates through consecutive pages of the home screen user interface 492 until the application library user interface 497 is (4116) displayed. In some embodiments, the application library user interface 497 displays application icons from multiple pages of the home screen user interface grouped into different categories. In some embodiments, the application library user interface 497 includes a search user interface element 4036 that accepts search criteria (e.g., keywords, image, and/or other search criteria) and returns application icons for relevant applications (e.g., applications that are stored on the multifunction device and/or available in the app store) as search results. In some embodiments, user selection of (e.g., by a tap input, a click input, or another type of selection input) on an application icon in the search results and/or in the application library causes the multifunction device to display the application user interface of the application that corresponds to the selected application icon.

In some embodiments, a downward swipe gesture 4109c that starts from the right portion of the top edge of the application library user interface 497 causes display of the control user interface 498 as described above. In some embodiments, an upward swipe gesture (e.g., upward swipe gesture 4110a, or another upward swipe gesture) that starts from the bottom edge of the control user interface 498 or another dismissal input causes the multifunction device to dismiss the control user interface 498 and redisplay the application library user interface 497 (e.g., since the application library user interface is the last displayed user interface before the display of the control user interface) (e.g., or redisplay another user interface (e.g., redisplay (4110a-1) the wake screen user interface 490 (e.g., if control user interface 498 is displayed in response to swipe gesture 4109a), redisplay (4110a-3) the home screen user interface 492 (e.g., if the control user interface is displayed in response to a downward swipe from the top right portion of the top edge of the display), or redisplay (4110a-2) the application user interface (e.g., if the control user interface is displayed in response to the downward swipe 4109b) that was the last displayed user interface prior to displaying the control user interface).

In some embodiments, a rightward swipe gesture 4115 that starts from the interior region or the left edge of the application library user interface 497 or an upward swipe gesture that starts from the bottom edge of the application library user interface 497 causes (4115) the multifunction device to dismiss the application library user interface 497 and redisplays the last page of the home screen user interface 492.

In some embodiments, a downward swipe gesture 4114 that starts from the interior region of the application library user interface 497 causes the multifunction device to display the application icons for applications stored on the multifunction device in a scrollable list (e.g., according to chronological or alphabetical order).

In some embodiments, an upward swipe gesture that starts from the bottom edge of the home screen user interface causes the multifunction device to display the first page of the home screen user interface 492 or display the multitasking user interface 488 (also referred to an application switcher user interface). In some embodiments, different criteria (e.g., criteria based on the speed, direction, duration, distance, intensity, and/or other characteristics) are used to determine whether to navigate to the first page of the home screen user interface 492 or to the multitasking user interface 488 in response to detecting the upward swipe gesture that starts from the bottom edge of the home screen user interface. For example, in some embodiments, a short flick and a slow and long swipe cause the multifunction device to navigate to the first page of the home screen user interface 492, while a slow and medium length swipe causes the multifunction device to display the multitasking user interface 488. In some embodiments, a navigation gesture is dynamically evaluated before the termination of the gesture is detected, and therefore, the estimated destination user interface of the navigation gesture continues to change and visual feedback regarding the estimated destination user interface continues to be provided to guide the user to conclude the gesture when the desired destination user interface is indicated by the visual feedback. In some embodiments, in response to a user input 4117 at a portion of the multitasking user interface 488 that does not correspond to an application, a last displayed user interface that is displayed before displaying the multitasking user interface 488 is displayed (e.g., home screen user interface 492 is displayed when the multitasking user interface 488 is displayed in response to user input 4111b).

In some embodiments, a reconfiguration mode of the home screen user interface 492 is displayed in which application icons and/or widgets can be repositioned in, removed from, or added to the different pages of the home screen user interface 492. In some embodiments, a touch and hold gesture or another enhanced selection input directed to the home screen user interface 492 for a respective threshold amount of time or another enhanced selection input directed to the home screen user interface 492 cause the multifunction device to display the home screen user interface 492 in the configuration mode. In some embodiments, selection of the search affordance 4034 in the home screen user interface 492 while the home screen user interface 492 is in the reconfiguration mode causes the multifunction device to display a page editing user interface for the home screen user interface in which pages of the home screen user interface may be reordered, deleted, hidden, or created. In some embodiments, a tap input on the home screen user interface in the reconfiguration mode, causes the home screen user interface to exit the reconfiguration mode. In some embodiments, a tap input on unoccupied portion of the page editing user interface causes the multifunction device to exist the page editing user interface and redisplays the home screen user interface in the reconfiguration mode. Another tap on the home screen user interface causes the home screen user interface to exit the reconfiguration mode and be redisplayed in the normal mode.

In some embodiments, while displaying the home screen user interface 492, a downward swipe gesture 4108a that starts from the top edge of the home screen user interface 492 causes (4108a) the multifunction device to cover the home screen user interface 492 with the coversheet user interface 496 (also referred to as the wake screen user interface 490 if the user interface is displayed when transitioning from a normal mode to a low-power mode, and/or vice versa (e.g., due to inactivity, due to activation of the power button, and/or due to user input that corresponds to a request to wake or lock the device)) and the access to the home screen user interface is temporarily restricted by the coversheet user interface 496. In some embodiments, while the coversheet user interface 496 is displayed, an upward swipe gesture 4103e that starts from the bottom edge of the coversheet user interface 496 dismisses (4103e) the coversheet user interface 496 and redisplays the home screen user interface 492 (e.g., since the home screen user interface is the last displayed user interface). In some embodiments, the coversheet user interface has responses to user inputs in a manner analogous to those described with respect to the wake screen user interface 490.

In some embodiments, an application user interface of a respective application can be displayed in response to user inputs in a number of scenarios, such as tapping on a widget displayed in the home screen user interface or the widget user interface; tapping on an application icon displayed in the home screen, in the widget user interface, in the search result or recommended application portion of the search user interface, in the application library user interface or in the search results provided in a search in the application library user interface; tapping on a notification on the wake screen user interface or in the notification history; tapping on a representation of an application in the multitasking user interface; or selecting a link to an application in a user interface of another application (e.g., a link to a document, a link to a phone number, a link to a message, a link to an image, and other types of links). In some embodiments, a user interface of a single application is displayed in a full-screen mode. In some embodiments, user interfaces of two or more applications are displayed in a concurrent-display configuration, such as in a side-by-side display configuration where the user interfaces of the applications are displayed adjacent to one another to fit within the display, or in an overlay display configuration where the user interface of a first application is displayed in the full-screen mode while the user interfaces of other applications are overlaid on portion(s) of the user interface of the first application (e.g., in a single stack or separately on different portions).

In some embodiments, while displaying a user interface of an application, an upward swipe gesture (e.g., upward swipe gesture 4111a, or another upward swipe gesture) that starts from the bottom edge of the application user interface (e.g., messages user interface 493, or another user interface of an application) or another dismissal input or home gesture causes (4111a-1, or 4111a-2) the multifunction device to dismiss the currently displayed application user interface, and display either the home screen user interface (e.g., shown as transition 4111a-1) or the multitasking user interface (e.g., shown as transition 4111a-1) depending on the characteristics of the upward swipe gesture. In some embodiments, while displaying home screen user interface 492, an upward swipe gesture 4111b that starts from the bottom edge of the home screen user interface causes (4111b) the multifunction device to dismiss the currently displayed home screen user interface 492, and display the multitasking user interface 488.

In some embodiments, a horizontal swipe gesture in the leftward and/or rightward direction that is performed within a bottom portion of the application use interface(s) causes the multifunction device to switch to another previously displayed application user interface of a different application. In some embodiments, the same swipe gesture that starts from the bottom portion of a respective application user interface is continuously evaluated, to determine and update an estimated destination user interface among the multitasking user interface 488, the home screen user interface 492, or a user interface of a previously displayed application, based on the characteristics of the swipe gesture (e.g., location, speed, direction, and/or change in one or more of the above), and a final destination user interface is displayed in accordance with the estimated destination user interface at the termination of the swipe gesture (e.g., lift off of the contact, reduction in intensity of the contact, a pause in movement, and/or another type of change in the input).

In some embodiments, while displaying an application user interface of a respective application (or displaying application user interfaces of multiple applications in a concurrent-display configuration), a downward swipe gesture 4108b that starts from the top edge of the application user interface(s) causes (4108b) the multifunction device to display the coversheet user interface 496 (e.g., in FIG. 4C1) (or the wake screen user interface 490 in FIG. 4C2) over the application user interface(s). The multifunction device dismisses the coversheet user interface 496 (or the wake screen user interface 490) and redisplays the application user interface(s) in response to an upward swipe gesture that starts from the bottom edge of the coversheet user interface (or another dismissal input).

In some embodiments, as shown in FIG. 4C2, a downward swipe gesture 4109b that starts from the static status region 4022 on the display cause (4109b) the multifunction device to display the control user interface 498 over the application user interface(s), and an upward swipe gesture 4110a that starts from the bottom edge of the control user interface 498 (or another dismissal input) dismisses the control user interface 498 and causes (4110a-2) the application user interfaces to be redisplayed (e.g., or the last displayed user interface that is displayed before displaying the control user interface 498).

In some embodiments, rotation of the display causes the multifunction device to display a different version of the currently displayed user interface (e.g., application user interface, home screen user interface, wake screen user interface, control user interface, notification user interface, widget user interface, application library user interface, and other user interfaces described with respect to FIGS. 4C1-4C2) that have a differently layout (e.g., landscape version vs. portrait version). In some embodiments, rotation of the display has no effect on the orientation of the respective user interface that is currently displayed.

In some embodiments, when the device is placed on a docking station or is connected wirelessly or through a contact-based connection (e.g., via electronic connection, or magnetic connection) to a charging source, rotation of the display when the wake screen user interface is displayed and/or when the device is in the low power state, cause the device to enter a standby mode, where a different set of navigation states are made available. In some embodiments, swiping in the vertical direction causes the device to navigate between different versions of a functional “face” (e.g., a user interface that provides a primary function, such as a “clock” face, a “weather” face, a “calendar” face, a “stock” face, a “photos” face, a “widget” face, or user interface that provides another function), while swiping in the horizontal direction cause the device to navigate between different functional faces. In some embodiments, swiping downward from the upper right corner of the display causes the device to display a “control” face that includes controls for various control functions of the device. Swiping upward from the bottom edge of the display when the “control” face is displayed causes the device to dismiss the “control” face and redisplay the last displayed functional face.

The above description of the navigation between user interfaces and exact appearances and components of the various user interfaces are merely illustrative and may be implemented with variations in various embodiments described herein. In addition, the transitions between pairs of user interfaces illustrated in FIGS. 4C1-4C2 are only a subset of all transitions that are possible between different pairs of user interfaces illustrated in FIGS. 4C1-4C2, and a transition to a respective user interface may be possible from any of multiple other user interfaces, in accordance with a respective user input of a same type, directed to a same interaction region of the display, and/or in accordance with a different type of input or directed to a different interactive region, in accordance with various embodiments.

### USER INTERFACES AND ASSOCIATED PROCESSES

Attention is now directed towards embodiments of user interfaces (“UI”) and associated processes that may be implemented on an electronic device (or computer system more generally), such as portable multifunction device 100 or device 300, with a display, a touch-sensitive surface, (optionally) one or more tactile output generators for generating tactile outputs, and (optionally) one or more sensors to detect intensities of contacts with the touch-sensitive surface.

FIGS. 5A-5F, 6A-6G, 7A-7T, 8A-8D, 9A-9F, 10A-10AE, 11A-11F, and 12A-12G illustrate example user interfaces for locking and/or hiding applications. The user interfaces in FIGS. 5A-5F, 6A-6G, 7A-7T, 8A-8D, 9A-9F, 10A-10AE, 11A-11F, and 12A-12G used to illustrate the processes in FIGS. 13A-13F and 14A-14J. For convenience of explanation, some of the embodiments will be discussed with reference to operations performed on a device with a touch-sensitive display system 112. In such embodiments, the focus selector is, optionally: a respective finger or stylus contact, a representative point corresponding to a finger or stylus contact (e.g., a centroid of a respective contact or a point associated with a respective contact), or a centroid of two or more contacts detected on the touch-sensitive display system 112. However, analogous operations are, optionally, performed on a device with a display 450 and a separate touch-sensitive surface 451 in response to detecting the contacts on the touch-sensitive surface 451 while displaying the user interfaces shown in the figures on the display 450, along with a focus selector, and/or in response to detecting other types of inputs performed using an input device (e.g., a hardware button, a controller, a mouse, a trackpad, or another control device) while a location or object is targeted, such as via a focus selector (e.g., a pointer, or a cursor, or a gaze) being on the location or object, and/or an air gesture performed using an input element such as hand(s) or finger(s) (e.g., a hand waving, a hand flipping, two hands moving toward each other, two fingers pinching, and/or one finger tapping) posed, changing pose, and/or moving in physical space while a location or object is targeted, such as when the location of the hand(s) and/or finger(s) are on or near the object or the location or while a focus selector is on the location or object.

FIGS. 5A-5F illustrate example user interfaces for accessing content associated with a locked application from another application in accordance with some embodiments in accordance with some embodiments. FIG. 5A illustrates device 100 displaying a home screen user interface (e.g., home screen user interface 492, FIGS. 4C1-4C2). In some embodiments, the device 100 displays a session region 502-1.

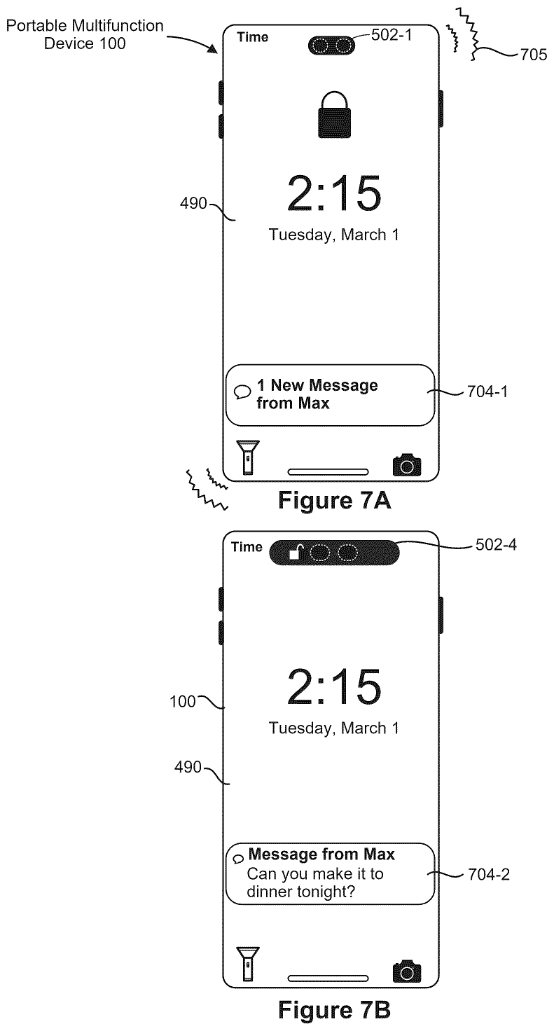

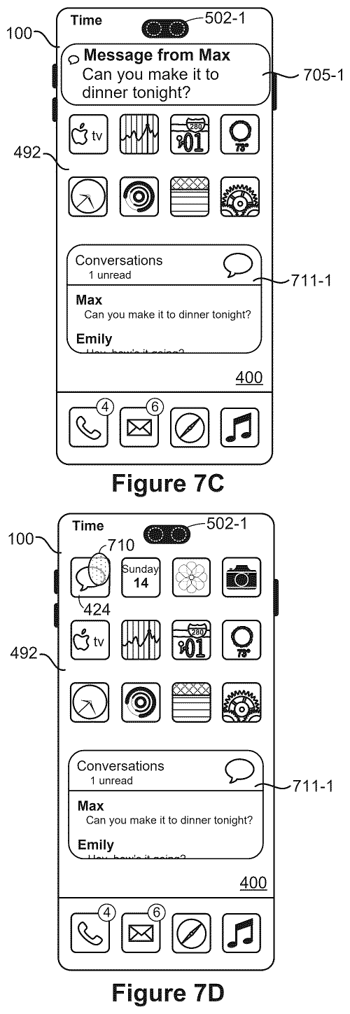

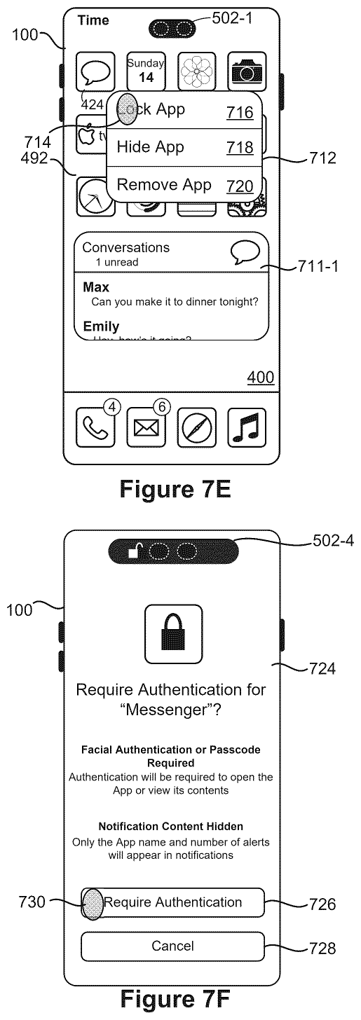

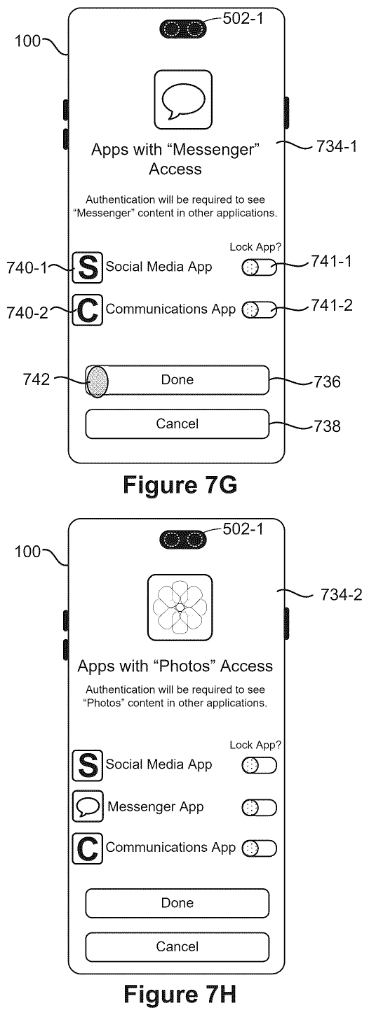

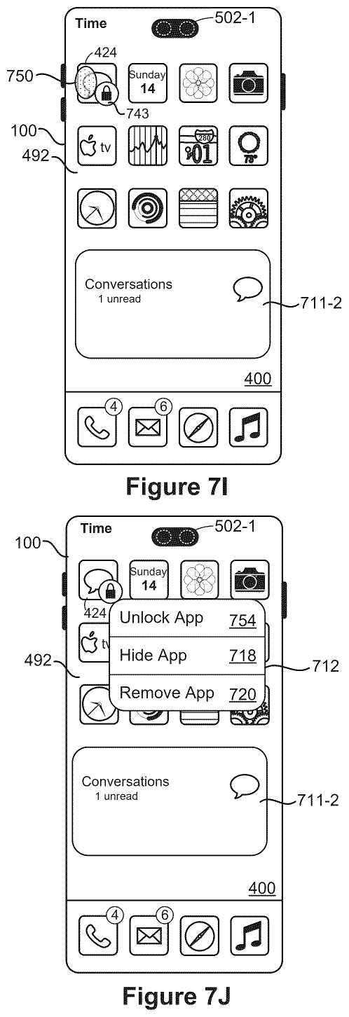

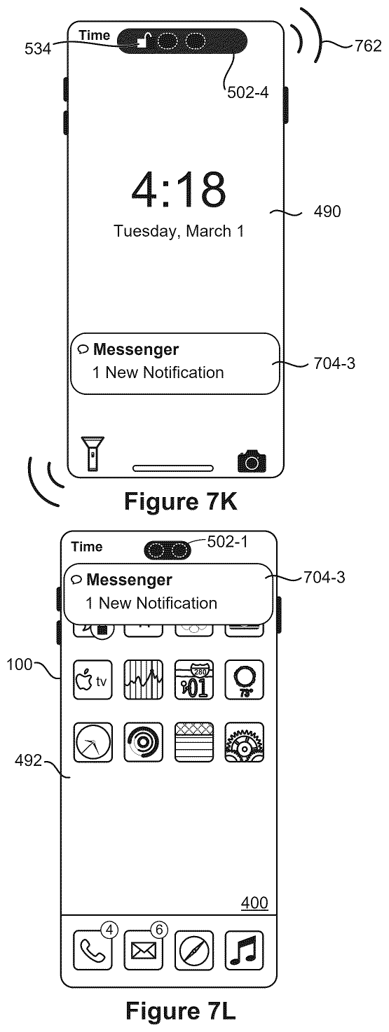

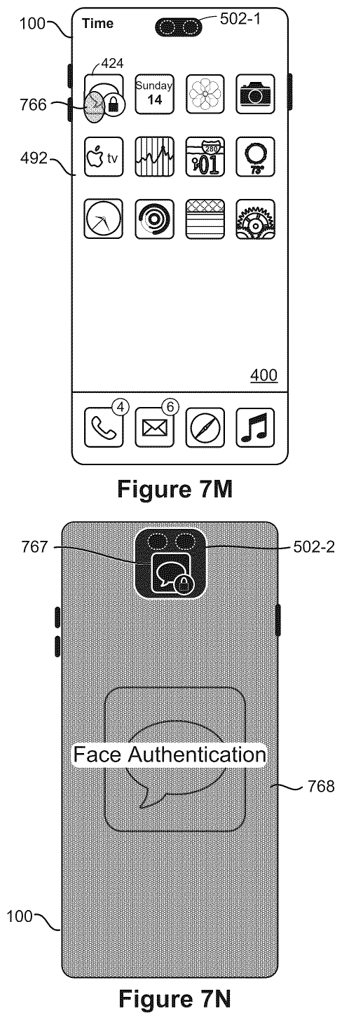

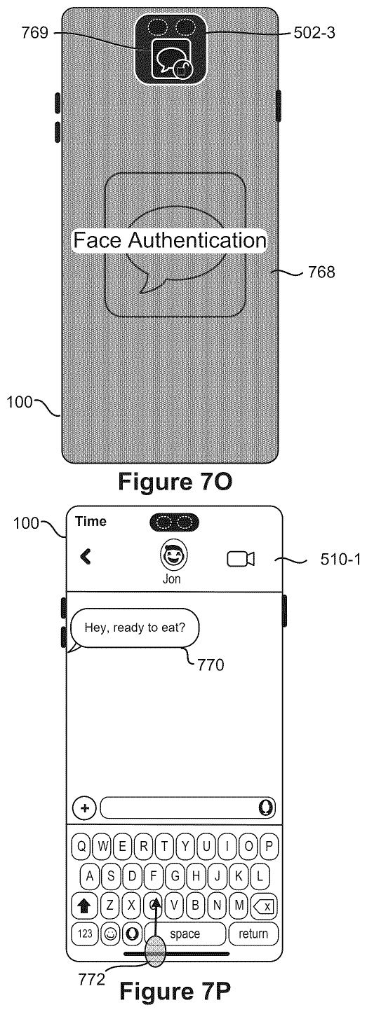

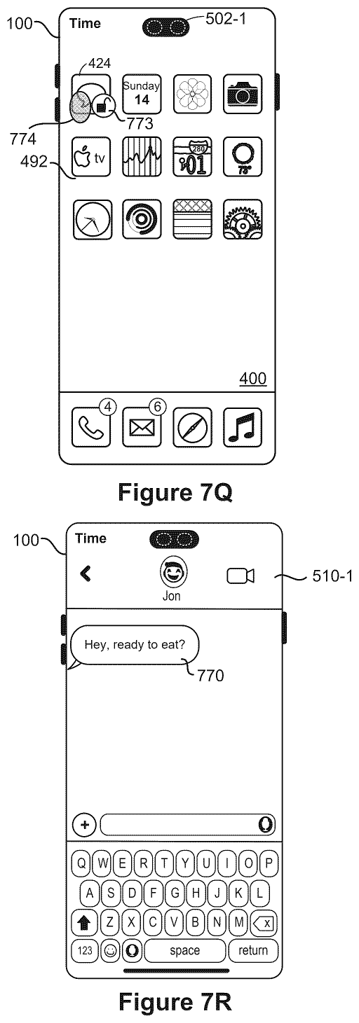

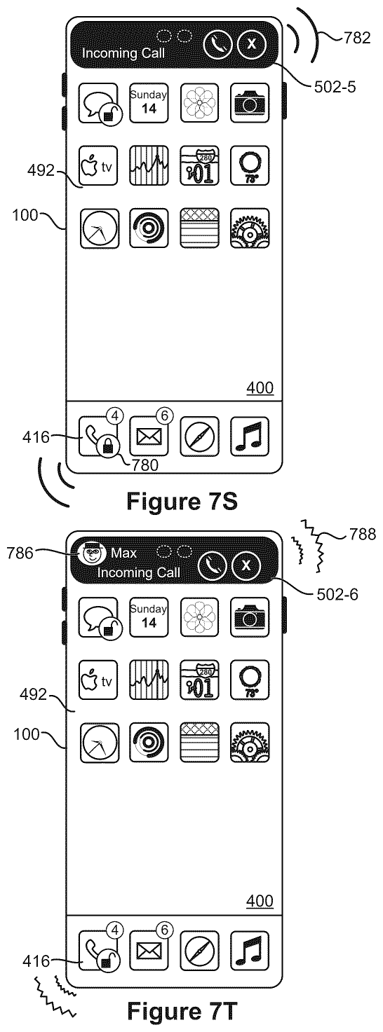

In some embodiments, the home screen user interface 492 includes a plurality of application icons, including application icon 424 for a messenger application and icon 428 for a photos application. In some embodiments, the photos application is a locked application in a locked state, as indicated by a lock indication 507 that is optionally displayed with the application icon 428. In some embodiments, the lock indication 507 is not displayed with the application icon 428 (e.g., the application icon 428 is displayed regardless of whether the application is a locked application or not). In some embodiments, an application that is a locked application requires additional authentication, such as biometric authentication, before enabling a user to access content of the application. In some embodiments, one or more applications are set to the locked state (e.g., and/or an unlocked state) via one or more user inputs, as described below with reference to FIGS. 7E-7J.

In some embodiments, in response to detecting a user input 506 (e.g., in FIG. 5A), such as a tap user input or other selection user input directed to the application icon 424 for the messenger application, a user interface 510 for the messenger application is displayed by the device 100, as illustrated in FIG. 5B. In some embodiments, the user interface 510 for the messenger application includes a message 512 from Tina. In some embodiments, the user interface 510 for the messenger application includes an option 514 to insert content into a message (e.g., to send from the device 100 to Tina). In some embodiments, in response to detecting a user input 516 (e.g., in FIG. 5B), such as a tap user input or other selection input, directed to the option 514, the device 100 displays the user interface 510-2 that includes a plurality of options 522 (e.g., including options 522-1 through 522-7) for inserting content, as illustrated in FIG. 5C. In some embodiments, one or more of the plurality of options 522 corresponds to an application associated with content, a file storing content and/or an operation to perform related to content, whereby the content is inserted into the message in the messenger application. For example, option 522-1 corresponds to a camera application for accessing one or more cameras of device 100 (e.g., and/or capturing a photo or video using the one or more cameras) to insert content captured by the one or more cameras; option 522-2 corresponds to a photos application for accessing one or more photos and/or videos stored in the photos application; option 522-3 corresponds to a file storing one or more stickers (e.g., images, avatars, GIFs, or other content); option 522-4 corresponds to a cash application for inserting a payment to be made via the cash application; option 522-5 corresponds to an audio application for recording and/or accessing a voice recording; option 522-6 corresponds to a location application, such as a maps application, e.g., for inserting a current location of the device 100; and option 522-7 corresponds to an option to view additional options corresponding to one or more other applications, files and/or actions to insert into the message.

In some embodiments, in response to detecting a user input directed to a respective application of the one or more applications that are unlocked (e.g., the applications other than the photos application), the device 100 displays content for the respective application without requiring additional authentication from the user. As such, if an application (e.g., messenger application, social media application, and/or another application) attempts to access content from a locked application (e.g., the photos application), the device 100 requires the user to provide successful authentication before allowing the application to access the content from the locked application.

FIG. 5C illustrates that the option 522-2 corresponding to the photos application is locked (e.g., as indicated by lock indication 507), while the other displayed options 522 are not displayed as locked. In some embodiments, in response to detecting a user input 524, such as a tap input or other selection input, directed to the option 522-2 corresponding to the photos application, the device 100 initiates a process for authenticating a user of the device 100 before granting the user access to the photos application (e.g., and/or content of the photos application). In some embodiments, the authentication process for authenticating the user is performed automatically without requiring additional input from the user. For example, the session region 502-2 (e.g., in FIG. 5D) is updated to optionally display a representation 530 of the photos application that is in the locked state. In some embodiments, the session region 502-2 corresponds to a prompt for the user to authenticate, for example, using biometric authentication (e.g., facial scan, fingerprint scan, eye scan, and/or another type of biometric scan) and/or using a passcode. In some embodiments, the session region 502-2 is updated to display an indication of the current state of the device 100, such as an animation of a lock symbol going from a locked state to an open state (e.g., as illustrated in the session region 502-4, FIG. 7B) optionally without displaying an indication of which application is being unlocked (e.g., the session region 502-4 is displayed without displaying the representation 530).

In some embodiments, in response to detecting that the user has successfully authenticated (e.g., via a matching biometric scan and/or via a correct passcode), the device 100 displays the session region 502-3 (e.g., in FIG. 5E) to include the representation 534 of the photos application that is in the unlocked state while maintaining display of the user interface 510-2. In some embodiments, the option 522-2 is also updated to indicate that the photos application associated with the option 522-2 is unlocked. In some embodiments, the one or more other options 522 (e.g., other than option 522-2) are optionally not displayed with a locked and/or unlocked indication. For example, options 522-1 and 522-3 through 522-6 are not associated with locked applications and/or locked files. In some embodiments, the device 100 forgoes displaying an indication of the locked and/or unlocked state for applications and/or files that have not been set to the locked state (e.g., application and/or files that are in a default state of being unlocked, without having been locked (e.g., as described with reference to FIGS. 7E-7J), are displayed without the indication).

FIG. 5F illustrates that, after the user has successfully authenticated, the device 100 redisplays the user interface 510-1 for the messenger application, including replacing display of a virtual keyboard (e.g., in FIG. 5B) with one or more photos 540 accessed from the photos application associated with the option 522-2. In some embodiments, the user interface 510-1 is automatically displayed, without additional user input, after the user has successfully authenticated (e.g., after displaying the updated session region 502-3 in the user interface 510-2, the device 100 displays the user interface 510-1). In some embodiments, the user interface 510-1 is redisplayed in response to detecting a second user input directed to the option 522-2 after the photos application has been unlocked. In some embodiments, in response to detecting a user input directed to a respective photo of the one or more photos 540, the respective photo is inserted into the message draft and is optionally sent to Tina via the messenger application (e.g., in response to detecting a user input corresponding to a request to send the message draft that includes the respective photo).

It will be understood that while the example provided with reference to FIGS. 5A-5F describes a messenger application requesting access to a locked photos application, the methods of accessing a locked application from another application are applicable to other examples of applications. For example, while displaying a user interface of a first application (e.g., an unlocked or locked application), the device 100 detects a user input corresponding to a request to share content of the first application with and/or via one or more applications; and in response to detecting the user input, the device 100 displays a share sheet user interface. In some embodiments, the share sheet user interface displays one or more options for sharing the content of the first application with one or more applications, such as one or messaging applications and/or file sharing applications. In some embodiments, the share sheet user interface optionally displays one or more suggested contacts with whom to share the content of the first application (e.g., via one or more messaging and/or file sharing applications). In some embodiments, one or more of the messaging applications and/or file sharing applications are locked applications and in response to a user input corresponding to selection of a respective locked application (e.g., and/or a contact via a locked application), the device 100 initiates an authentication process (e.g., requiring biometric authentication and/or a passcode) before sharing the content of the first application with the selected respective locked application.

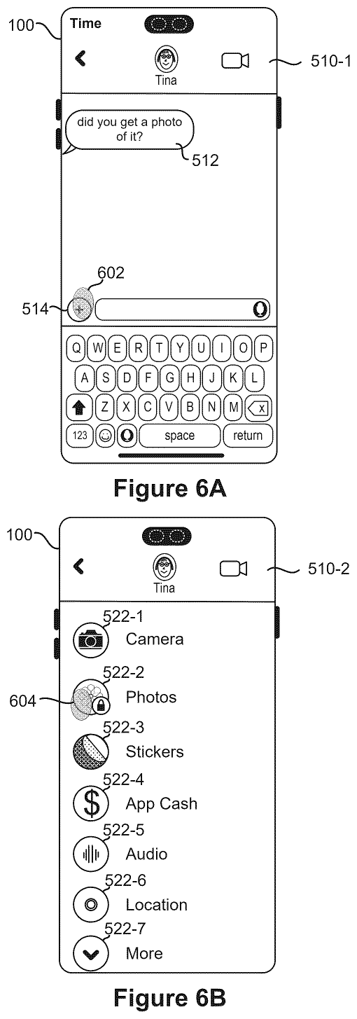

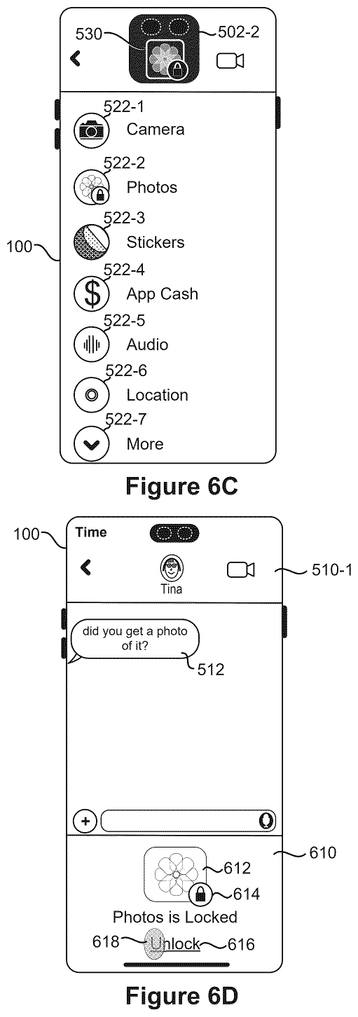

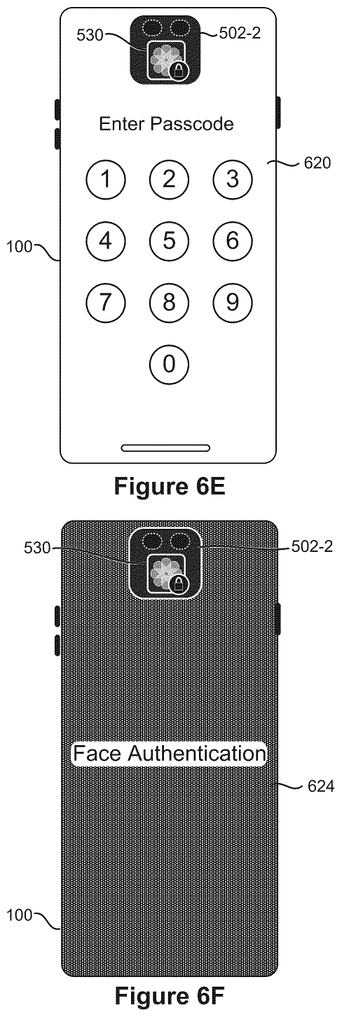

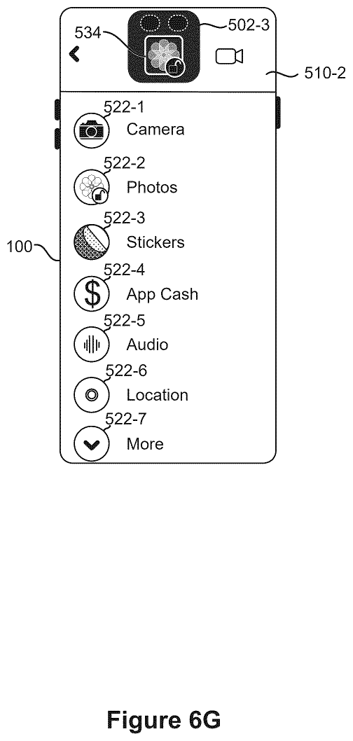

FIG. 6A illustrates another example of detecting a user input 602, such as a tap input or other selection input (e.g., corresponding to the user input 516, FIG. 5B), directed to the option 514. In response to detecting the user input 602, the user interface 510-2 is displayed, as illustrated in FIG. 6B. FIG. 6B illustrates detecting a user input 604, such as a tap input or other selection input (e.g., corresponding to the user input 524, FIG. 5C) directed to the option 522-2 associated with the photos application that is in the locked state. As described above with reference to FIGS. 5B-5D, in response to detecting the user input 604 (e.g., or the user input 524), the device 100 initiates a process for authenticating a user of the device 100 before granting the user access to the photos application (e.g., and/or content of the photos application).

FIG. 6C illustrates the session region 502-2 continues to display the representation 530 of the photos application in the locked state while the device 100 attempts to authenticate the user. In some embodiments, in accordance with a determination that the user is not successfully authenticated (e.g., did not match a biometric authentication), the device 100 redisplays the user interface 510-1 (e.g., in FIG. 6D). In some embodiments, the user is not successfully authenticated in accordance with a determination that a biometric scan does not match a stored biometric key within a threshold amount of time (e.g., within 3 seconds, 5 seconds, 10 seconds, 1 minute, or another amount of time).

FIG. 6D illustrates that, in accordance with a determination that the device 100 has not authenticated the user, the photos application associated with option 522-2 remains in the locked state, and the virtual keyboard (e.g., in FIG. 6A) in the user interface 510-1 is replaced with a region 610. In some embodiments, the region 610 includes a representation of the photos application 612 and an indication 614 of the locked state of the photos application 612, optionally with a textual indication that “Photos is Locked.” In some embodiments, the region 610 includes an unlock option 616 for unlocking the photos application 612. For example, in response to detecting a user input 618, such as a tap input or other selection input, directed to the unlock option 616, the device again initiates the process for authenticating a user of the device 100 to access the photos application 612. In some embodiments, the unlock option 616 is displayed in an authentication user interface 624 (e.g., in FIG. 6F) (e.g., instead of or in addition to being displayed in the region 610), such that, after failing authentication, the device 100 displays the authentication user interface 624 with the unlock option 616 that, when selected, causes the device 100 to reattempt authentication.

In some embodiments, because the user previously failed the biometric authentication, in response to detecting the user input 618, the device 100 presents the user with a user interface 620 to enter a passcode, as illustrated in FIG. 6E. In some embodiments, the session region 502-2 continues to display the representation 530 to indicate the photos application remains in the locked state in the user interface 620. In some embodiments, in response to detecting the user input 618, the device 100 displays authentication user interface 624 that prompts the user for a respective type of biometric authentication, such as face authentication and/or a fingerprint scan. In some embodiments, while the photos application remains in the locked state, the session region 502-2 continues to display the representation 530 in the user interface 624 to indicate the photos application remains in the locked state.

FIG. 6G illustrates, in accordance with a determination that the user has successfully authenticated by entering a correct passcode and/or via biometric authentication, the device 100 displays the user interface 510-2, including displaying the session region 502-3 with the representation 534 of the photos application in the unlocked state (e.g., as described above with reference to FIG. 5E) before displaying the user interface 510-1 with the one or more photos 540 that are accessed from the unlocked photos application, as described with reference to FIG. 5F.

FIGS. 7A-7T illustrate example user interfaces for providing alerts and/or notifications for locked and/or unlocked applications. For example, FIG. 7A illustrates the device 100 displaying a wake screen user interface 490 (e.g., FIGS. 4C1-4C2) while the device 100 is in a locked state. In some embodiments, while the device 100 is in the locked state (e.g., “locked”), in response to detecting an incoming message, the device 100 displays a limited notification 704-1 and optionally outputs an audio output and/or a tactile output 705 to indicate the occurrence of the incoming message. In some embodiments, the audio output and/or the tactile output 705 is a first type of output (e.g., having a first audio tone and/or haptic pattern) that is associated with the sender, Max (e.g., different contacts are optionally assigned to different tones and/or haptic patterns to be associated with notifications received from that respective contact). For example, the limited notification 704-1 displays information that optionally includes one or more of: the application associated with the alert (e.g., a messenger application and/or another application), a number of messages, and/or a sender of the message. In some embodiments, the limited notification 704-1 does not include a preview of the content of the received message.

In some embodiments, in response to detecting successful authentication of the user to unlock the device 100 (e.g., via biometric authentication and/or via a passcode) (e.g., optionally the same authentication that is required to access a locked and/or hidden application), the session region 502-4 is updated to indicate the device 100 is in the unlocked state (e.g., “unlocked”) while maintaining display of the wake screen user interface 490, as illustrated in FIG. 7B. In some embodiments, in accordance with a determination that the authentication is not successful, the device 100 remains in the locked state (e.g., and optionally reinitiates the authentication process for the device 100).

In some embodiments, unlocking the device 100 via the authentication process further unlocks one or more of the locked applications of the device. For example, in response to detecting a user input directed to a locked notification that is displayed in the wake screen user interface while the device 100 is locked, in response to authenticating the user, the device 100 unlocks and the locked application associated with the locked notification is unlocked (e.g., such that the user can view the content of the notification within an application user interface of the locked application).

In some embodiments, the wake screen user interface 490 displays a preview notification 704-2 that optionally includes one or more of: the application associated with the alert (e.g., a messenger application and/or another application), a number of messages, a sender of the message and/or a preview of the content of the received message (e.g., “Can you make it to dinner tonight?”). As such, additional information is provided in the preview notification 704-2 that is displayed while the device 100 is unlocked, as compared to the limited notification 704-1 that is displayed while the device 100 is locked.

FIG. 7C illustrates device 100 displaying a home screen user interface (e.g., home screen user interface 492, FIGS. 4C1-4C2) while an incoming message is detected (e.g., the incoming message corresponding to the preview notification 705-1). In some embodiments, the preview notification 705-1 includes the same information as the preview notification 704-2. For example, the device 100 is in the unlocked state while displaying the home screen user interface 492 and/or another application user interface, such that preview notifications are displayed in a notification region near the top of the currently displayed user interface.

In some embodiments, the home screen user interface 492 in FIG. 7C includes a messages widget 711-1 corresponding to the messenger application. For example, the messages widget 711-1 includes one or more previews of messages from one or more conversation threads in the messenger application (e.g., a thread with Max and a thread with Emily). In some embodiments, messages widget 711-1 is optionally scrollable. As illustrated in FIG. 7C, while the messenger application is not locked, previews of the messages are displayed in the widget 711-1 (e.g., while the device 100 is unlocked).

FIG. 7D illustrates the device 100 detecting a user input 710 directed to the application icon 424 for the messenger application. In some embodiments, in accordance with a determination that the user input 710 is a first type of user input, such as a tap input or other selection input, the device 100 displays a user interface for the messenger application (e.g., launches, opens, or otherwise displays the messenger application) in response to the user input 710. In some embodiments, in accordance with a determination that the user input 710 is a second type of user input, such as a tap and hold input (e.g., a long press), and/or other type of user input, the device 100 displays a quick actions menu 712, as illustrated in FIG. 7E.

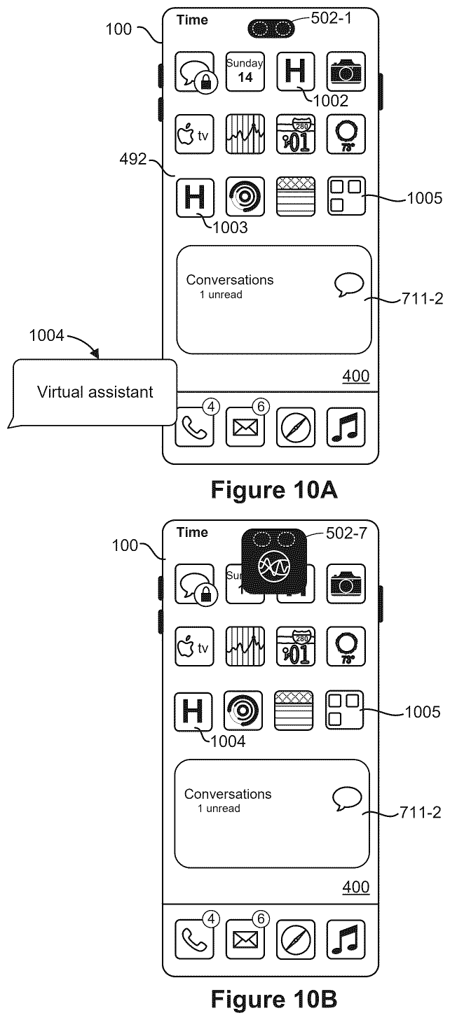

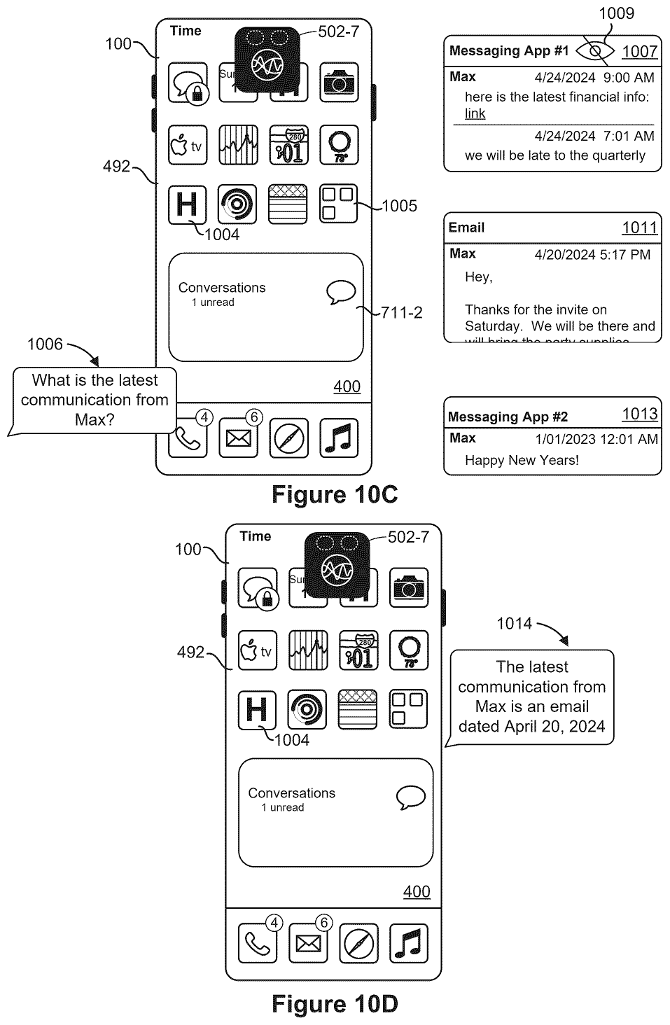

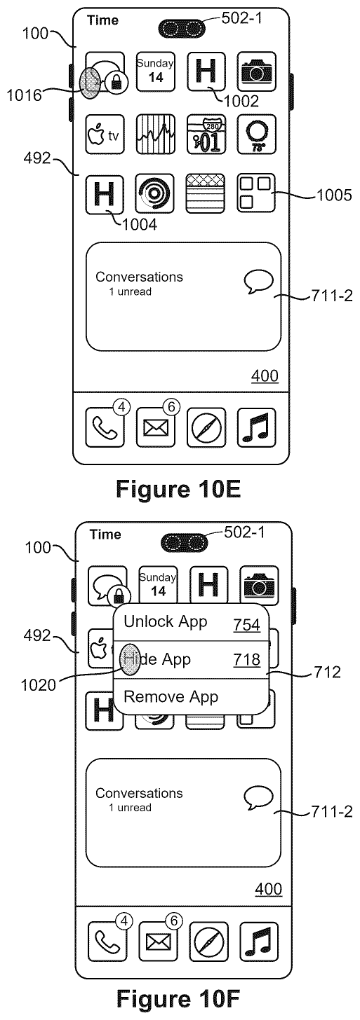

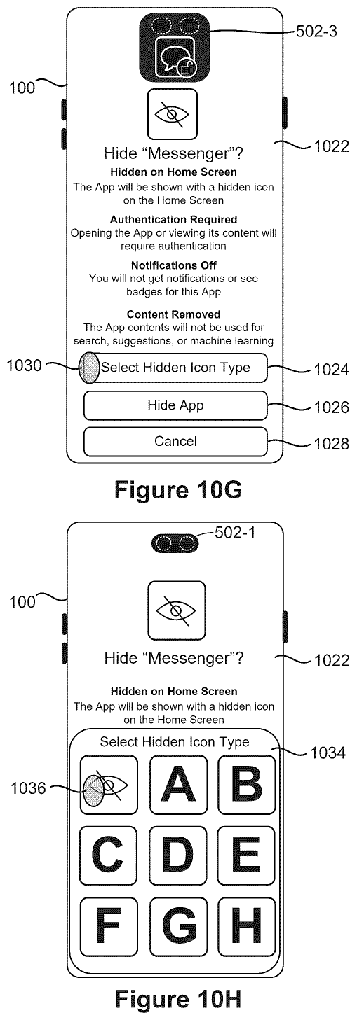

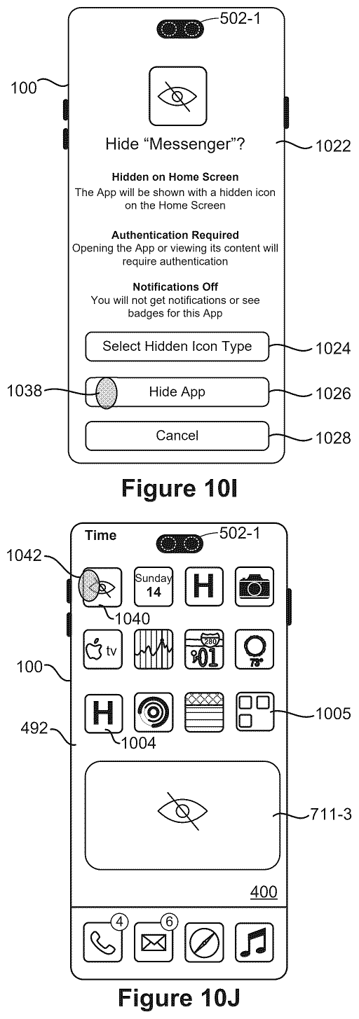

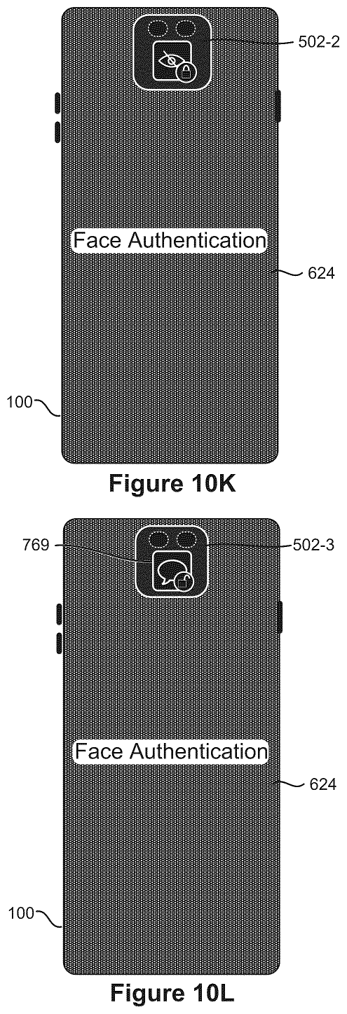

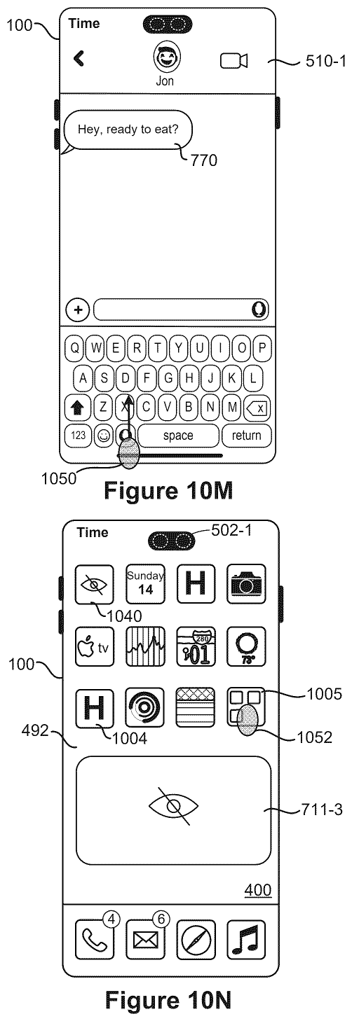

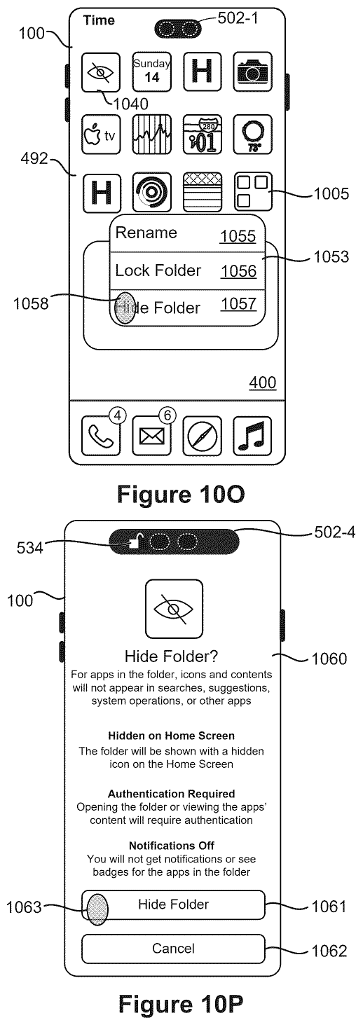

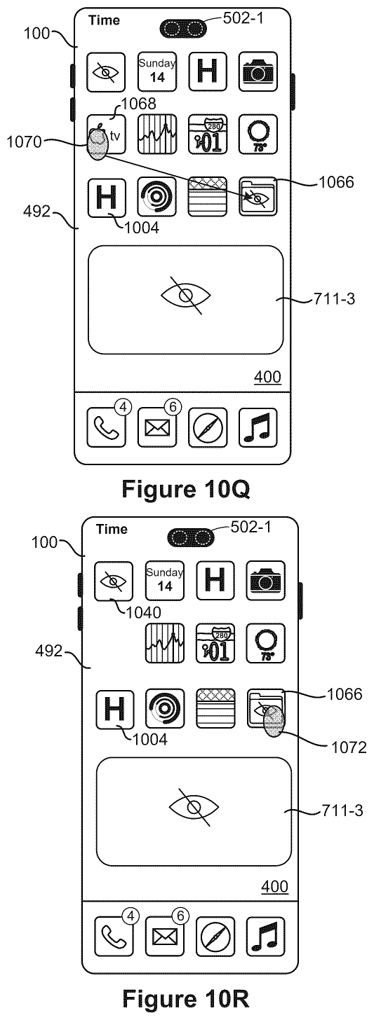

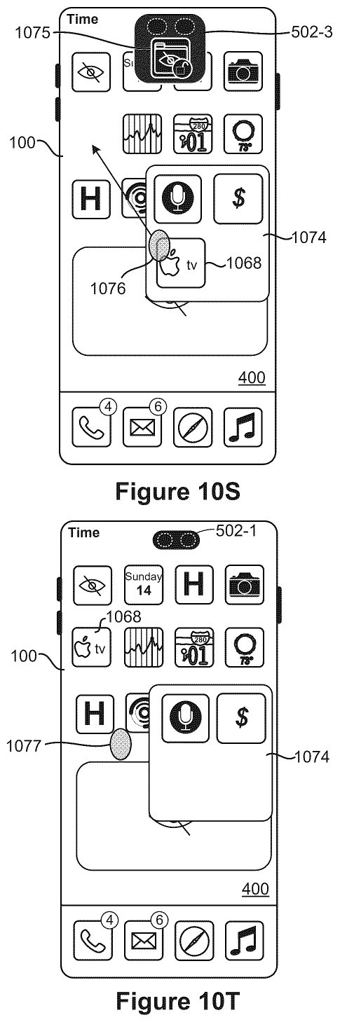

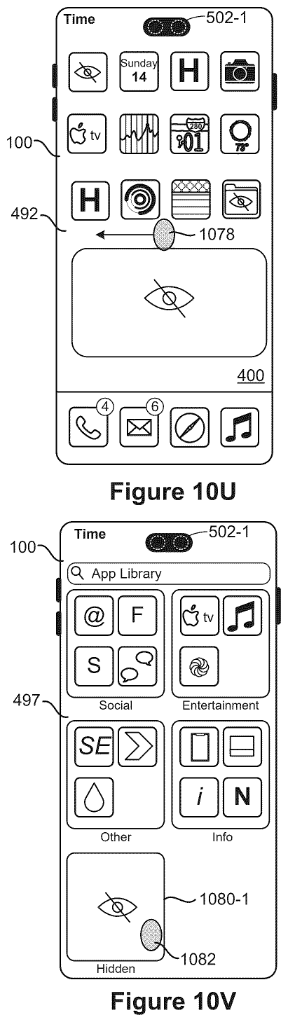

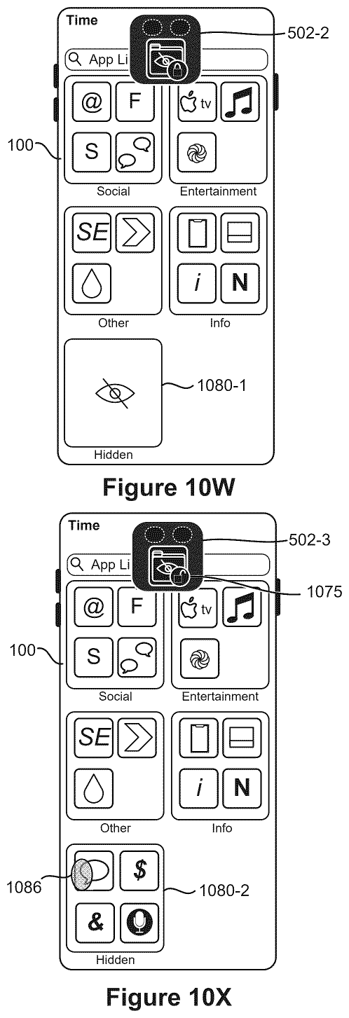

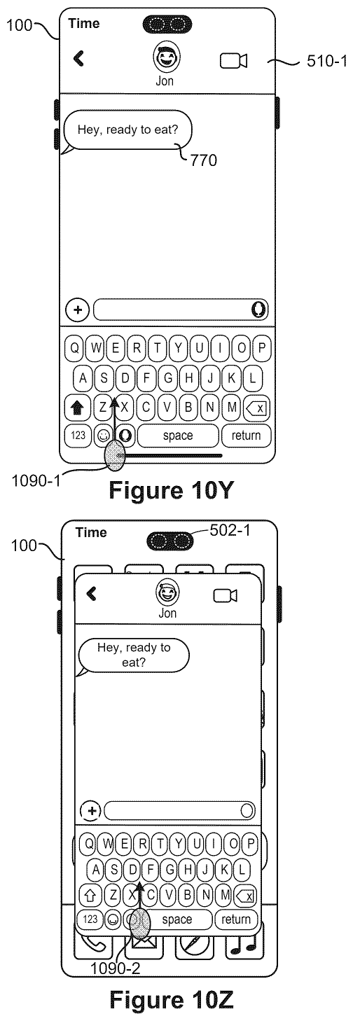

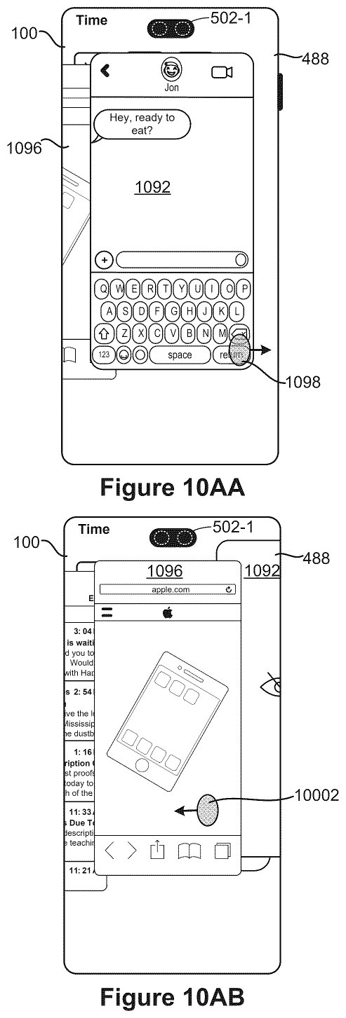

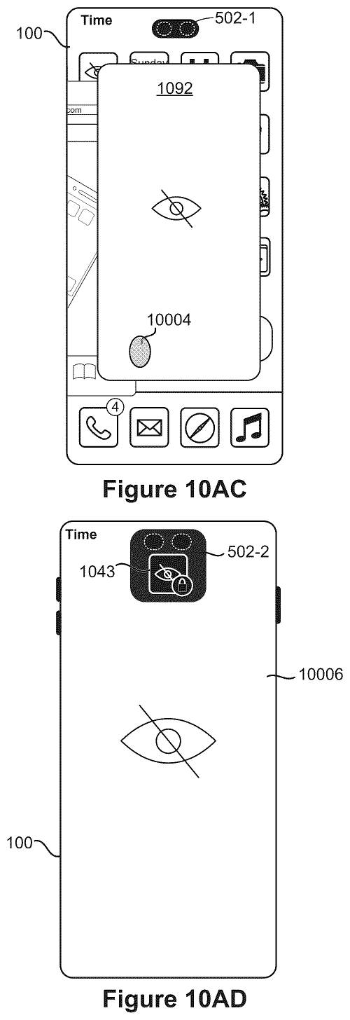

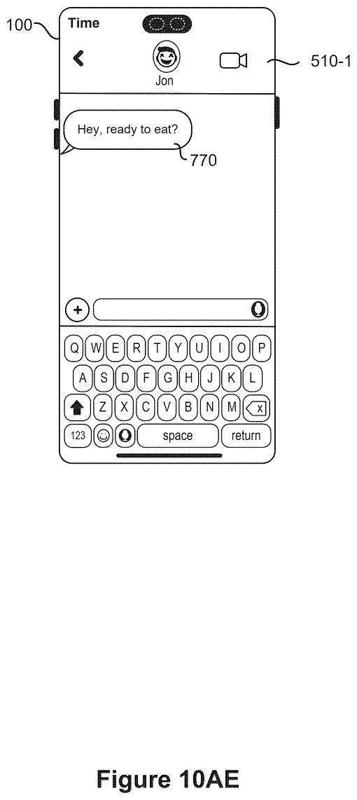

In some embodiments, the quick actions menu 712 (e.g., in FIG. 7E) includes a list of one or more selectable operations related to the application for application icon 424. For example, the quick actions menu 712 for the messenger application optionally includes a user-selectable option for initiating a new message draft, a user-selectable option for sending a new message to a recommended contact or group (e.g., a recent, pinned and/or favorite contact or group), a user-selectable option 720 for removing the application icon from the home screen user interface 492, a user-selectable option 716 for locking the application, and/or a user-selectable option 718 for hiding the application (e.g., as described in more detail with reference to FIGS. 10A-12G).

In some embodiments, the quick actions menu 712 includes a user-selectable option for requiring authentication (e.g., biometric authentication) (e.g., instead of displaying the user-selectable options 716 and 718). In some embodiments, in response to detecting a user input, such as a tap input or other selection input, directed to the user-selectable option for requiring biometric authentication, the device 100 displays a second menu (e.g., and ceases display of the quick action menu 712) that includes (i) an option to require biometric authentication (e.g., corresponding to the user-selectable option 716 for locking the application), (ii) an option to hide the application and require biometric authentication (e.g., corresponding to the user-selectable option 718 for hiding the application) and/or (iii) an option to cancel (e.g., dismiss the second menu).

In some embodiments, in response to detecting a user input 714, such as a tap input or other selection input, directed to the option 716 for locking the application (e.g., and/or directed to the option to require biometric authentication displayed in the second menu), the device 100 optionally requires authentication (e.g., biometric authentication) to enable the user to change the setting of the messenger application (e.g., to allow the user to lock and/or hide the application), as illustrated by an unlock indication in the session region 502-4. In some embodiments, after the user has successfully authenticated, the device 100 displays a user interface 724 (e.g., in FIG. 7F) that provides an explanation of requiring authentication for the messenger application and provides an option 726 for setting the application to require authentication and an option 728 to cancel (e.g., to forgo setting the application to require authentication). For example, the user interface 724 provides a description that, if authentication is required for the messenger application (e.g., the messenger application is put into the locked state), biometric authentication (e.g., face authentication, fingerprint authentication) and/or a passcode is required to open the messenger application and/or view its contents. Additionally, contents of notifications for the locked application (e.g., “locked notifications”) will be removed such that only an application name and number of alerts will be displayed in the notification before the application is unlocked (e.g., as opposed to the limited notification 704-1 and the preview notification 704-2 described with reference to FIGS. 7A-7B). As such, while a respective application is locked, the respective application and its contents are not displayed at the device 100 until after the user has successfully authenticated via biometric authentication and/or a passcode, and notifications for the respective application are provided as minimized notifications that only identify the name of the application and/or number of notifications for the respective application. In some embodiments, locked applications require biometric authentication by default, although in some embodiments the device 100 prompts the user to enter a passcode to authenticate instead of using biometric authentication after biometric authentication has failed (e.g., optionally a threshold number of times).

FIG. 7F illustrates detecting a user input 730, such as a tap input or other selection input, directed to the option 726 to require authentication for the messenger application. In some embodiments, in response to detecting the user input 730, the device 100 displays a user interface 734-1 (e.g., in FIG. 7G) that includes a list of other applications (e.g., system applications and/or third-party applications) that have access to the messenger application. For example, FIG. 7G illustrates that the user interface 734-1 provides an option for each application, such as option 741-1 for application 740-1 and option 741-2 for application 740-2, for locking the respective application. For example, while the application 740-1 is not locked, the application 740-1 optionally may still access content from the messenger application. In response to detecting a user input directed to the option 741-1, the device 100 locks the application 740-1 such that a user is required to authenticate to access the application 740-1 and its content. As such, the user interface 734-1 provides the user with a list of related and/or relevant applications that may have access to the locked messenger application so that the user easily controls whether or not to lock these applications. In some embodiments, the user interface 734-1 further includes a done button 736 and a cancel button 738 to cease display of the user interface 734-1. For example, in response to detecting a user input 742 directed to the done button 736, the options 741-1 and 741-2 are saved and the device 100 ceases to display the user interface 734-1 (e.g., and optionally redisplays the home screen user interface 492 or another user interface).

FIG. 7H illustrates another example of the user interface 734-1, for a photos application displayed as the user interface 734-2. For example, in response to the user requesting to require biometric authentication for a photos application, the user interface 734-2 is displays to list one or more related and/or relevant applications that have access to the content of the photos application, and provides options for locking the applications.

FIG. 7I illustrates display of the home screen user interface 492 while the messenger application is locked. In some embodiments, while the messenger application is locked, the application icon 424 is optionally displayed with a lock symbol 743. In some embodiments, the messenger application is not displayed with the lock symbol 743 (e.g., the application icon 424 is unchanged whether or not the messenger application requires authentication to access the messenger application or its content). In some embodiments, while the messenger application requires authentication (e.g., is in the locked state), the widget 711-2 for the messenger application does not display previews of content. For example, the widget 711-2 displays that one conversation is unread but does not display an indication of the contact and/or a preview of the message. As such, like the locked notifications described above, the widget 711-2 displays a limited amount of information that does not include content of the messenger application.

FIG. 7J illustrates that, in response to detecting the user input 750 (e.g., in FIG. 7I), such as a tap and hold or other user input (e.g., optionally the user input of the second type described with reference to FIG. 7D), the quick actions menu 712 is redisplayed. In some embodiments, the quick actions menu 712 replaces the option 716 to lock the application with the option 716 to unlock the application. In some embodiments, the quick actions menu 712 replaces the option for requiring biometric authentication with an option for “not requiring biometric authentication” for the application. For example, the user toggles the setting for the application between requiring and not requiring authentication (e.g., from the locked to the unlocked state) by accessing the quick actions menu 712 from the application icon displayed in the home screen user interface 492.

FIG. 7K illustrates that, while the messenger application requires authentication, even while the device 100 is unlocked (e.g., as indicated by the session region 502-4), the notification 704-3 for the messenger application is shown as a locked notification (e.g., that does not include content from the messenger application, such as a contact or a preview of the message) in the wake screen user interface 490. For example, the locked notification 704-3 only displays the name of the application (e.g., Messenger) and the number of notifications. In some embodiments, the device 100 outputs a generic audio output and/or a generic tactile output that is not associated with a sender of the notification (e.g., even for a contact who has been assigned a particular audio tone and/or tactile pattern). As such, the notification 704-3, including the audio output and/or tactile output 762 does not identify a sender of the notification while the messenger application requires authentication (e.g., the messenger application is in the locked state).

FIG. 7L illustrates another example of the locked notification 704-3 that is displayed in a home screen user interface 492 while the device 100 is locked. FIG. 7M illustrates detecting a user input 766, such as a tap input or other selection input (e.g., a user input of the first type as described with reference to FIG. 7D), directed to the application icon 424 for the messenger application. In some embodiments, the user input 766 is directed to the locked notification 704-3 (e.g., and corresponds to a request to view the content of the locked notification 704-3, e.g., in an application user interface for the application associated with the locked notification 704-3); and in response to detecting the user input 766, the device 100 initiates a process for opening the messenger application (e.g., optionally including displaying a lock symbol in the session region), as illustrated in FIG. 7N.

In some embodiments, the device 100 interrupts, pauses, or otherwise does not provide full access to the messenger application, while the device 100 attempts to authenticate the user, as indicated by the session region 502-2. In some embodiments, as illustrated in FIG. 7N, the device 100 displays a user interface 768 that includes a blurred or otherwise visually obscured version of an application user interface for the messenger application. In some embodiments, the user interface 768 is displayed after a threshold amount of time has expired since initiating the authentication process without the device 100 successfully authenticating the user. For example, if the authentication process is successful within the threshold amount of time, the session region 502-2 is updated to indicate the authentication is successful, without displaying the user interface 768. In some embodiments, while the device attempts to authenticate the user, the session region 502-2 displays an animation of a lock symbol (also referred to herein as a lock icon) unlocking and/or displays an animation of a lock symbol transitioning into a check mark (e.g., a green check mark) in accordance with a determination that authentication is successful (e.g., updates to an unlocked symbol of a lock in the session region 502-3, FIG. 7O). In some embodiments, the session region 502-2 optionally includes an indication 767 of the application that is requiring the authentication.

In some embodiments, after successful authentication of the user, the device 100 displays a user interface 510-1 for the messenger application, as illustrated in FIG. 7P, including displaying the content of the message 770 that was not displayed in the locked notification 704-3 and the sender of the message, Jon. FIG. 7P illustrates detecting a user input 772, such as a swipe user input in a first direction (e.g., in an upward direction) and/or another type of user input, corresponding to a request to dismiss the application user interface 510-1.

In some embodiments, in response to detecting the user input 772, the device 100 redisplays the home screen user interface 492, as illustrated in FIG. 7Q. In some embodiments, as illustrated in FIG. 7Q, after dismissing the application user interface 510-1 for the messenger application, the messenger application remains unlocked for a threshold amount of time (e.g., 10 seconds, 15 seconds, 30 seconds, another amount of time) and/or until the device 100 enters a locked state. As such, in response to detecting a user input 774, such as a tap input or other selection input, that is received before the threshold amount of time has elapsed and/or before the device 100 has entered a locked state, directed to the application icon 424, the application user interface 510-1 is redisplayed (e.g., in FIG. 7R) without requiring authentication from the user. For example, if a user quickly (e.g., within the threshold amount of time) returns to an application that requires authentication after navigating away from the application user interface for the application, the device 100 does not require additional authentication to redisplay the application user interface.

FIG. 7S illustrates an example of the device 100 detecting an incoming phone call notification 502-5 while a phone application requires authentication (e.g., the phone application is in the locked state, optionally indicated by a lock indication 780 with the application icon 416 for the phone application). In some embodiments, while the phone application requires authentication, the incoming phone call notification 502-5 is displayed (e.g., even while device 100 is unlocked) as a locked notification (e.g., the locked notification 502-5 does not include information about the phone number and/or contact initiating the call), and an audio output and/or tactile output 782 is generated and output by the device 100.

In contrast to FIG. 7S, FIG. 7T illustrates an example of the device 100 detecting an incoming phone call notification 502-6 while the phone application does not require authentication (e.g., either the phone application is not set to require authentication or the phone application is currently unlocked but otherwise requires authentication). In some embodiments, the notification 502-6 is not a locked notification and includes information about the contact initiating the phone call (e.g., Max), and outputs an audio output and/or tactile output 788 (e.g., a first ringtone and/or tactile pattern) that has been assigned to Max, such that incoming phone calls and/or messages from Max cause the device 100 to output the first ringtone and/or tactile pattern. For example, the notification 502-5 (e.g., in FIG. 7S) also corresponds to an incoming phone call from Max, but Max's audio output and/or tactile output 788 is not output with the locked notification 502-5 while the phone application requires authentication.

In some embodiments, calls apps (e.g., a voice over IP, messaging, and/or video calling app) that are not locked and/or hidden are added to a call history for incoming calls (e.g., answered and/or missed calls) and/or outgoing calls. In some embodiments, representations of calls from calls apps that are locked are not added to the call history for incoming calls (e.g., answered and/or missed calls) and/or outgoing calls. In some embodiments, representations of calls from calls apps that are hidden are not added to a call history for incoming calls (e.g., answered and/or missed calls) and/or outgoing calls. In some embodiments, the call history includes a section for representations of hidden calls (e.g., incoming and/or outgoing calls for locked and/or hidden apps) that is initially hidden and then revealed in response to a user request to reveal hidden calls (e.g., an input detected via one or more input devices directed to a “show” or “unhide” affordance that is displayed concurrently with at least a portion of the call history user interface). In some embodiments, representations of hidden calls are included in the call history but those representations have detailed information redacted (e.g., by removing an identifier of the application, an identifier of the caller, and/or an identifier of the content of the call) in the call history, the representations of hidden calls in the call history optionally include an indication of a time at which the call occurred (e.g., a time at which an outgoing call was placed and/or an incoming call was received and/or missed), the indication of time can be text or numerals that indicate time or a location in a call history that is organized chronologically (e.g., so that one or more representations of hidden calls are displayed in the same list with representations of one or more non-hidden calls). In some embodiments, hidden calls in the call history remain hidden when an app is unlocked or unhidden (e.g., the representations of the hidden calls continue to be redacted). In some embodiments, hidden calls in the call history are unhidden when an app is unlocked or unhidden (e.g., the representations of the hidden calls are changed from being redacted to being unredacted by including additional identifying information such as revealing an identifier of the application, an identifier of the caller, and/or an identifier of the content of the call). When an application is no longer hidden or locked, representations of calls are associated with the application that were made, received, or missed while the application was not hidden or locked are shown in the call history without redaction.

In some embodiments, additional authentication is required to reveal representations of hidden calls (e.g., passcode, password, and/or biometric authentication), where if the authentication is successful the representations of hidden calls are revealed in response to the user request to reveal hidden calls, and if the authentication is not successful (e.g., because the entered password, passcode, or detected biometric information does not match authorized authentication information), the representations of hidden calls are not revealed in response to the user request to reveal hidden calls. In some embodiments, an indication of a section for hidden calls and/or a “show” or “unhide” affordance are displayed without regard to whether or not there are any hidden calls or any hidden and/or locked apps that are able to make or receive calls. In some embodiments whether representations of calls from an application are placed in the hidden section of the call history is dependent on whether the application is hidden and/or locked, and the representations of calls are moved from a non-hidden section of the call history into the hidden section of the call history when the corresponding app is hidden and/or locked and, optionally, the representations of calls are moved out of the hidden section of the call history and into the non-hidden section of the call history when the corresponding app is unhidden and/or unlocked. In some embodiments, call history information that is hidden in a shared call history user interface is available in an application-specific user interface for a hidden or locked app and can be accessed by opening the hidden or locked app (e.g., as described in greater detail with reference to FIGS. 7M-7P and 10V-10Y) and navigating to a view where call history information is displayed.

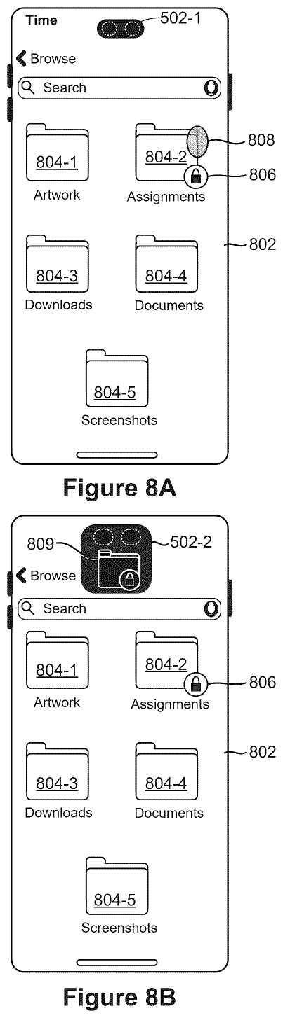

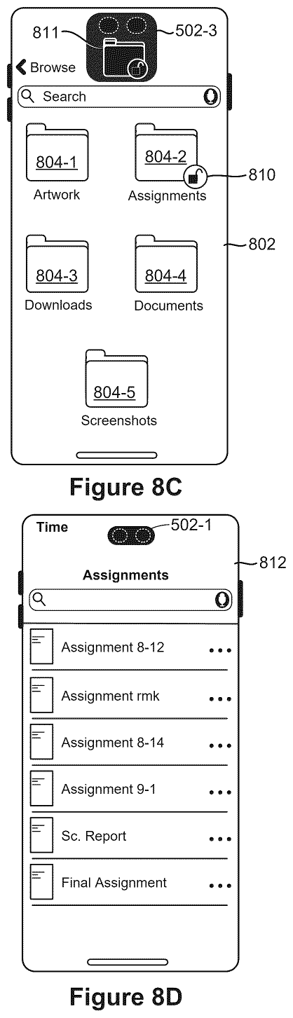

FIGS. 8A-8D illustrate examples of requiring authentication for a folder of content, optionally a folder of content associated with a respective application of the device 100. In some embodiments, locking a respective application automatically causes a folder of content that stores content for the respective application to be locked. For example, in response to detecting a user input to lock a word processing application, the device 100 locks the “Assignments” file 804-2 that stores documents associated with the word processing application. For example, FIG. 8A illustrates device 100 displaying a user interface 802 that includes representations of a plurality of files 804, including representation of file 804-1 for “Artwork,” representation of file 804-2 for “Assignments,” representation of file 804-3 for “Downloads,” representation of file 804-4 for “Documents” and representation of file 804-5 for “Screenshots.” In some embodiments, the representation of file 804-2 for “Assignments” optionally includes a lock indication 806, indicating that the file 804-2 requires authentication for a user to view and/or access the contents of the file 804-2.

In some embodiments, in response to detecting a user input 808, such as a tap input or other selection input, directed to the representation of the file 804-2, the device 100 initiates an authentication process, as illustrated by the session region 502-2 in FIG. 8B, which includes a representation 809 to indicate the device 100 is attempting to authenticate the user. In some embodiments, the device 100 authenticates the user via a biometric authentication process (e.g., matches a facial scan of the user with a stored facial key or other biometric authentication). FIG. 8C illustrates that the session region 502-3 is updated to indicate that authentication was successful (e.g., by displaying a representation 811 that includes an unlocked lock icon and/or a green check mark). FIG. 8D illustrates that, in accordance with a determination that the authentication was successful, the device 100 displays a user interface 812 that includes contents stored in the file 804-2.

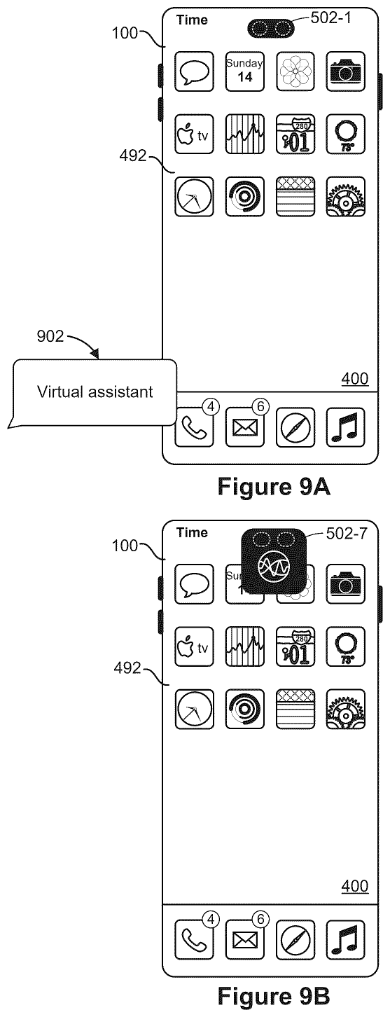

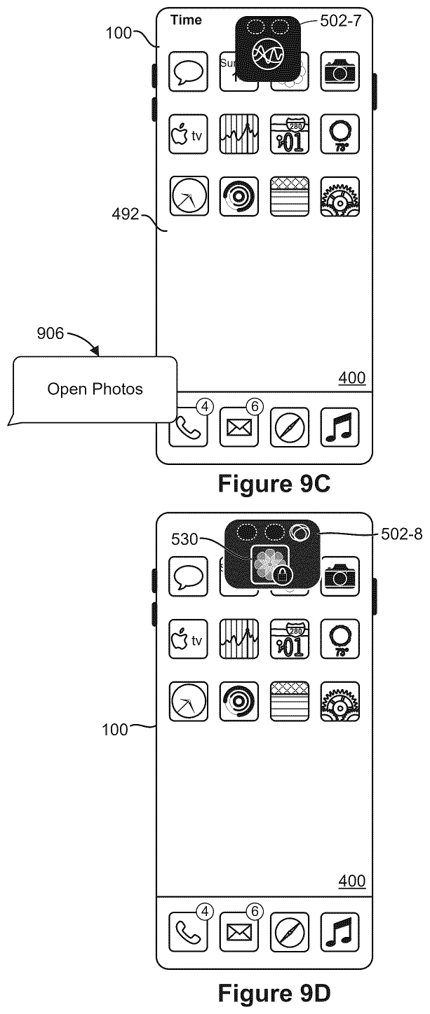

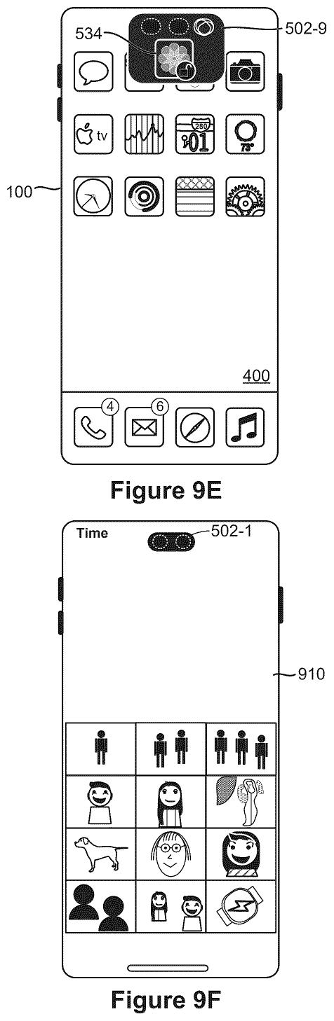

FIGS. 9A-9F illustrate example user interfaces for requesting a virtual assistant to access an application that requires authentication to access the application. For example, FIG. 9A illustrates the device 100 detecting a request 902 to invoke a virtual assistant of the device 100. In some embodiments, the request 902 is a voice command corresponding to a wake word or other command to invoke the virtual assistant of the device 100. In some embodiments, the request 902 is an input directed to one or more physical buttons of the device 100 that corresponds to a request to invoke the virtual assistant of the device 100. In some embodiments, the request 902 is a tap input or other input directed to a displayed representation of the virtual assistant that is displayed at device 100 that, when selected, invokes the virtual assistant of the device 100.

FIG. 9B illustrates in response to detecting the request 902 to invoke the virtual assistant, the device 100 displays an indication, optionally in the session region 502-7, indicating that the virtual assistant has been invoked and/or is ready to accept one or more commands. FIG. 9C illustrates the virtual assistant of the device 100 detecting a command 906, such as a voice command and/or a text input, to “Open Photos.” In some embodiments, while the command 906 is being detected, the session region 502-7 is animated to indicate that the virtual assistant is actively receiving the command. In some embodiments, in response to detecting the command 906, the virtual assistant causes the device 100 to open a photos application in accordance with the detected command 906.

FIG. 9D illustrates the device 100 initiating a process to open the photos application in accordance with the command 906. In some embodiments, the photos application requires authentication (e.g., the photos application is locked) before being opened and/or accessed, as indicated by the representation 530 in the session region 502-8. In some embodiments, in accordance with a determination that the photos application requires authentication before being opened and/or accessed, the device 100 automatically, without user input, attempts to authenticate the user (e.g., via biometric authentication). In some embodiments, while the device 100 attempts to authenticate the user, the session region 502-8 displays a locked indication and/or displays an animation to indicate authentication is in process. FIG. 9E illustrates the session region 502-9 is updated in accordance with a determination that the device 100 has successfully authenticated the user. For example, the representation 534 is displayed in the session region 502-9 to indicate that the authentication was successful. In some embodiments, the session region 502-9 is displayed briefly as the device 100 displays an application user interface 910 for the photos application.

FIGS. 10A-10AE illustrate example user interfaces for hiding one or more applications of the device 100. In some embodiments, a hidden application refers to an application that is both hidden in the user interface (e.g., by replacing display of the application icon in the home screen user interface 492 with a generic application icon (also referred to herein as a hidden application icon) or by removing display of the application icon from the home screen user interface 492) and requires authentication (e.g., biometric authentication and/or a passcode) to open and/or access the application. For example, a hidden application that is removed from display in the home screen user interface 492 is accessible from a hidden application folder (e.g., as described with reference to FIGS. 10W-10X below) in an application library user interface 497 (e.g., in FIGS. 4C1-4C2). In some embodiments, hidden applications (e.g., and/or locked applications) are hidden from a first set of system functions, such as notifications, a virtual assistant, suggestions, and a search function, but are available to a second set of system functions, such as application settings and screen time.

FIG. 10A illustrates device 100 displaying a home screen user interface 492 that includes a first hidden application icon 1002 and a second hidden application icon 1003. In some embodiments, the home screen user interface 492 also includes one or more locked application icons (e.g., application icons for applications that require authentication before allowing access to the application, as described above) and/or one or more widgets, such as widget 711-2 (e.g., optionally corresponding to a locked application). In some embodiments, the home screen user interface 492 includes a hidden group of application icons in the application folder 1005 (sometimes also referred to herein as a folder of applications and/or a folder of application icons). In some embodiments, the device 100 detects a request 1004 to invoke the virtual assistant (e.g., as described with reference to the request 902, for example in FIG. 9A). FIG. 10B illustrates, in response to detecting the request 1004, the device 100 displays an indication, optionally in the session region 502-7, indicating that the virtual assistant has been invoked and/or is ready to accept one or more commands, as described with reference to FIG. 9B.

FIG. 10C illustrates the device 100 detecting a request 1006, such as a voice command and/or a text input, directed to the virtual assistant of the device 100. For example, the request 1006 asks “What is the latest communication from Max?” and in response to detecting the request 1006, the virtual assistant of the device 100 performs a lookup or otherwise determines that one or more communications from the contact Max were sent via one or more applications. For example, the one or more communications from Max were received via three different applications: a message 1007 from a first messaging application, an email 1011 from an email application, and a message 1013 from a second messaging application. In some embodiments, the first messaging application is a hidden application, as indicated by the hidden icon 1009. In some embodiments, because the first messaging application is a hidden application, the device 100 does not recognize the message 1007 as the most recent communication from Max (e.g., even though it was received more recently than the email 1011 and the message 1013). For example, the hidden application and its content is hidden from a first set of system functions of the device 100, including the system function accessed by the virtual assistant to perform a search and/or the system function for generating notifications for the hidden application. For example, the virtual assistant performs a lookup of recent notifications to identify one or more communications from Max, but a notification for the message 1007 was not generated because the first messaging application is a hidden application. As such, the device 100 identifies the latest (e.g., most recent) communication from Max as the email 1011, as illustrated in FIG. 10D. FIG. 10D illustrates the device 100 outputting a response 1014 to the request from the user. In some embodiments, the response 1014 is output as audio (e.g., the virtual assistant reads the response aloud). In some embodiments, the response 1014 is output as text displayed at the device 100.

Although the example described above with reference to FIGS. 10A-10D describe a system function corresponding to a request that is directed to a digital assistant to perform a digital assistant operation (e.g., that accesses content and/or data from one or more unhidden applications of the device 100 in order to perform the operation), other examples of system functions perform operations that access content and/or data from one or more unhidden applications and/or provides results of the operations that include information from the one or more unhidden applications (e.g., without having access to, and/or otherwise without providing results from, content and/or data from one or more hidden applications). For example, in response to a request to perform a search operation (e.g., based on a search query input by the user of the device 100), the device 100 performs the search operation and provides search results that do not include content associated with one or more hidden applications. Similarly, in response to a user input corresponding to a request for one or more recommendations from the device 100 (e.g., in response to a user input corresponding to a request to view a search user interface, optionally without detecting one or more user inputs corresponding to a search query input), the device 100 outputs recommendations (e.g., of applications and/or content that are likely to be relevant to the user) for the device 100 without including hidden applications and/or content associated with one or more hidden applications in the recommendations. In some embodiments, the system function comprises performing an operation that uses artificial intelligence and/or machine learning, such as for performing an autocomplete operation. In some embodiments, the system function comprises accessing one or more unhidden applications from another application (e.g., to insert content from the one or more unhidden applications (e.g., as described with reference to FIGS. 5A-5C) and/or to display a share sheet user interface (e.g., as described with reference to FIGS. 5A-5F) in the application that includes indications of the one or more unhidden applications).

FIG. 10E illustrates the device 100 detecting a user input 1016, such as a long press input or other selection input, directed to the messenger application icon corresponding to a request to access the quick actions menu 712 (e.g., as described above with reference to FIG. 7E). In some embodiments, the quick actions menu 712 includes the option 718 to hide the messenger application. In some embodiments, as described above with reference to FIG. 7E, the quick actions menu 712 includes an option to require authentication for the application that, when selected, provides a second menu that includes an option for hiding the application and requiring authentication to access the application.

In some embodiments, in response to detecting a user input 1020, such as a tap input or other selection input, directed to the option 718, the device 100 displays the user interface 1022, as illustrated in FIG. 10G. In some embodiments, before enabling the user to interact with the user interface 1022, the device 100 attempts to authenticate the user, as illustrated in the session region 502-3. For example, the device 100 requires that the user authenticate (e.g., via biometric authentication and/or a passcode) before allowing the user to hide the application. In some embodiments, the device 100 requires that the user authenticate before allowing the user to lock the application (e.g., before allowing the user to require authentication to access the application).

In some embodiments, the user interface 1022 (e.g., in FIG. 10G) displays information about how hiding the application will affect the application icon on the home screen user interface 492, will require authentication to view the application icon, will prevent notifications for the application, and will limit a first set of system functions from using the application. In some embodiments, the device 100 optionally allows the user to select if certain types of notifications, such as emergency notifications, notifications from a set of trusted contacts, and/or other critical notifications, are able to breakthrough the hidden notification setting. In some embodiments, the user interface 1022 includes an option 1024 to select a hidden icon (e.g., a generic icon that is distinct from the application icon) to replace the application icon on the home screen user interface 492. In some embodiments, the user interface 1022 includes an option 1026 to hide (and/or optionally remove) the application from the home screen user interface 492 (e.g., instead of displaying a hidden icon as the application icon on the home screen user interface 492), and includes an option 1028 to cancel the hiding application process.

In some embodiments, in response to detecting a user input 1030 directed to the option 1024, the device 100 displays a platter 1034 that includes a plurality of user-selectable hidden icon types, as illustrated in FIG. 10H. For example, one or more hidden icons are displayed in the platter 1034, and in response to detecting a user input 1036, such as a tap input or other selection input, directed to a respective hidden icon, the respective hidden application icon is selected to replace the application icon for the application on the home screen user interface 492. For example, as illustrated in FIG. 10J, the hidden application icon 1040 replaces the messenger application icon such that the application cannot be identified based on its icon on the home screen user interface 492. Further, as illustrated in FIG. 10J, widgets associated with a hidden application (e.g., widget 711-3 and/or one or more other widgets) are updated to be displayed with the selected hidden application icon or are removed from the home screen user interface 492.

FIG. 10I illustrates the device 100 detecting a user input 1038 directed to the option 1026 to hide the application icon. In some embodiments, in response to detecting the user input 1038, the home screen user interface 492 does not display the hidden application icon 1040 or the application icon for the messenger application (e.g., no application icon is displayed in the upper left position of application icons in the home screen user interface).

FIG. 10J illustrates detecting a user input 1042 (e.g., a tap input or other selection input) directed to the hidden application icon 1040, and in response to detecting the user input 1042, the device 100 displays an authentication user interface 624, as illustrated in FIG. 10K. In some embodiments, the authentication user interface 624 includes an opaque background such that the application corresponding to the selected hidden application icon 1040 cannot be identified. For example, the session region 502-2 in FIG. 10K does not indicate that the hidden application icon 1040 corresponds to a messenger application.

In some embodiments, upon successfully authenticating the user, as illustrated in FIG. 10L, an indication 769 of the messenger application is optionally displayed in the session region 502-3. As such, the device 100 reveals the application that is associated with the hidden application icon 1040 only after the user has been authenticated. FIG. 10M illustrates that, after successfully authenticating the user, the device 100 displays the application user interface 510-1 for the messenger application. In some embodiments, in response to detecting a user input 1050, such as a swipe input or other input corresponding to a request to dismiss the application user interface 510-1, the device 100 redisplays the home screen user interface 492, as illustrated in FIG. 10N.

FIG. 10N illustrates the device 100 displaying the home screen user interface 492 with the hidden application icon and immediately requires authentication to reopen the application corresponding to the hidden application icon 1040 (e.g., unlike a locked application that optionally remains unlocked for a threshold amount of time, as described with reference to FIGS. 7Q-7R. FIG. 10N further illustrates detecting a user input 1052 directed to the application folder 1005. In some embodiments, the application folder 1005 includes two or more application icons that have been grouped together and displayed as the application folder 1005. In some embodiments, miniature representations of at least some of the two or more application icons are displayed within the application folder 1005 on the home screen user interface 492. In some embodiments, in accordance with a determination that the user input 1052 is a tap and hold or other type of user input that corresponds to a request to access a quick actions menu 1053 (e.g., corresponding to the quick actions menu 712) for the application folder 1005, the device 100 displays the quick actions menu 1053, as illustrated in FIG. 10O.

In some embodiments, the quick actions menu 1053 includes a list of one or more user-selectable options for controlling the application folder 1005. For example, the quick actions menu 1053 includes an option 1055 to rename the application folder 1005, option 1056 to lock the application folder 1005 and/or option 1057 to hide the application folder 1005. In some embodiments, as described with reference to FIG. 7E, the quick actions menu 1053 (e.g., like the quick actions menu 712) includes an option to require authentication for the application (e.g., instead of displaying the options 1056 and 1057) that, when selected, provides a second menu that includes (i) an option to require biometric authentication to view and/or access the folder, (ii) an option to hide the application folder and require biometric authentication and/or (iii) an option to cancel (e.g., dismiss the second menu).

In some embodiments, in response to detecting a user input 1058 corresponding to a selection of the option 1057 (e.g., and/or the selection of the option to hide the application folder and require biometric authentication displayed in the second menu), the device 100 displays the user interface 1060, as illustrated in FIG. 10P. In some embodiments the user interface 1060 has one or more of the properties described with reference to the user interface 1022 (e.g., in FIG. 10G). For example, the user interface 1022 displays information relating to how hiding the application folder will affect one or more system operations for the applications that are included in the application folder. In some embodiments, in response to detecting a user input 1063 (e.g., in FIG. 10P) directed to the option 1061, the device 100 hides the application folder, as illustrated in FIG. 10Q. In some embodiments, the device 100 requires authentication, as illustrated in the session region 502-4, before enabling the user to select an option 1061 to hide the folder and/or the device 100 initiates the authentication process in response to user selection of the option 1061 (e.g., before hiding the application in response to the user input 1063).

FIG. 10Q illustrates the application folder is represented in the home screen user interface 492 as a hidden application folder icon 1066 that does not include displayed indications of the applications that are included in the hidden application folder. In some embodiments, in response to detecting a user input 1070 such as a drag input or other input corresponding to a request to move the application icon 1068 to a different position within the home screen user interface 492, the device 100 displays the application icon 1068 for a media application (e.g., a television application or another type of application) as being moved within the home screen user interface 492 in accordance with a movement (e.g., magnitude and/or direction) of the user input 1070. For example, in response to detecting an end of the user input 1070 at a position that overlaps with the hidden application folder icon 1066, the application icon 1068 is added to the hidden application folder and the application icon 1068 ceases to be displayed in the home screen user interface 492, as illustrated in FIG. 10R. FIG. 10R illustrates detecting a user input 1072, such as a tap user input or other selection user input, directed to the hidden application folder icon 1066, and in response to detecting the user input 1072, the device 100 initiates the authentication process, as indicated by the session region 502-3 (e.g., in FIG. 10S), before providing the user with access to the hidden application folder associated with the hidden application folder icon 1066.

In some embodiments, in accordance with a determination that the authentication is successful, the application icons for the applications that are included in the hidden application folder are displayed in an expanded view 1074, as illustrated in FIG. 10S. For example, the application icons are displayed to include identifying information for the respective application (e.g., rather than being displayed as hidden application icons). In some embodiments, after the application icons are displayed, in response to one or more user inputs corresponding to requests to open and/or interact with the application icons, the device 100 performs one or more operations without requiring additional authentication from the user. In some embodiments, while displaying the unhidden application icons in the expanded view 1074, the device 100 requires additional authentication before the user is enabled to open an application that is in the hidden application folder. In some embodiments, in response to detecting the user input 1076, such as a drag user input or other user input, corresponding to a request to move the application icon 1068 out of the hidden application folder, the device 100 moves the application icon 1068 in the home screen user interface 492 (e.g., without displaying the application icon 1068 as a hidden application icon), as illustrated in FIG. 10T.

FIGS. 10U-10V illustrate the device 100 navigating from the home screen user interface 492 to the application library user interface 497 (e.g., in FIG. 10V) in response to detecting a user input 1078, such as a swipe user input or other user input. For example, as described with reference to FIG. 4C1-4C2, in some embodiments, consecutive leftward swipe gestures 4116 on the home screen user interface 492 navigates through consecutive pages of the home screen user interface 492 until the application library user interface 497 is displayed.

FIG. 10V illustrates the application library user interface 497 includes a plurality of application icons that are grouped into categories (e.g., “social,” “entertainment,” “other,” and “info”). In some embodiments, the “hidden” category 1080-1 is displayed in the application library user interface 497 whether or not any applications are hidden at the device 100. As such, a user cannot tell whether or not any applications are hidden by viewing the application library user interface 497 (e.g., without authentication). For example, the other categories display the application icons within the group.

In some embodiments, hidden applications are automatically, without user input, added to the hidden category 1080-1 in the application library user interface 497 and are not displayed within any of the other categories in the application library. For example, the messenger application that is hidden (e.g., as described with reference to FIGS. 10E-10J) is excluded from the visible categories in the application library, and is accessible via the hidden category 1080-1. In some embodiments, in response to detecting a user input 1082, such as a tap input or other selection input, directed to the hidden category 1080-1, the device 100 initiates the authentication process, as illustrated by session region 502-2 in FIG. 10W. In some embodiments, during the authentication process, the content (e.g., the hidden applications) included in the hidden category 1080-1 is not revealed. In some embodiments, in accordance with a determination that the authentication is not successful, the hidden category 1080-1 remains hidden.

In some embodiments, in accordance with a determination that the authentication is successful, as illustrated by the unlock indication 1075 (also referred to herein as an unlocked symbol) in the session region 502-3, the device 100 reveals the application icons in the hidden category 1080-2 (e.g., in FIG. 10X) for applications that have been hidden, including applications that have been individually hidden (e.g., the messenger application) and applications that have been hidden by hiding a folder to which the application have been added (e.g., the applications in the hidden application folder corresponding to the hidden application folder icon 1066). In some embodiments, the user accesses the quick actions menu 712 for the hidden application icons (e.g., that are not displayed in the home screen user interface 492) via a user input (e.g., a tap and hold input) directed to the respective application icon in the application library user interface 497 (e.g., after the application icon is displayed in the hidden category 1080-2). For example, the quick actions menu 712 includes an option to unhide the respective application.

FIG. 10X illustrates the device 100 detecting a user input 1086, such as a tap input or other selection input, directed to the messenger application, and in response to detecting the user input 1086, the device 100 displays the user interface 510-1 for the messenger application, optionally without requiring additional authentication for the user, as illustrated in FIG. 10Y. FIG. 10Y illustrates the device 100 detecting a user input 1090-1 corresponding to a user request to dismiss the user interface 510-1. In some embodiments, in accordance with a determination that the user input 1090-1 is an upward swipe gesture that starts from the bottom edge of the home screen user interface 492 (e.g., as described with reference to FIGS. 4C1-4C2), the device 100 transitions (e.g., as the user input 1090-1 continues as the user input 1090-2) from displaying the user interface 510-1 to displaying the multitasking user interface 488, as illustrated in FIGS. 10Z-10AA.

FIG. 10AA illustrates the device 100 displaying the multitasking user interface 488, including displaying a representation 1092 of the messenger application user interface 510-1. In some embodiments, the multitasking user interface 488 displays (e.g., in a stack) one or more representations of application user interfaces of ongoing applications that were recently and/or previously opened at the device 100 (e.g., applications that have not been closed by the device 100). In some embodiments, a representation of the most recently accessed application user interface is displayed as the top representation in a stack of representations. For example, in response to detecting a user input 1098, such as a swipe user input, the device 100 swipes through the stack of representations in the multitasking user interface 488. In some embodiments, while the representation of the user interface 510-1 (e.g., corresponding to the hidden messenger application) is at the top of the stack, content (e.g., the messages, contacts and/or other content) of the messenger application continues to be displayed.

In some embodiments, in response to detecting the user input 1098, the device 100 displays a representation 1096 of a different application user interface as the top of the stack of representations (e.g., navigates away from the representation 1092 of the user interface 510-1 corresponding to the hidden application). In some embodiments, the device 100 updates the representation 1092 to remove content of the messenger application from display, as illustrated in FIG. 10AB. For example, after the user navigates away from the representation 1092 that is initially displayed as the top of the stack of representations, the representation 1092 is updated to a hidden state that does not include content from the application.

For example, as illustrated in FIG. 10AC, after the representation 1092 has been updated to the hidden state, the representation 1092 remains in the hidden state while displaying the multitasking user interface 488. In some embodiments, in response to detecting a user input 10002 corresponding to a request to navigate back to the representation 1092 in the stack, the representation 1092 continues to be displayed in the hidden state, as illustrated in FIG. 10AC (e.g., without displaying content from the application associated with the representation 1092). In some embodiments, the representations of applications that are not hidden applications continue to display previews of content from the respective application.

In some embodiments, representations for applications that are in the hidden state are optionally not displayed in the multitasking user interface 488. In some embodiments, one or more representations for applications that are in the hidden state are displayed (e.g., or not displayed) based at least in part on an amount of time that has elapsed since the respective application was accessed, displayed and/or authenticated. For example, a representation of a hidden application that has been recently used (e.g., within the last 2 minutes, 5 minutes, 30 minutes, 1 hour, or another amount of time) is included in the multitasking user interface 488, while a representation of a hidden application that has not been recently used (e.g., within the last 2 minutes, 5 minutes, 30 minutes, 1 hour, or another amount of time) is not included in the multitasking user interface 488.

FIG. 10AC illustrates the device 100 detecting a user input 10004 directed to the representation 1092, corresponding to a request to replace display of the multitasking user interface 488 with display of the application user interface 510-1 corresponding to the representation 1092. In some embodiments, in response to detecting the user input 10004, the device 100 initiates the authentication process, as illustrated in FIG. 10AD. For example, the session region 502-2 updates to indicate the authentication process is in progress. In some embodiments, while the device 100 attempts to authenticate the user, the device 100 displays an opaque hidden user interface 10006 (e.g., optionally a more visually obscured user interface than the user interface 768 displayed for locked application, as described with reference to FIG. 7N).

In some embodiments, in accordance with a determination that the device 100 successfully authenticates the user, the device 100 displays the user interface 510-1, as illustrated in FIG. 10AE. In some embodiments, in accordance with a determination that the device 100 does not successfully authenticate the user, the device 100 does not display the user interface 510-1 and continues to display the user interface 10006 and/or optionally provides an option for the user to reattempt authentication.

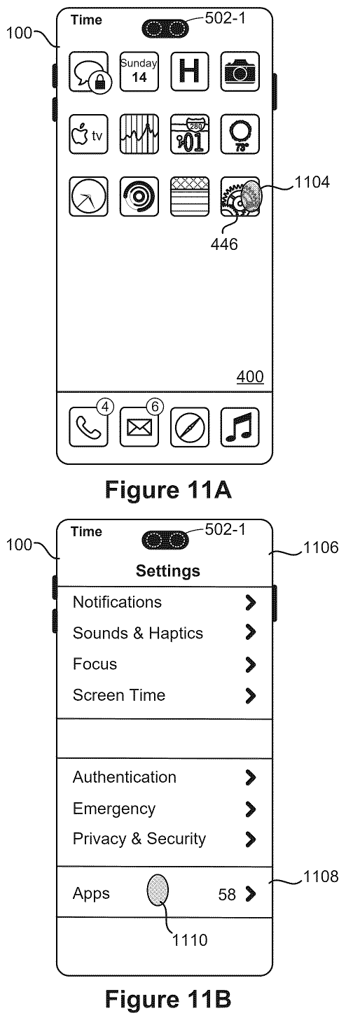

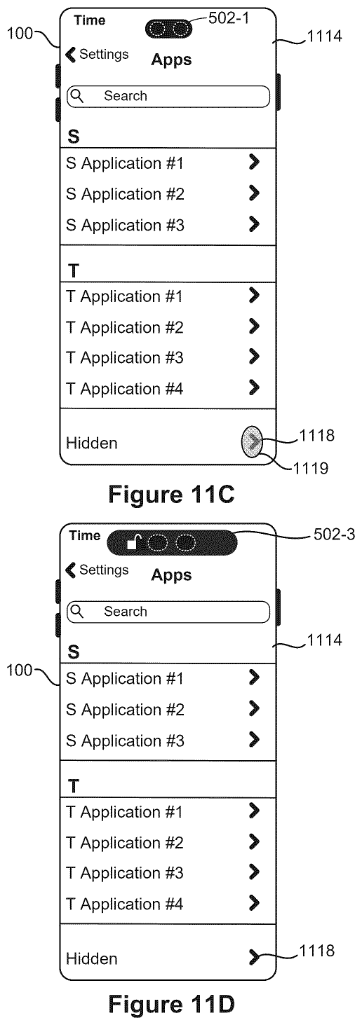

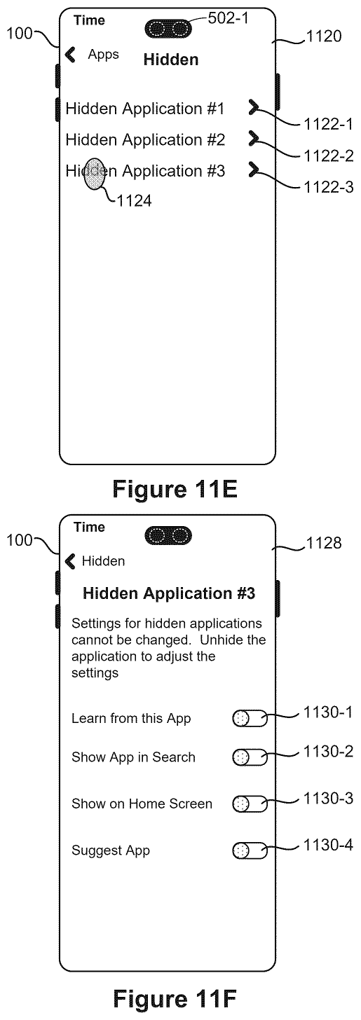

FIGS. 11A-11F illustrate example user interfaces for controlling settings of the device 100. FIG. 11A illustrates detecting a user input 1104, such as a tap input or other selection input, directed to the settings application icon 446. In some embodiments, in response to detecting the user input 1104, the device 100 displays a settings user interface 1106, as illustrated in FIG. 11B. In some embodiments, the settings user interface 1106 includes one or more user-selectable options for selecting and/or updating one or more settings of the device 100. In some embodiments, the settings user interface 1106 includes an option 1108 for controlling the settings for applications of the device 100. For example, in response to detecting the user input 1110 directed to the option 1108 for controlling the settings for applications of the device 100, the device 100 displays a list of applications in the user interface 1114 (e.g., in FIG. 11C), optionally in alphabetical order, that are stored on and/or accessible by the device 100. In some embodiments, the list of applications excludes the hidden applications (e.g., the list excludes individually hidden applications and applications that are in a hidden folder). In some embodiments, the list of application in the user interface 1114 (e.g., in FIG. 11C) excludes the locked applications.

For example, FIG. 11C illustrates the user interface 1114 includes an option 1118 for accessing the hidden applications. In some embodiments, the option 1118 is displayed whether or not the device 100 has any applications that are hidden. In some embodiments, in response to detecting the user input 1119 directed to the option 1118, the device 100 initiates the authentication process, as illustrated by the session region 502-3 in FIG. 11D. In some embodiments, in accordance with a determination that the authentication process is not successful, the device 100 does not display a list of the hidden applications (e.g., in the user interface 1120, FIG. 11E), and continues to display the user interface 1114, optionally including displaying an option to reattempt authentication.

In some embodiments, in accordance with a determination that the authentication process is successful, the device 100 displays the user interface 1120 (e.g., in FIG. 11E) that includes a list of the hidden application of the device 100, including the hidden application 1122-1, the hidden application 1122-2, and the hidden application 1122-3. In some embodiments, the user selects a respective application from the list of applications to control one or more settings for the respective application. For example, in response to detecting the user input 1124 directed to the hidden application 1122-3, the device 100 displays, in a user interface 1128, one or more settings for the hidden application 1122-3, as illustrated in FIG. 11F.

In some embodiments, the one or more settings for the hidden application 1122-3 displayed in the user interface 1128 (e.g., in FIG. 11F) are not modifiable while the application is hidden. For example, hiding the application 1122-3 causes the application 1122-3 to be hidden, or otherwise unavailable to, a set of system functions, including the setting 1130-1 to learn from the application, the setting 1130-2 to show the application in search, the setting 1130-3 to show the application in the home screen user interface 492 and the setting 1130-4 to suggest the application. As such, in response to a user input corresponding to a request to toggle any of the settings to “on,” the device 100 optionally prompts the user to unhide the application before allowing the user to toggle the setting. In some embodiments, the user must unhide the respective application (e.g., via the quick actions menu 712) before being able to adjust the settings for the application.

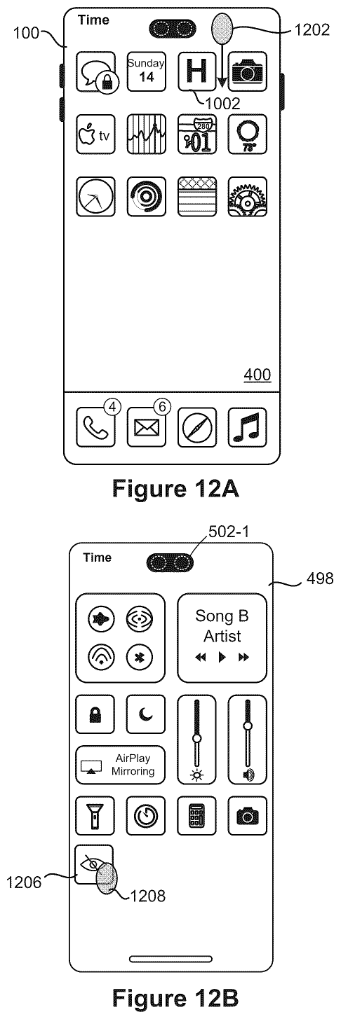

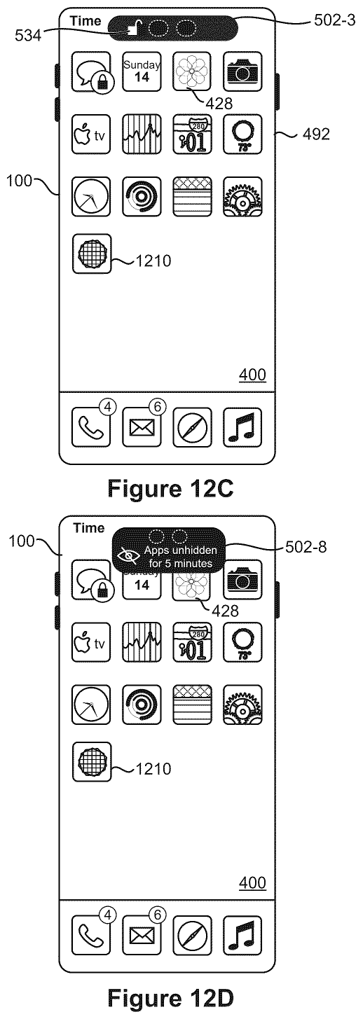

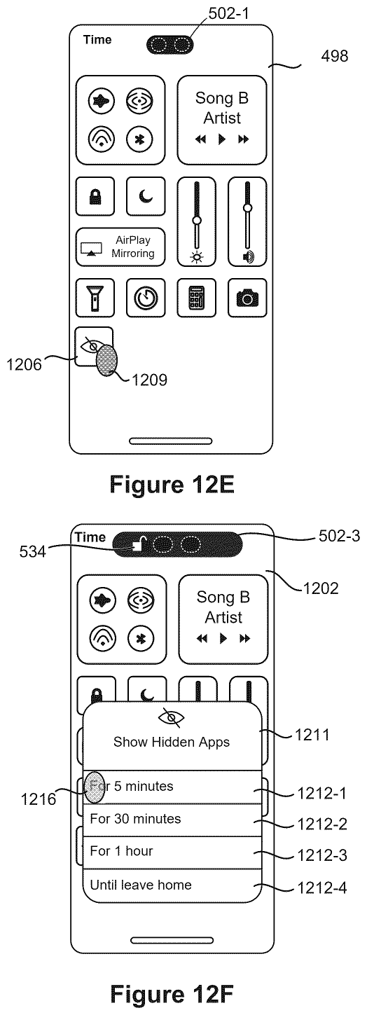

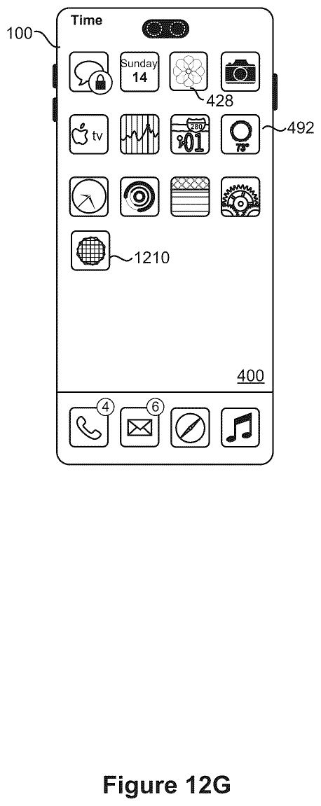

FIGS. 12A-12G illustrate example user interfaces for unhiding hidden applications using one or more controls. For example, FIG. 12A illustrates detecting a user input 1202 corresponding to a request to access a control user interface 498 (e.g., as described with reference to FIG. 4C1-4C2, in some embodiments the user input 1202 is a swipe input that starts from a top edge of the device 100). In some embodiments, the control user interface 498 (e.g., in FIG. 12B) includes a control 1206 for toggling hidden applications from being displayed as hidden to being displays as unhidden and vice-versa.

For example, in response to detecting the user input 1208 (e.g., in FIG. 12B), such as a tap user input or other selection user input, directed to the control 1206, the device 100 initiates the authentication process, as illustrated in the session region 502-3 in FIG. 12C. In some embodiments, in accordance with a determination that the authentication is successful (e.g., as indicated by the unlocked representation 534 in FIG. 12C), the one or more hidden application icons are displayed (e.g., with their unhidden application icons) in the home screen user interface 492. For example, the hidden application icons 1002 and 1004 (e.g., in FIG. 10A) are updated to be displayed as application icon 428 and application icon 1210, as illustrated in FIG. 12C. For example, the application icon 428 identifies the application corresponding to the application icon 428 (e.g., a photos application) while the hidden application icon 1002 also corresponded to the photos application without displaying identifying information about the application. In some embodiments, one or more hidden application icons that are displayed on one or more other pages of the home screen user interface 492 are also displayed as hidden. In some embodiments, in accordance with a determination that the authentication is unsuccessful, the device 100 forgoes displaying the application icons 428 and 1210 and maintains display of the hidden application icons 1002 and 1004.

In some embodiments, as illustrated in FIG. 12D, in response to the user input 1202 and in accordance with a determination that the authentication process was successful, the application icons remain unhidden for a threshold amount of time (e.g., for 1 minutes, for 5 minutes, 10 minutes, 1 hours, or another amount of time) and/or the application icons remain unhidden until the device 100 enters a locked state (e.g., whichever occurs first or last, the threshold amount of time or the locked state). For example, FIG. 12D illustrates that the session region 502-8 displays an indication that the applications will remain unhidden for 5 minutes. In some embodiments, while the applications are unhidden, the device 100 does not require authentication for the user to open and/or access the applications.

FIG. 12E illustrates detecting a user input 1209, such as a tap and hold input or other selection input (e.g., a different type of input than the user input 1208), directed to the control 1206, and in response to the user input 1209, the device 100 displays a menu 1211 of options 1212 (e.g., including options 1212-1 through 1212-4) for the control 1206 and/or initiates the authentication process to enable the user to access and/or interact with the menu 1211, as illustrated in FIG. 12F.

In some embodiments, the device 100 displays the menu 1211 in accordance with a determination that authentication process is successful (e.g., and the menu 1211 is not displayed if the authentication process is unsuccessful). For example, the menu 1211 of options for the control for toggling hidden applications from being displayed as hidden and/or unhidden includes options for setting the threshold amount of time and/or setting a context for how long the hidden applications should remain unhidden. For example, the options 1212-1 through 1212-3 correspond to lengths of time for which the applications will remain unhidden, and the option 1212-4 corresponds to a context (e.g., until the device 100 leaves home (e.g., as determined by location information of the device 100, connectivity to a home wireless network and/or another determination) or another location, such as work). FIG. 12G illustrates that, in response to detecting the user input 1216 directed to the option 1212-1, the hidden application icons are displayed as unhidden application icon 428 and unhidden application icon 1210 in the home screen user interface 492.

FIGS. 13A-13F are flow diagrams illustrating method 13000 of requiring authentication for a locked application in accordance with some embodiments. Method 13000 is performed at a computer system (e.g., device 300 (e.g., in FIG. 3A) or portable multifunction device 100 (e.g., in FIG. 1A)) with one or more output generation components (e.g., one or more display devices (e.g., touch-sensitive display system 112 (e.g., in FIG. 1A) or display 340 (e.g., in FIG. 3A)), optionally one or more tactile output generators (e.g., tactile output generator(s) 167 (e.g., in FIG. 1A) or tactile output generator(s) 357 (e.g., in FIG. 3A)), and/or optionally one or more audio output devices (e.g., speaker 111 (e.g., in FIG. 1A))), and one or more input devices (e.g., touch screen 112 (e.g., in FIG. 1A), keyboard/mouse 350 (e.g., in FIG. 3A), touchpad 355 (e.g., in FIG. 3A), hardware input device 145 (e.g., in FIG. 1C), and/or other input or control devices 116 (e.g., in FIG. 1A), (e.g., one or more buttons, switches, joysticks, click wheels, keys, microphones, sensors (e.g., image sensors, capacitive sensors, and/or other types of sensors), touch-sensitive surfaces, microphones, and/or other input elements)). In some embodiments, the computer system includes a display component, such as a touch-sensitive display (e.g., touch-sensitive display system 112 (e.g., in FIG. 1A) or display 340 (e.g., in FIG. 3A)). In some embodiments, the computer system is communicatively coupled to a display device (e.g., via a wired and/or wireless connection). Some operations in method 13000 are, optionally, combined and/or the order of some operations is, optionally, changed.

As described herein, method 13000 provides a computer system for locking an application of the computer system, whereby a locked application requires authentication before allowing the user and/or other applications of the computer system to access content of the locked application. For example, in response to detecting a request from a user and/or from an application of the computer system to access (e.g., view and/or control) content that is stored by or otherwise associated with a locked application, the computer system initiates an authentication process to authenticate the user before enabling the user and/or application of the computer system to access the content of the locked application. Requiring authentication from a user before allowing access to content associated with one or more locked applications prevents unauthorized access to the locked applications and associated content, thereby improving the privacy and security of the computer system by protecting sensitive content associated with the locked applications. Additionally, initiating an authentication process in response to detecting a user input corresponding to a request to access a locked application, where the authentication process optionally does not require explicit input from the user, reduces the number of inputs required to unlock an application.

The computer system detects (13002), via the one or more input devices, one or more inputs (e.g., one or more tap inputs, tap and hold inputs, air tap gestures, air pinch gestures, and/or other types of user inputs) corresponding to a request from outside of a first application to access content corresponding to the first application (e.g., a request from a system user interface or from a user interface of a second application that is different from the first application). For example, as described with reference to FIG. 5C, the device 100 displays a user interface 510-2 that includes a plurality of options 522 (e.g., including options 522-1 through 522-7) for inserting content, and in response to detecting the user input 524, the device 100 attempts to access content of the photos application (e.g., the user input 524 corresponds to a request for the messenger application to access content corresponding to the photos application associated with option 522-2).

In response to detecting (13004) the request to access the content corresponding to the first application, the computer system: in accordance with a determination that the first application is in a locked state (13006): requests (e.g., outputs an audio, visual, and/or tactile prompt for) authentication information from a user of the computer system. For example, as described with reference to FIGS. 5D-5E, the device 100 requires the user to provide successful authentication before allowing the application to access the content from the locked application. In response to receiving, via the one or more input devices (e.g., a keyboard, touch-sensitive surface, and/or one or more biometric sensors), the authentication information (e.g., from the user) and in accordance with a determination that the received authentication information is consistent with (or matches) authorized authentication information, the computer system allows access to the content corresponding to the first application (e.g., outputting via the one or more output generation components at least a portion of the content such as playing audio content or displaying visual content and/or providing a response to the request with identification of the content) without opening the first application (e.g., without displaying the first application or without displaying a user interface of the first application). For example, as described with reference to FIGS. 5E-5F, one or more photos 540 are displayed in the messenger user interface 510-1 after successful authentication of the user.

In accordance with a determination that the first application is in an unlocked state (13008), the computer system allows access to the content corresponding to the first application (e.g., outputs via the one or more output generation components at least a portion of the content such as playing audio content or displaying visual content and/or provides a response to the request with identification of the content) without requesting the authentication information from the user of the computer system and without opening the first application (e.g., without displaying the first application or without displaying a user interface of the first application). For example, as described with reference to FIG. 5C, the one or more applications that are unlocked (e.g., the one or more applications in the user interface 510-2 other than the photos application) are accessible without requiring authentication from the user.

In some embodiments, requesting the authentication information from the user of the computer system comprises presenting an authentication user interface (e.g., including instructions for the user to input the authentication information). In some embodiments, in response to receiving, via the one or more input devices, the authentication information and in accordance with a determination that the received authentication information is inconsistent with the authorized authentication information, the computer system does not allow (e.g., prevents or restricts) access to the content corresponding to the first application. In some embodiments, in response to detecting the request to access the content corresponding to the first application and in accordance with the determination that the first application is in the locked state, the computer system automatically (e.g., without requesting the authentication information and/or without requiring further user inputs) obtains the authentication information from the user (e.g., via a biometric scan such as a facial scan, a retinal scan, or other type of scan).

For example, the request from outside of the first application to access the content corresponding to the first application may be from a search application, a share application, or other type of application. As another example, the request from outside of the first application may be from a system operation, such as a search operation, a display operation, a recommendation operation, a sort operation, or a digital assistant operation. For example, the first application may be a messaging application, a photos application, a storage application, and/or other type of application. As an example, the content corresponding to the first application may include one or more files, such as audio files, image/video files, text files, and/or one or more other types of files.

In some embodiments, the authentication information comprises (13010) biometric information from the user of the computer system. For example, as described with reference to FIG. 5C, the session region 502-2 corresponds to a prompt for the user to authenticate, for example, using biometric authentication (e.g., facial scan, fingerprint scan, eye scan, and/or another type of biometric scan). In some embodiments, the biometric information comprises information about unique biological traits of the user (e.g., a fingerprint scan, a voice recording, an eye (e.g., iris and/or retina) scan, a facial scan, and/or other types of biometric authentication). In some embodiments, the computer system includes a fingerprint reader, a voice analyzer, a facial scanner, a retina scanner, and/or other biometric sensor or component. In some embodiments, the request for authentication information is a request for multimodal authentication involving two or more types of authentication information, such as two types of biometric information and/or a type of non-biometric authentication information. Requiring biometric authentication from a user before allowing access to content associated with one or more locked applications prevents unauthorized users that do not successfully perform the biometric authentication from accessing locked applications and associated content, thereby improving the privacy and security of the computer system by protecting sensitive content associated with the locked applications.

In some embodiments, prior to detecting the one or more inputs corresponding to the request to access the content corresponding to the first application, the computer system causes presentation (13012), via the one or more output generation components, of a notification from the first application. In some embodiments, the request to access the content corresponding to the first application comprises a user input corresponding to selection of the notification. For example, as described with reference to FIGS. 7L-7N, in response to detecting a user input directed to the notification 704-3 for the locked messenger application, the device 100 initiates the authentication process before enabling the user to view the application user interface for the messenger application. Example notifications include a notification of a missed call (e.g., the first application is a telephony application), a notification of a new message (e.g., the first application is a messaging application), a notification of new updates being available for the first application, a notification of an event involving the first application (e.g., new content available from the first application), a recommendation notification, or other type of notification. In some embodiments, the content corresponding to the first application comprises notification information from the first application. In some embodiments, causing presentation of the notification comprises causing display of the notification. In some embodiments, causing presentation of the notification comprises causing a haptic and/or audio output corresponding to the notification. Displaying a notification and, if the notification is associated with a locked application, requiring authentication from a user before allowing access to content of the notifications provides the user with additional information by notifying the user of the notification without allowing unauthorized users to view content of the notification, thereby improving the privacy and security of the notifications associated with a locked application.

In some embodiments, the notification includes (13014) a subset of notification information from the first application without including other notification information from the first application. For example, as described with reference to FIG. 7L, the locked notification 704-3 (e.g., in FIG. 7L) for the messenger application includes information about the application and a number of notifications, but does not include information about the sender and/or the content of the message while the messenger application is locked. In some embodiments, the subset of the notification information is a name of the first application. In some embodiments, substance of the notification is suppressed prior to the determination that the received authentication information is consistent with the authorized authentication information. For example, the notification may be a notification of a new message received from a sender. In this example, the sender information and/or the message content may be suppressed until the determination that the received authentication information is consistent with the authorized authentication information. In some embodiments, notification does not include any information for which the corresponding information type is denoted as being sensitive information. Displaying a notification without displaying content of the notification and/or other information about the notification and, if the notification is associated with a locked application, requiring authentication from a user before allowing access to content of the notifications, provides real-time updates to the user by notifying the user of the notification without allowing unauthorized users to view content of the notification, thereby improving the privacy and security of the notifications associated with a locked application.

In some embodiments, the notification is presented (13016) with one or more attributes; in accordance with a determination that the first application is in the unlocked state, the notification is presented with a first set of values for the one or more attributes, the first set of values corresponding to the first application; and in accordance with a determination that the first application is in the locked state, the notification is presented with a set of default values, wherein the set of default values are different than the first set of values. For example, as described with reference to FIGS. 7C and 7L, the notification 705-1 that is displayed while the messenger application is unlocked includes additional information than the locked notification 704-3 (e.g., in FIG. 7L) for the messenger application while the messenger application is locked. In some embodiments, the one or more attributes include one or more haptic outputs and/or one or more audio outputs. In some embodiments, the first set of values are mapped to the entity (e.g., a person or device) that caused the notification to be generated. For example, message notifications from particular senders may have customized (e.g., personalized) attributes (e.g., set by the first application). In some embodiments, the first set of values are selected by a user of the computer system (e.g., selected for use with the first application or for use with a first type of notifications from the first application). Automatically displaying or not displaying information for a notification based on whether or not the application associated with the notification is a locked or an unlocked application, reduces the number of user inputs required to set up or otherwise manage notification settings for different applications and improves the privacy and security of the computer system by limiting the information displayed for one or more notifications.

In some embodiments, the content corresponding to the first application comprises a (13018) file folder. For example, as described with reference to FIGS. 8A-8D, in some embodiments, the file folder 804-2 associated with a respective application is locked. In some embodiments, the file folder is stored on the computer system. In some embodiments, the file folder is stored on a system that is communicatively coupled to the computer system. In some embodiments, the file folder comprises an application-specific file folder. In some embodiments, the file folder is part of a files application distinct from the first application. In some embodiments, the file folder stores files with user-generated content and/or application-generated data (e.g., metadata, settings, and/or other types of application-generated data). Enabling a user to lock a file folder such that the computer system requires authentication from the user before allowing access to the locked file folder, provides the user with additional control options for securing files stored in a file folder, and improves the privacy and security of files by requiring additional authentication from the user.

In some embodiments, the one or more inputs corresponding to the request to access the content corresponding to the first application corresponds to (13020) a request to display a sharing user interface of a second application, and wherein the content corresponding to the first application comprises contact information for one or more potential recipients of shared information. For example, as described with reference to FIGS. 5A-5F, in some embodiments, a share sheet user interface is displayed and includes options for sharing content of a first application with one or more locked applications and/or one or more contacts via a locked application. In some embodiments, the sharing user interface includes potential recipients for sharing data (e.g., one or more images, videos, audio files, text files, and/or other types of data) from the second application. In some embodiments, displaying the sharing interface includes one or more sharing options for sharing content with other devices. In some embodiments, the sharing option(s) include options for sharing content via different applications and/or protocols. For example, the sharing options may include an email option for emailing the selected content to a selected recipient, an SMS/MMS option for sending the selected content via an instant message to the selected recipient, and/or a third-party app option for sharing the selected content with the selected recipient via a third-party application. In some embodiments, the sharing user interface includes a contacts section with a set of selectable elements for respective contacts of a user of the computer system. Determining whether or not to provide an application in a share sheet user interface, based on whether the application is locked or unlocked, in response to a request to display the share sheet user interface, improves the privacy and security of locked applications by preventing display of representations of locked applications in the share sheet user interface.

In some embodiments, in response to receiving, via the one or more input devices, the authentication information and in accordance with a determination that the received authentication information is inconsistent with the authorized authentication information, the computer system causes display (13022), via the one or more display generation components, of a user interface that includes an option to retry authentication of the user. For example, as described with reference to FIGS. 6B-6D, the device 100 displays the option 616 to reattempt authentication after the authentication process failed. In some embodiments, the user interface is an authentication user interface that includes instructions for the user to submit authentication information (e.g., via text input, biometrics input, or other type of input). In some embodiments, requesting the authentication information from the user comprises causing display of an authentication user interface, and causing the display of the user interface that includes the option to retry the authentication comprises causing display of the authentication user interface with information indicating a failure to authenticate the user using previously submitted authentication information. In some embodiments, the user interface that includes the option to retry the authentication further includes instructions and/or recommendations for the user to assist with acquiring authentication information. For example, a facial-scan based authentication methodology may include a recommendation to remove glasses, a hat, and/or a mask, instructions to adjust lighting, and/or instructions to adjust positioning of the user with respect to a sensor (e.g., a camera of the computer system). As another example, a fingerprint-based authentication methodology may include a recommendation to use a different finger, a recommendation to wipe/dry the finger, and/or instructions to adjust orientation of the finger. In some embodiments, the option to retry the authentication comprises an option to provide a different type of authentication information (e.g., a different type of biometric authentication). Automatically displaying an option for the user to reattempt authentication to unlock a locked application and/or folder in accordance with a determination that a previous authentication attempt failed, reduces the number of inputs required from the user to request to re-initiate the authentication process without requiring the user to navigate complex menu hierarchies.

In some embodiments, the first application is (13024) a files application configured to manage files of one or more other applications, including a third application. In some embodiments, the computer system detects, via the one or more input devices, one or more inputs (e.g., one or more tap inputs, tap and hold inputs, air tap gestures, air pinch gestures, and/or other types of user inputs) corresponding to a second request from within the third application to access one or more files of the third application; and in response to detecting the one or more inputs corresponding to the second request, the computer system allows access to the one or more files of the third application regardless of whether the first application is in the locked state. For example, as described with reference to FIG. 8A, in some embodiments, one or more files require authentication for a user to view and/or access contents of the file 804-2. In some embodiments, the one or more files are stored in an application-specific folder designated for the third application. In some embodiments, the state of the first application is checked in response to cross-app content requests, and is not checked in response to same application content requests. As an example, the third application is a photo application and the request to access the one or more files is a request to view a photo stored in an application-specific folder (e.g., a photos folder) for the photo application. Automatically enabling an application to access to files that are associated with the application, regardless of whether the application is a locked or unlocked application, reduces the number of inputs required from the user by granting an application with access to its own files without requiring additional user authentication.

In some embodiments, the one or more inputs corresponding to the request to access the content corresponding to the first application is (13026) a request generated using a digital assistant executing at least in part on the computer system. For example, as described with reference to FIGS. 9A-9C, the command 906 corresponds to a request, to the virtual assistant of the device 100, to open the photos application. In some embodiments, the request from outside of the first application is generated by the digital assistant in response to a user query to the assistant. In some embodiments, the request from outside of the first application is a request from a digital assistant function. A digital assistant can be an application, module, and/or software capable of analyzing user instructions to identify tasks and provide assistance with completing the identified tasks. For example, a digital assistant can be an application, e.g., implemented in part on the computer system and in part on a set of server computers accessed by the computer system via a communications network such as the internet, that uses semantic analysis to analyze text, recognize terms and interpret the intended meaning. In some embodiments, processing by the digital assistant is performed at the computer system and/or at the set of server computers. Determining whether or not an application is unlocked or locked in response to a request from a virtual assistant that attempts to access the application, improves the privacy and security of the device by preventing unauthorized users from accessing locked applications by using the virtual assistant.

A task can be any type of action with which a digital assistant can provide assistance. For example, a task can include scheduling a meeting, performing a financial transaction, determining an estimated time of arrival, providing directions, providing weather information, performing a search and providing search results, providing spelling and/or definition of a term, alerting a user of relevant information, and/or other type of task. As an example, the digital assistant can gather requested data for the user from one or more web servers, such as weather data and/or traffic data. As another example, to assist with scheduling a meeting, a digital assistant can gather calendar information for a plurality of intended participants (e.g., from each intended participant) and recommend one or more proposed times for the meeting. As another example, to assist with performing a financial transaction, a digital assistant can determine the financial applications available and/or utilized by the user and recommend a financial application to perform the financial transaction.

As an example, the digital assistant may be tasked with scheduling a meeting and may generate the request to access the content corresponding to the first application (e.g., an application that stores contact information) to obtain contact information for participants in the meeting. As another example, the digital assistant may be tasked with performing a search and may generate the request to access the content corresponding to the first application so that the content may be searched. As another example, the digital assistant may be responding to a natural language request and may generate the request to access the content corresponding to the first application to obtain additional context information for interpreting and responding to the request.

In some embodiments, the computer system detects (13028), via the one or more input devices, one or more inputs (e.g., one or more tap inputs, tap and hold inputs, air tap gestures, air pinch gestures, and/or other types of user inputs) corresponding to a request to activate the first application; and in response to detecting the one or more inputs corresponding to the request to activate the first application: in accordance with a determination that the first application is in the locked state, the computer system requires additional authentication before allowing the first application to activate; and the computer system receives, via the one or more input devices, second authentication information; and in response to receiving, via the one or more input devices, the second authentication information from the user, and in accordance with a determination that the second authentication information is consistent with the authorized authentication information, allows the first application to activate. In some embodiments, in accordance with a determination that the first application is in the unlocked state, the computer system allows the first application to activate without requesting the second authentication information from the user. For example, as described with reference to FIGS. 7M-7R, if the messenger application is in the locked state, authentication is required; and if the messenger application is in the unlocked state (e.g., in FIG. 7Q), the device 100 displays the user interface 510-1 for the messenger application without requiring the user to reauthenticate. In some embodiments, in accordance with the determination that the first application is in the locked state, the computer system requests the second authentication information from the user of the computer system. In some embodiments, requesting the second authentication information comprises causing display of an authentication user interface (e.g., with one or more selectable options for inputting authentication information). In some embodiments, execution of the first application is halted (e.g., suspended, paused, or otherwise halted) until the first application is allowed to activate. In some embodiments, in response to receiving, via the one or more input devices, the second authentication information and in accordance with a determination that the received second authentication information is inconsistent with the authorized authentication information, the computer system does not allow (e.g., prevents or restricts) the first application to activate. Requiring user authentication in order to open a locked application improves the privacy and security of the computer system by preventing unauthorized users from opening and/or viewing the locked application.

In some embodiments, allowing the first application to activate comprises allowing display of a user interface of the first application. In some embodiments, allowing the first application to activate comprises allowing the first application to access content stored in an application-specific folder for the first application. In some embodiments, the request to activate the first application corresponds to a user selection of a selectable interface element (e.g., an icon, a representation, or other type of interface element) for the first application. In some embodiments, the selectable interface element is displayed on a home screen. In some embodiments, the selectable interface element is displayed in an application folder. In some embodiments, the selectable interface element is displayed in a set of search results (e.g., in a search results interface).

A home screen user interface (also sometimes referred to as a “home screen”) includes icons for navigating to a plurality of applications that are executed by the computer system. In some embodiments, the home screen user interface is displayed as a default user interface in response to the user powering on, logging into, and/or activating the computer system. In some embodiments, the computer system detects and responds to interaction with the home screen user interface using one or more gestures, including touch inputs. For example, a tap input or other selection input directed to a respective application icon causes the respective application to launch, or otherwise open a user interface for the respective application, on a display. In some embodiments, a plurality of views for the home screen user interface is available. For example, the device detects and responds to user inputs such as swipe gestures or other inputs (e.g., inputs directed to the currently displayed view of the home screen user interface) that correspond to requests to navigate between the plurality of views, where each view of the home screen user interface includes different application icons for different applications. In some embodiments, the application icons are different sizes, such as an application widget that displays information for the respective application, where the application widget is larger than the application icons.

In some embodiments, in response to detecting the one or more inputs corresponding to the request to activate the first application, the computer system displays (13030), via the one or more output generation components, a first portion of an indication that the first application has started to open; and in accordance with the determination that the first application is in the locked state, requiring additional authentication before allowing the first application to activate comprises displaying, via the one or more output generation components, a second portion of the indication that the first application has started to open. For example, as described with reference to FIGS. 7N-70, the device 100 displays the session region 502-2 optionally includes an indication 767 of the application that is requiring the authentication. In some embodiments, the second portion of the indication comprises displaying the authentication user interface 768 that prompts the user for authentication. In some embodiments, displaying the second portion of the indication that the first application has started to open comprises an indication that the computer system is attempting to launch the first application and optionally includes displaying a lock symbol and/or optionally includes blurring and/or otherwise visually obscuring the user interface. In some embodiments, in accordance with the determination that the first application is in the locked state, the computer system suspends, interrupts, or halts the launch of the first application (e.g., while displaying the second portion of the indication). In some embodiments, the display of the second portion of the indication that the first application has started to open comprises display of an authentication user interface (e.g., a biometric authentication user interface), and the second authentication information is received via the authentication user interface. In some embodiments, in accordance with the determination that the first application is in the unlocked state (e.g., after the providing the additional authentication), the computer system displays, via the one or more output generation components, a third portion of the indication that the first application has started to open, wherein the third portion of the indication comprises an unlocked symbol that is optionally displayed in a session region of the computer system. Displaying an indication that an application is attempting to open, without displaying information about the application until successful authentication is achieved, provides visual feedback to the user in response to the user request to open the application without providing any private information related to the application before authenticating the user, thereby improving the privacy and security of the application.

In some embodiments, the second authentication information is (13032) biometric authentication information; and, in response to detecting the one or more inputs corresponding to the request to activate the first application and in accordance with the determination that the first application is in the locked state, the computer system automatically obtains the biometric authentication information from the user (e.g., the one or more inputs corresponding to the request to activate the first application is interpreted as a request to obtain biometric authentication information). For example, as described with reference to FIG. 5C, in some embodiments, the authentication process is initiated automatically (e.g., in response to detecting an input corresponding to a request to access a locked application) without requiring additional explicit user input. In some embodiments, automatically obtaining the biometric authentication information comprises performing (e.g., via one or more sensors of the computer system) a scan of the user (e.g., a facial scan, a retinal scan, or other type of scan). In some embodiments, the biometric authentication information is received in response to detecting the request to activate the first application without further user inputs (e.g., without the user needing to select a biometric scan option or needing to interact with an authentication interface). Automatically obtaining biometric information from the user in order to perform the biometric authentication reduces the number of inputs required from the user to unlock the application.

In some embodiments, while receiving the second authentication information and/or determining whether the second authentication information is consistent with the authorized authentication information, the computer system causes display (13034), via the one or more output generation components, of an authentication status user interface that indicates a status of an authentication process corresponding to the second authentication information. For example, as described with reference to FIG. 7N, the session region 502-2 and/or the user interface 768 displays status information for the authentication process. In some embodiments, the authentication status user interface indicates that a biometric scan is being performed (e.g., indicates that a particular type of biometric scan is being performed). In some embodiments, the authentication status user interface indicates whether the second authentication information is being received or the second authentication information is being authenticated (e.g., being compared with the authorized authentication information). Displaying a status indication that an authentication process is being performed provides real-time visual feedback to the user without requiring the user to provide explicit user inputs to determine whether or not the authentication process is in progress.

In some embodiments, the authentication status user interface is displayed (13036) overlaid over at least a portion of a user interface of the first application. For example, as described with reference to FIG. 7N, the session region 502-2 at least partially overlays the user interface 768 as the application is being launched. In some embodiments, the authentication status user interface is partially transparent such that the portion of the user interface is at least partially visible under the authentication status user interface. In some embodiments, display of the user interface of the first application is replaced with display of the authentication status user interface. Displaying a status of the authentication process for allowing access to a locked application concurrently with a portion of the user interface for the locked application as the application is opened provides visual feedback to the user about the state of opening the application and the progress of the authentication without requiring the user to provide additional explicit inputs to determine whether or not the application is being opened.

In some embodiments, the authentication status user interface is displayed (13038) within a status region that displays information about one or more operations currently being performed by the computer system. For example, as described with reference to FIG. 7N, the session region 502-2 displays a status of the authentication process. In some embodiments, the status region (sometimes referred to as a dynamic window) has a size (e.g., a length and/or width) that is adjusted based on content presented within the region. In some embodiments, the status region is displayed at a preset location on a display of the computer system (or on a display component that is communicatively coupled to the computer system). In some embodiments, the status region (also called a session region) provides status information for one or more applications (e.g., in some embodiments for multiple applications concurrently), within a consistently located display region that persists during navigation between user interfaces outside of the status region (e.g., typically user interfaces of applications not represented in the status region). In some embodiments, the status information for a respective application in the status region is updated over time while an active session for the respective application is ongoing (e.g., the respective application continues executing on the computer system, optionally as a background process), during display and/or interaction with a user interface of another application outside of the status region and/or during navigation between user interfaces of one or more applications other than the respective application and/or one or more system user interfaces). Displaying a status of the authentication process for allowing access to a locked application concurrently in a status region of the computer system provides visual feedback to the user about the progress of the authentication process without requiring the user to provide additional explicit inputs to determine whether or not authentication is being performed.

In some embodiments, after authenticating the user, the computer system detects (13040), via the one or more input devices, one or more inputs (e.g., one or more tap inputs, tap and hold inputs, air tap gestures, air pinch gestures, and/or other types of user inputs) corresponding to a third request to access the content corresponding to the first application; and in response to detecting the one or more inputs corresponding to the third request: in accordance with a determination that less than a threshold amount of time has passed since authenticating the user, the computer system allows access to the content corresponding to the first application without requesting additional authentication information from the user; and in accordance with a determination that more than the threshold amount of time has passed since authenticating the user, the computer system: requests second authentication information from the user; and in response to receiving, via the one or more input devices, the second authentication information and in accordance with a determination that the second authentication information is consistent with authorized authentication information, allows access to the content corresponding to the first application. For example, as described with reference to FIGS. 7P-7R, the device 100 redisplays the application user interface 510-1 for the locked application, without requiring additional authentication, in accordance with a determination that less than a threshold amount of time has passed since the user unlocked the application. In some embodiments, in accordance with a determination that the second authentication information is not consistent with authorized authentication information, the computer system denies (e.g., forgoes allowing) access to the content corresponding to the first application. For example, the threshold amount of time may be 30 seconds, 1 minute, 3 minutes, 5 minutes, 8 minutes, 10 minutes, 1 hour, or another period of time. In some embodiments, authenticating the user comprises authenticating the user with regards to the first application. In some embodiments, authenticating the user comprises authenticating the user with multiple (e.g., some or all) locked applications on the computer system. In some embodiments, the user is authenticated for the threshold amount of time, until the computer system is locked, until the computer system is powered off, until the user re-locks the first application, or whichever of the preceding occurs first. In some embodiments, closing the first application comprises re-locking the first application. Requesting additional authentication from the user if a previous authentication was recent, without requiring additional authentication from the user if a previous authentication was not recent, reduces the number of inputs and amount of time required to open a locked application by preventing the user from reauthenticating if the user recently successfully authenticated.

In some embodiments, in accordance with a determination that the received authentication information is consistent with authorized authentication information, the computer system sets the first application to the unlocked state (e.g., for the threshold amount of time, until the first application ceases to execute (e.g., is closed), or whichever of the preceding occurs first). In some embodiments, the third request to access the content corresponding to the first application comprises a request to access a different subset of the content corresponding to the first application than the first request to access the content corresponding to the first application.

In some embodiments, while the computer system is in the locked state, the computer system requests (13042) biometric information from the user of the computer system in response to detecting, via the one or more input devices, an input (e.g., an input detected at a physical button of the computer system, a swipe input, a tap input, a tap and hold input, an air tap gesture, an air pinch gesture, and/or another type of user input) corresponding to a request to unlock the computer system; and in response to receiving, via the one or more input devices, the biometric information from the user and in accordance with a determination that the received biometric information is consistent with authorized biometric information, the computer system unlocks the computer system and authenticates the user. For example, as described with reference to FIG. 7B, a same authentication unlocks the device 100 and a locked application of the device 100. In some embodiments, the user is prompted to provide authentication information in order to unlock the computer system, and the biometric information is received in response to the prompt. In some embodiments, the biometric information is received via a biometric scan such as a facial scan, a retinal scan, or other type of scan). Requiring the user to provide biometric authentication in order to unlock the computer system improves the privacy and security of the computer system by limiting access to the user.

In some embodiments, in response to receiving, via the one or more input devices, the biometric information from the user and in accordance with a determination that the received biometric information is not consistent with authorized biometric information, the computer system maintains (13044) the computer system in the locked state (e.g., forgoing unlocking the computer system without authenticating the user). For example, as described with reference to FIG. 7B, the device 100 remains in the locked state in accordance with a determination that the authentication is not successful. Preventing a user from accessing the computer system if the biometric authentication fails improves the privacy and security of the computer system.

In some embodiments, the computer system causes display (13046), via the one or more output generation components, of an icon for the first application on a first user interface; detects, via the one or more input devices, a first user input (e.g., a tap input, a tap and hold input, an air tap gesture, an air pinch gesture, and/or another type of user input) directed to the icon; and in response to detecting the first user input: in accordance with a determination that the first user input is a first type of input, causes display, via the one or more output generation components, of an option to activate the locked state for the first application; and in accordance with a determination that the first user input is not the first type of input, forgoes causing display of the option to activate the locked state for the first application. For example, as described with reference to FIGS. 7D-7E, in response to detecting the user input 710, in accordance with a determination that the input 710 is a tap and hold input (e.g., a long press), and/or other type of user input, the device 100 displays the quick actions menu 712 that includes option 716 for locking the application. For example, the first type of input may be a tap input, a tap-and-hold input, or other type of input. In some embodiments, the option to activate the locked state for the first application is displayed in a menu (e.g., quick actions menu 712) that includes a list of one or more other options for performing respective operations (e.g., also referred to as quick actions) associated with the first application. In some embodiments, in response to detecting the first user input and in accordance with the determination that the first user input is the first type of input, the computer system causes a context menu to be displayed for the first application, where the context menu includes the option to activate the locked state. In some embodiments, the first user interface is a home screen user interface. In some embodiments, the first user interface is an application library interface. In some embodiments, the option to activate the locked state for the first application is an option to toggle a lock state of the first application. In some embodiments, the option to activate the locked state for the first application is displayed in response to the first user input, in accordance with the determination that the first user input is the first type of input, and in accordance with a determination that the first application is in the unlocked state. Displaying a menu for an application in response to a user input that includes an option for locking an application provides additional control options to the user and improves the privacy and security of the device.

In some embodiments, the computer system causes display (13048), via the one or more output generation components, of an icon for the first application on a first user interface; detects, via the one or more input devices, a first user input (e.g., a tap input, a tap and hold input, an air tap gesture, an air pinch gesture, and/or another type of user input) directed to the icon; and in response to detecting the first user input: in accordance with a determination that the first user input is a first type of input, causes display, via the one or more output generation components, of an option to activate the unlocked state (e.g., an option to deactivate the locked state) for the first application; In some embodiments, the option to activate the unlocked state is displayed in a menu that includes a list of one or more other options for performing respective operations (e.g., also referred to as quick actions) associated with the first application. In some embodiments, in accordance with a determination that the first user input is not the first type of input, the computer system forgoes causing display of the option to activate the locked state for the first application. For example, as described with reference to FIGS. 71-7J, in response to detecting the user input 750, the device 100 displays the quick actions menu 712. For example, the first type of input may be a tap input, a tap-and-hold input, or other type of input. In some embodiments, in response to detecting the first user input and in accordance with the determination that the first user input is the first type of input, the computer system causes a context menu to be displayed for the first application, where the context menu includes the option to activate the unlocked state. In some embodiments, the context menu includes an option to activate the locked state and an option to activate the unlocked state (e.g., with one of the options disabled based on the current lock state of the first application). In some embodiments, the first user interface is a home screen user interface. In some embodiments, the first user interface is an application library interface. In some embodiments, the option to activate the unlocked state for the first application is an option to toggle a lock state of the first application. In some embodiments, the option to activate the unlocked state for the first application is displayed in response to the first user input, in accordance with the determination that the first user input is the first type of input, and in accordance with a determination that the first application is in the locked state. Displaying a menu for an application in response to a user input that includes an option for unlocking an application that was previously locked provides additional control options to the user for selecting which applications are locked and unlocked.

In some embodiments, the computer system detects (13050), via the one or more input devices, one or more inputs (e.g., one or more tap inputs, tap and hold inputs, air tap gestures, air pinch gestures, and/or other types of user inputs) corresponding to a request to activate the locked state for the first application. In some embodiments, in response to detecting the one or more inputs corresponding to request to activate the locked state, the computer system causes display, via the one or more output generation components, of a user interface with information indicating a set of applications that use data from the first application. For example, as described with reference to FIGS. 7G and 7H, the user interface 734-1 displays a list of one or more applications that are related to and/or use data from the messenger application and the user interface 734-2 displays a list of one or more applications that are related to and/or use data from the photos application. In some embodiments, the information indicating the set of applications is displayed in a user interface with an option to confirm the request to activate the locked state. In some embodiments, the information indicating the set of applications is displayed in a user interface confirming that the first application is in the locked state. In some embodiments, the set of applications includes one or more applications for which the user has granted permission to access the data of the first application. Displaying a user interface, in response to a request to lock an application, that includes a list of other applications that use data from the application, provides the user with visual feedback and makes it easier for the user to lock the other applications without navigating through complex menu hierarchies.

In some embodiments, the user interface with information indicating the set of applications that use the data from the first application further comprises (13052) a set of selectable elements configured to lock the respective applications of the set of applications. In some embodiments, the computer system detects, via the one or more input devices, a second user input (e.g., a tap input, a tap and hold input, an air tap gesture, an air pinch gesture, and/or another type of user input) at a location corresponding to a selectable element for a fourth application; and in response to detecting the second user input at the location corresponding to the selectable element for the fourth application, activates the locked state for the fourth application (e.g., corresponding to the locked state of the first application described herein) (e.g., wherein the locked state of the fourth application requires authentication information before allowing access to the content corresponding to the fourth application). For example, as described with reference to FIGS. 7G, the user interface 734-1 the user interface 734-1 provides an option for each application, such as option 741-1 for application 740-1 and option 741-2 for application 740-2, for locking the respective applications that access the messenger application. In some embodiments, each application in the set of applications includes an option to toggle the lock state of the respective application. In some embodiments, the computer system, after activating the locked state for the fourth application, detects a user input corresponding to a request to navigate away from the user interface with the information indicating the set of applications; and in response to detecting the user input, the computer system causes display, via the one or more output generation components, of an icon for the fourth application (e.g., in the home screen user interface and/or another system user interface) with the first set of one or more attributes (e.g., a lock symbol or other indication that the fourth application is locked). Displaying a user interface, in response to a request to lock an application, that includes a list of other applications and an option for locking the other applications that use data from the application, provides the user with additional control options and reduces the number of inputs required to lock the other applications.

In some embodiments, the computer system causes display (13054), via the one or more output generation components, of an icon for the first application on a home screen user interface, wherein: in accordance with a determination that the first application is in the locked state, causing the icon to be displayed with a first set of one or more attributes; and in accordance with a determination that the first application is in the unlocked state, causing the icon to be displayed with a second set of one or more attributes that is different than the first set of one or more attributes. For example, as described with reference to FIG. 7D, the application icon 424 is displayed while the messenger application is unlocked; and as described with reference to FIG. 7I, the application icon 424 is displayed with a lock symbol 743 while the messenger application is locked. In some embodiments, while the first application is in the locked state and the icon is displayed with the first set of one or more attributes, the computer system detects, via the one or more input devices, a user input (e.g., a tap user input or other selection input directed to the icon) corresponding to a request to change the state of the first application from the locked state to the unlocked state; and in response to detecting the user input, the computer system updates the appearance of the icon to be displayed with the second set of one or more attributes (e.g., the lock symbol is updated to an unlocked symbol). In some embodiments, causing the icon to be displayed with a first set of one or more attributes comprises causing the icon to be displayed with a lock symbol or other indication that the first application is locked. In some embodiments, causing the icon to be displayed with a first set of one or more attributes comprises causing a default (e.g., generic and/or nondescript) icon to be displayed for the first application. In some embodiments, in accordance with the determination that the first application is in the locked state, a version of the icon that does not indicate the first application is displayed. For example, an icon with a locked symbol is displayed for each locked application. In some embodiments, respective icons for applications in the locked state are displayed with a same (e.g., generic) set of attributes. In some embodiments, in accordance with the determination that the first application is in the unlocked state, a version of the icon that indicates the identity of the first application is displayed. Automatically displaying an application icon with a locked indication if the application is locked and displaying the application icon without the locked indication if the application is unlocked provides visual feedback as to whether or not the application is in the locked or unlocked state without requiring the user to request a status of the application.

In some embodiments, in accordance with activating the locked state for the first application, the computer system activates (13056) the locked state for one or more widgets corresponding to the first application. For example, as described with reference to FIG. 7I, in accordance with a determination that the messenger application is locked, one or more widgets, such as widget 711-2 for the messenger application are also displayed with the locked state. In some embodiments, activating the locked state for the widget comprises hiding (e.g., ceasing to display) the widget. In some embodiments, activating the locked state for the widget comprises changing an appearance of the widget (e.g., to a default, generic, and/or non-descriptive appearance). In some embodiments, activating the locked state for the widget comprises ceasing to display content of the corresponding application within the widget. In some embodiments, activating the locked state for the widget comprises forgoing displaying content of the corresponding application that denoted as being sensitive information within the widget. In some embodiments, the one or more widgets are displayed in the home screen user interface 492, a wake screen user interface 490 and/or a widget user interface 491, as described with reference to FIGS. 4C1-4C2. Automatically displaying one or more widgets in a locked state in accordance with a determination that an application corresponding to the one or more widgets is in the locked state, causes the computer system to limit the information available in the one or more widgets for a locked application without requiring additional user inputs to manually lock the widgets, thereby improving the privacy and security of the widgets displayed by the computer system.

A widget (also sometimes referred to as a mini-application object) is a user interface object that provides a limited subset of functions and/or information available from the corresponding application without requiring the application to be launched. In some embodiments, widgets contain application content that is dynamically updated based on the current context. In some embodiments, a tap input or other selection input on a widget causes the corresponding application to be launched. In some embodiments, a respective widget operates as a standalone application residing in memory of the device, distinct from an associated application also residing in the memory of the device. In some embodiments, a respective widget operates as an extension or component of an associated application on the device. In some embodiments, a respective widget has a dedicated memory portion for temporary storage of information. In some embodiments, the memory portion is accessible by a corresponding full-featured application of the respective widget. In some embodiments, a widget is configured to perform a subset, less than all, of the functions of a corresponding application. In some embodiments, a widget displays an identifier for the corresponding application. In some embodiments, a widget displays a portion of the content from the corresponding application.

For example, a map widget displays a portion of a map that is displayed in a map application that corresponds to the map widget. For example, a calendar widget displays a portion of a calendar that is displayed in a corresponding calendar application. In some embodiments, a predefined input on a widget launches the corresponding application. In some embodiments, a widget operates as a standalone application residing in memory of the device, distinct from an associated application also residing in the memory of the device. For example, a widget corresponding to a social networking application operates as a single-purpose or streamlined application with a subset, less than all, of the functionality of the corresponding application, but is associated with the full-featured social networking application. In this example, the widget operates independently of the social networking application, and in a scenario where the social networking application is not running, the widget continues to operate. In some embodiments, a widget operates as an extension or component of an associated application on the device. For example, a widget for a calendar application is a single feature or operational component of the full-featured calendar application. In this example, if the calendar application is not running (e.g., in the background), the calendar widget does not operate either. In some embodiments, a widget has a dedicated memory portion for temporary storage of information. In some embodiments, this memory portion can be accessed by the corresponding full-featured application. For example, a widget for an instant messaging application has a memory portion for temporary storage of partially written reply messages. In this example, if the user opens the corresponding application in the middle of writing a reply message, the contents of the reply message are retrieved from the temporary storage location and used by the full-featured application to allow the user to complete his reply message.

In some embodiments, the computer system detects (13058), via the one or more input devices, one or more inputs (e.g., one or more tap inputs, tap and hold inputs, air tap gestures, air pinch gestures, and/or other types of user inputs) corresponding to a request to perform a system operation for which content corresponding to the first application is contextually relevant; in response to detecting the one or more inputs corresponding to a request to perform the system operation, outputs, via the one or more output generation components, a result of the system operation, including: in accordance with a determination that the first application is in the locked state, outputting (e.g., displaying visual content, playing audio content, and/or outputting tactile output), via the one or more output generation components, a result of the system operation using content from one or more sources other than the first application without using the content corresponding to the first application (e.g., restricting access to the content corresponding to the first application for the system operation); and in accordance with a determination that the first application is in the unlocked state, outputting (e.g., displaying visual content, playing audio content, and/or outputting tactile output), via the one or more output generation components, a result of the system operation using content from the one or more sources other than the first application and also using the content corresponding to the first application (e.g., allowing access to the content corresponding to the first application for the system operation). For example, as described with reference to FIG. 10A, in some embodiments, locked applications are hidden from a first set of system functions, such as notifications, a virtual assistant, suggestions, and a search function. Preventing the computer system from accessing one or more locked applications to perform system operations provides the user with additional control to limit the computer's access to applications and improves the privacy and security of the application.

It should be understood that the particular order in which the operations in method 13000 (e.g., in FIGS. 13A-13F) have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 14000) are also applicable in an analogous manner to method 13000 described above with respect to FIGS. 13A-13F. For example, the authentication information, one or more inputs, applications, locked states, and/or hidden states described above with reference to method 13000 optionally have one or more of the characteristics of the authentication information, one or more inputs, applications, locked states, and/or hidden states described herein with reference to other methods described herein (e.g., methods 14000). For brevity, these details are not repeated here.

FIGS. 14A-14J are flow diagrams illustrating method 14000 of determining whether or not to provide a system function with access an application based on its hidden state in accordance with some embodiments. Method 14000 is performed at a computer system (e.g., device 300 (e.g., in FIG. 3A) or portable multifunction device 100 (e.g., in FIG. 1A)) with one or more output generation components (e.g., one or more display devices (e.g., touch-sensitive display system 112 (e.g., in FIG. 1A) or display 340 (e.g., in FIG. 3A)), optionally one or more tactile output generators (e.g., tactile output generator(s) 167 (e.g., in FIG. 1A) or tactile output generator(s) 357 (e.g., in FIG. 3A)), and/or optionally one or more audio output devices (e.g., speaker 111 (e.g., in FIG. 1A))), and one or more input devices (e.g., touch screen 112 (e.g., in FIG. 1A), keyboard/mouse 350 (e.g., in FIG. 3A), touchpad 355 (e.g., in FIG. 3A), hardware input device 145 (e.g., in FIG. 1C), and/or other input or control devices 116 (e.g., in FIG. 1A), (e.g., one or more buttons, switches, joysticks, click wheels, keys, microphones, sensors (e.g., image sensors, capacitive sensors, and/or other types of sensors), touch-sensitive surfaces, microphones, and/or other input elements)). In some embodiments, the computer system includes a display component, such as a touch-sensitive display (e.g., touch-sensitive display system 112 (e.g., in FIG. 1A) or display 340 (e.g., in FIG. 3A)). In some embodiments, the computer system is communicatively coupled to a display device (e.g., via a wired and/or wireless connection). Some operations in method 700 are, optionally, combined and/or the order of some operations is, optionally, changed.

As described herein, method 14000 provides a computer system for hiding one or more applications of the computer system, whereby a hidden application requires authentication before allowing the user, other applications, and/or one or more system functions of the computer system to access content of the hidden application. For example, one or more system functions are unable to access the content of the hidden application such that, upon execution of the one or more system functions, the results of the one or more system functions do not include results that use and/or are based on the hidden application. Preventing one or more system functions of the computer systems from accessing content associated with hidden applications improves the privacy and security of the computer system by allowing the user to hide applications that include sensitive data and/or content that the user does not want to be used in certain system functions or otherwise displayed by the computer system without additional authentication from the user.

The computer system detects (14002), via the one or more input devices, one or more inputs (e.g., one or more tap inputs, tap and hold inputs, air tap gestures, air pinch gestures, and/or other types of user inputs) corresponding to a request to perform a system operation for which content corresponding to a first application is contextually relevant; For example, as described with reference to FIG. 10C, the device 100 detects the request 1006 to a virtual assistant to return a latest communication from Max.

In response to detecting the one or more inputs corresponding to a request to perform the system operation, the computer system outputs (14004), via the one or more output generation components, a result of the system operation, including: in accordance with a determination that the first application is in a hidden state, outputting (14006) (e.g., displaying visual content, playing audio content, and/or outputting tactile output), via the one or more output generation components, a result of the system operation using content from one or more sources other than the first application without using the content corresponding to the first application (e.g., restricting access to the content corresponding to the first application for the system operation). For example, as described with reference to FIGS. 10C-10D, the message 1007 is from the hidden messaging application 1 and is not used by the virtual assistant in returning the results to the request 1006.

In response to detecting the one or more inputs corresponding to a request to perform the system operation, the computer system outputs (14004), via the one or more output generation components, a result of the system operation, including: in accordance with a determination that the first application is in an unhidden state, outputting (14008) (e.g., displaying visual content, playing audio content, and/or outputting tactile output), via the one or more output generation components, a result of the system operation using content from the one or more sources other than the first application and also using the content corresponding to the first application (e.g., allowing access to the content corresponding to the first application for the system operation). For example, as described with reference to FIGS. 10C-10D, the email 1011 is from an email application that is not hidden and the email 1011 is used by the virtual assistant in returning the results to the request 1006.

In some embodiments, the computer system includes a display component, such as a touch-sensitive display. In some embodiments, the computer system is communicatively coupled to a display device (e.g., via a wired and/or wireless connection).

For example, the first application may be a messaging application, a photos application, a storage application, and/or other type of application. As an example, the content corresponding to the first application may include one or more files, such as audio files, image/video files, text files, and/or one or more other types of files.

In some embodiments, the system operation corresponds to a content search, a recommendation (e.g., corresponding to one or more contacts of a user), and/or another type of system operation. As an example, the system operation may be an auto-complete operation and/or an auto-correct operation.

In some embodiments, content corresponding to a respective application is contextually relevant to a system operation if performing the system operation includes (or would include, if criteria discussed herein are met) displaying, referencing, or otherwise using the content corresponding to the respective application. For example, content that matches a search query is considered to be contextually relevant to a search operation. As another example, content that completes or corrects a typed term or phrase is considered to be contextually relevant to a recommendation operation. As another example, media content is considered to be contextually relevant to a media library and/or playback interface and corresponding operations. In a particular example, the first application may be an address book application with a list of contacts and corresponding contact information. If one of the contacts is named “John Smith” then the contact name may be contextually relevant to an auto-complete operation for the term “John S”. Additionally, the name “John Smith” may be contextually relevant to a search query for “John” or “Smith”. In another scenario, the system operation is a share operation to share some data (e.g., an image or file) stored on the computer system. The list of contacts may be contextually relevant to the share operation as options for which the data may be shared. In these examples, the contacts and corresponding contact information are not used in the system operation if the address book application is in a hidden state. Other examples include using information about (and/or from) the respective application (e.g., including user interface controls involving functions of the respective application) in search results, in application and/or content suggestions, on a home menu user interface, in a control user interface, in a response from a virtual assistant to a user's query, in data collection and/or a learning model, within a user interface of a different application, and/or other context). In some embodiments, the contextual relevance of application content is based on the system operation requested to be performed; for example, content from the first application that constitutes a relevant search result in response to a first search query in some circumstances does not constitute a relevant search result in response to a second search query that is different from the first search query.

In some embodiments, in accordance with a determination that second content corresponding to a second application is contextually relevant to the system operation, the result of the system operation further includes (14010): in accordance with a determination that the second application is in the hidden state, the result is outputted without using the second content corresponding to the second application; and in accordance with a determination that the second application is in the unhidden state, the result is outputted using the second content corresponding to the second application. For example, as described with reference to FIG. 10C, in response to the request 1006, the device 100 performs a system operation, including accessing content from at least three applications of the device 100 to determine a latest communication from Max. In some embodiments, for each application that has (or may have) content that is contextually relevant to the system operation, a determination is made as to whether the application is in the hidden state, and the content is included or excluded in the system operation accordingly. Preventing one or more system functions of the computer systems from accessing content associated with a second hidden application improves the privacy and security of the computer system by allowing the user to hide applications that include sensitive data and/or content that the user does not want to be used in certain system functions or otherwise displayed by the computer system without additional authentication from the user.

In some embodiments, outputting the result of the system operation further includes (14012), in accordance with a determination that the first application is in a locked state, the result is outputted using the content corresponding to the first application. For example, as described with reference to FIG. 7I, the messenger application corresponding to application icon 424 is locked. In some embodiments, content from the locked messenger application is available for the system operation described with reference to FIG. 10C. In some embodiments, the result of the system operation uses content for a locked application in accordance with a determination that a user of the computer system has provided valid authentication information. In some embodiments, the result of the system operation is informed by the content for a locked application, but does not include information for the locked application. Enabling one or more system functions to access a locked application while preventing the system functions from accessing a hidden application provides additional control options for the user to set different levels of security to different applications.

In some embodiments, outputting the result of the system operation further includes (14014), in accordance with a determination that the first application is in a locked state, the result is outputted from one or more sources other than the first application without using the content corresponding to the first application. For example, as described with reference to FIG. 7I, the messenger application corresponding to application icon 424 is locked. In some embodiments, content from the locked messenger application is not available for the system operation described with reference to FIG. 10C. For example, if the first application is in the locked state or if the first application is in the hidden state, the computer system does not access the content for the first application and provides a result based on one or more other sources (e.g., one or more other applications that are not in the hidden state or the locked state). Preventing one or more system functions from accessing a locked application and its content, improves the privacy and security of the locked applications by limiting the tracking and usage of the locked application and its content by system functions of the computer system.

In some embodiments, the computer system causes display (14016), via the one or more output generation components, of an icon for the first application on a home screen user interface, wherein: in accordance with a determination that the first application is in the hidden state, the computer system causes the icon for the first application to be displayed with a first set of one or more attributes; and in accordance with a determination that the first application is in the unhidden state, the computer system causes the icon for the first application to be displayed with a second set of one or more attributes that is different than the first set of one or more attributes. For example, as described with reference to FIG. 10J, the hidden application icon 1040 replaces the messenger application icon such that the application cannot be identified while hidden based on its icon on the home screen user interface 492. In some embodiments, causing the icon to be displayed with a first set of one or more attributes comprises causing a default (e.g., generic and/or nondescript) icon to be displayed for the first application. In some embodiments, in accordance with the determination that the first application is in the hidden state, a version of the icon that does not indicate the first application is displayed. In some embodiments, respective icons for applications in the hidden state are displayed with a same (e.g., generic) set of attributes. For example, a same generic icon is displayed for each hidden application. In some embodiments, in accordance with the determination that the first application is in the unhidden state, a version of the icon that indicates the identity of the first application is displayed. In some embodiments, in accordance with a determination that the first application is in a locked state, causing the icon to be displayed with a third set of one or more attributes that is different than the first set of one or more attributes and the second set of one or more attributes. Displaying an application icon with visual features, such that the application icon does not provide identifying features for the application, while the application is hidden improves the privacy and security of the hidden applications such that a user is unable to identify the hidden applications without first providing authentication.

An example home screen user interface includes icons for navigating to a plurality of applications that are executed by the device 100. In some embodiments, a user is enabled to interact with the device 100 using one or more gestures, including touch inputs. For example, a tap input or other selection input on a respective application icon causes the respective application to launch, or otherwise open a user interface for the respective application, on the display area of device 100.

In some embodiments, the computer system causes display (14018), via the one or more output generation components, of a second icon for a third application on the home screen user interface, wherein: in accordance with a determination that the third application is in the hidden state, the computer system causes the second icon to be displayed with the first set of one or more attributes; and in accordance with a determination that the third application is in the unhidden state, the computer system causes the second icon to be displayed with a third set of one or more attributes that is different than the first set of one or more attributes and the second set of one or more attributes. For example, in FIG. 10A, the hidden application icon 1002 has the same visual appearance as the hidden application icon 1003. In some embodiments, respective icons for locked applications are displayed with the same set of attributes. In some embodiments, a same icon is displayed for all locked applications on the computer system. In some embodiments, respective icons for applications in the hidden state are displayed with a same (e.g., generic) set of attributes. For example, a same generic icon is displayed for each hidden application. Displaying a plurality of application icons with a same set of visual features, such that the plurality if application icons do not provide identifying features for the respective applications, while the plurality of application are hidden improves the privacy and security of the hidden applications such that a user is unable to identify the hidden applications without first providing authentication.

In some embodiments, while displaying, via the one or more output generation components, the icon for the first application on the home screen user interface, the computer system detects (14020), via the one or more input devices, one or more user inputs (e.g., one or more tap inputs, tap and hold inputs, air tap gestures, air pinch gestures, and/or other types of user inputs) directed to the icon for the first application; in response to detecting the one or more user inputs directed to the icon for the first application, the computer system causes display, via the one or more output generation components, of multiple selectable options for setting an appearance of the icon for the first application while the first application is in the hidden state. In some embodiments, the computer system detects, via the one or more input devices, one or more inputs corresponding to selection of a selectable option of the multiple selectable options for setting an appearance of the icon for the first application to the first set of one or more attributes (e.g., a tap input, a tap and hold input, an air tap gesture, an air pinch gesture, and/or another type of user input); and in response to detecting the user selection of the selectable option, the computer system assigns the first set of one or more attributes to the icon for the first application (e.g., and displaying the icon for the first application on the home screen user interface). For example, the platter 1034 includes a plurality of user-selectable hidden icon types, as illustrated in FIG. 10H. In some embodiments, the one or more user inputs include a first user input that causes the computer system to display a quick actions menu, and in response to detecting a second user input corresponding to selection of an option to require authentication for the first application, the computer system displays a second menu that includes an option to hide the application. In some embodiments, the one or more user inputs includes a third user input selecting the option to hide the application, and in response to the third user input selecting the option to hide the application, the computer system displays the multiple selectable options for setting an appearance of the icon for the first application while the first application is in the hidden state. In some embodiments, the multiple selectable options are displayed in response to detecting a user request to activate a hidden state for the first application. In some embodiments, the multiple selectable options are displayed in response to detecting a user request to adjust settings for the first application. In some embodiments, the multiple selectable options are displayed in a settings user interface for the first application. In some embodiments, the multiple selectable options are displayed in a settings user interface for hidden applications. In some embodiments, the multiple selectable options comprise a set of selectable icon options. For example, the set of selectable icon options includes respective icons for each letter in the alphabet, numerals 0 through 9, and/or other symbols and/or characters. Providing the user with options for selecting a respective hidden icon to assign to an application icon in order to hide the identity of the hidden application, provides additional control options for the user that enables the user to distinguish between different hidden application icons without displaying identifiers for the application icons, thereby improving the privacy and security of the applications.

In some embodiments, in response to detecting, via the one or more input devices, a user input (e.g., a swipe gesture, a tap input, an air pinch input, and/or another type of user input) corresponding to a request to display the home screen user interface, the computer system displays (14022) the home screen user interface, including displaying the icon for the first application on the home screen user interface, wherein: in accordance with a determination that the first application is in a locked state (e.g., and is not in the hidden state), the computer system causes the icon for the first application to be displayed, via the one or more output generation components, on the home screen user interface with the second set of one or more attributes; and in accordance with a determination that the first application is in an unlocked state (e.g., is not in the hidden state), the computer system causes the icon for the first application to be displayed, via the one or more output generation components, on the home screen user interface with the second set of one or more attributes. For example, in some embodiments, the unlocked application icon 424 (e.g., in FIG. 5A), the locked application icon 424 (e.g., in FIG. 7I), and the unhidden application icon are displayed with the same visual appearance. In some embodiments, the icon for the first application is displayed in a same manner while the first application is in the unhidden state, the locked state, or the unlocked state. For example, a first icon is displayed for the first application while the first application is in the hidden state, and a second icon is displayed for the first application while the first application is in the unhidden state. Displaying locked application icons with a same set of visual features as hidden application icons improves the privacy and security of the hidden applications such that a user is unable to identify the locked applications and/or the hidden applications from their respective application icons without first providing authentication.

In some embodiments, in response to detecting, via the one or more user input devices, a user input (e.g., a swipe gesture, a tap input, an air pinch input, and/or another type of user input) corresponding to a request to display the home screen user interface, the computer system displays (14024), via the one or more output generation components, the home screen user interface, including: in accordance with a determination that the first application is in the unhidden state, displaying, via the one or more output generation components, an icon for the first application on a home screen user interface; and in accordance with a determination that the first application is in the hidden state, forgoing displaying the icon for the first application on the home screen user interface. For example, in some embodiments, the hidden application icon for the application 1068 is not displayed on the home screen user interface, as described with reference to FIGS. 10Q-10R. In some embodiments, icons for applications in the hidden state are not included on a home screen interface (and/or a user interface having a listing of applications installed on the computer system). In some embodiments, while causing display of an icon for the first application and in response to a user request to activate the hidden state for the first application, ceasing to cause display an icon for the first application. Removing application icons for hidden applications from the home screen user interface prevents users from easily viewing the application icons on the home screen user interface, thereby improving the privacy and security of the hidden applications.

In some embodiments, while the first application is in the hidden state, in response to detecting, via the one or more input devices, a user input (e.g., a swipe input, a tap input, a tap and hold input, an air tap gesture, an air pinch gesture, and/or another type of user input) corresponding to a request to display a system user interface (e.g., control user interface 498, home screen user interface 492, the application library user interface 497, or another system user interface), the computer system displays (14026), via the one or more output generation components, the system user interface, including displaying a control element. In some embodiments, the control elements is displayed as a control in the control user interface 498. In some embodiments, the control element is displayed as the hidden category 1080-1 (e.g., in FIG. 10V) in the application library user interface 497. In some embodiments, the control element is displayed as an option in the quick action menu for the application icon (e.g., displayed in the home screen user interface 497). In some embodiments, the computer system detects, via the one or more input devices, one or more inputs (e.g., one or more tap inputs, tap and hold inputs, air tap gestures, air pinch gestures, and/or other types of user inputs) corresponding to selection of the control element; and in response to detecting the one or more inputs corresponding to selection of the control element, the computer system displays, via the one or more output generation components, a user interface element corresponding to the first application. For example, as described with reference to FIG. 12B, the device 100 displays a control 1206 to unhide one or more hidden applications. In some embodiments, in response to detecting the user selection, the icon for the first application is displayed. In some embodiments, in response to detecting the user selection, a user interface and/or widget for the first application is displayed. In some embodiments, the control element is displayed on a home screen interface. In some embodiments, the control element is displayed in a system settings user interface. The settings user interface may include various settings and parameters associated with the computer system and/or devices communicatively coupled with the computer system (e.g., settings and parameters associated with the one or more wearable devices). For example, the settings user interface includes various settings and parameters that may be adjusted by a user. In some embodiments, the user interface element for the first application is caused to be displayed in accordance with (e.g., in response to) authenticating a user of the computer system. In some embodiments, in response to detecting the user selection and in accordance with a determination that received authentication information is inconsistent with authorized authentication information, the user interface element is not caused to be displayed. Updating display of one or more hidden application icons to display the application icons (e.g., that indicate the respective application) after authenticating the user allows the user to view and access the hidden application icons while preventing unauthenticated users from viewing and accessing the hidden application icons, thereby improving the privacy and security of the applications.

In some embodiments, in response to detecting the user selection of the control element, the computer system displays (14028), via the one or more output generation components, respective user interface elements corresponding to a set of hidden applications. For example, as described with reference to FIGS. 12B-12C, application icon 428 and application icon 1210 are unhidden and displayed in the home screen user interface 492 in response to the user input 1208 directed to the control 1206 to unhide one or more applications. In some embodiments, the control element is configured to cause display of user interface elements (e.g., icons or other representations) for a plurality of hidden applications (or, optionally, all hidden applications) at the computer system. In some embodiments, the respective user interface elements are caused to be displayed in response to detecting the user selection and in accordance with (e.g., in response to) authenticating a user of the computer system. In some embodiments, in response to detecting the user selection and in accordance with a determination that received authentication information is inconsistent with authorized authentication information, the respective user interface elements are not caused to be displayed. Displaying application icons for a plurality of hidden applications in response to detecting user selection of a control to unhide the hidden applications reduces the number of user inputs required to view the unhidden applications by enabling the user to select one control to view a plurality of application icons that were hidden.

In some embodiments, the computer system detects (14030), via the one or more input devices, one or more inputs (e.g., one or more tap inputs, tap and hold inputs, air tap gestures, air pinch gestures, and/or other types of user inputs) corresponding to selection of a second control element; and in response to detecting the one or more inputs corresponding to selection of the second control element, the computer system deactivates the hidden state for a set of applications, wherein deactivating the hidden state for the set of applications comprises: including one or more icons for the set of applications in a first view of a user interface of the computer system when the first view of the user interface is displayed, and including one or more icons for the set of applications in a second view of a user interface of the computer system when the second view of the user interface is displayed, wherein the second view of the user interface is different from the first view of the user interface. For example, as described with reference to FIG. 12C, one or more hidden application icons are displayed as respective unhidden application icons on one or more other pages of the home screen user interface 492. In some embodiments, the two or more views correspond to a home screen user interface. In some embodiments, a plurality of views (e.g., also referred to as pages) for the home screen user interface is available. For example, a user is enabled to swipe or otherwise navigate between the plurality of views, wherein each view of the home screen user interface includes different application icons for different applications. In some embodiments, the application icons are different sizes, such as an application widget that displays information for the respective application, wherein the application widget is larger than the application icons. In some embodiments, the two or more views correspond to a folder or library. In some embodiments, a first icon for a first hidden application is displayed in a first view of the home screen user interface and a second icon for a second hidden application is displayed in a second view of the home screen user interface. In some embodiments, the respective icon for a respective hidden application is displayed on the view of the home screen on which the application icon for the respective application (e.g., while the respective application is not hidden) is displayed. Displaying application icons for a plurality of hidden applications across multiple user interfaces, including multiple pages of the home screen user interface, in response to detecting user selection of a control to unhide the hidden applications reduces the number of user inputs required to view the unhidden applications by enabling the user to select one control to view a plurality of application icons that were hidden across multiple user interface.

In some embodiments, while the first application is in the hidden state, the computer system detects (14032), via the one or more input devices, one or more inputs (e.g., one or more tap inputs, tap and hold inputs, air tap gestures, air pinch gestures, and/or other types of user inputs) corresponding to a request to unhide the first application; and in response to detecting the one or more inputs corresponding to a request to unhide the first application, the computer system initiates a process to obtain authentication information from a user of the computer system. In some embodiments, the computer system optionally requests (e.g., by outputting an audio, visual, and/or tactile prompt for) authentication information from a user of the computer system. In some embodiments, after initiating the process to obtain the authentication information, the computer system obtains, via one or more input devices, authentication information from a user of the computer system. In some embodiments, the authentication information is obtained via one or more user inputs, such as via a passcode entry and/or placement of a finger on a fingerprint scanner. In some embodiments, the authentication information is obtained automatically without requiring explicit user inputs (e.g., by performing facial scanning or other biometric authentication that does not require explicit user input). In some embodiments, in response to obtaining, via the one or more input devices (e.g., a keyboard, touch-sensitive surface, and/or one or more biometric sensors), the authentication information: in accordance with a determination that the received authentication information is consistent with authorized authentication information, the computer system deactivates the hidden state for the first application; and in accordance with a determination that the received authentication information is inconsistent with the authorized authentication information, the computer system maintains the hidden state for the first application. For example, as described with reference to FIG. 12F, the session region 502-3 indicates that the device 100 performs the authentication process before enabling the user to unhide the one or more applications. In some embodiments, deactivating the hidden state for the first application comprises setting the first application to the unhidden state. In some embodiments, requesting the authentication information from the user of the computer system comprises presenting an authentication user interface (e.g., including instructions for the user to input the authentication information). In some embodiments, the authentication information comprises biometric information from a user of the computer system. In some embodiments, the biometric information comprises information about unique biological traits of the user (e.g., a fingerprint scan, a voice recording, an eye (e.g., iris and/or retina) scan, a facial scan, and/or other types of biometric authentication). In some embodiments, the computer system includes a fingerprint reader, a voice analyzer, a facial scanner, a retina scanner, and/or other biometric sensor or component. In some embodiments, the request for authentication information is a request for multimodal authentication involving two or more types of authentication information, such as two types of biometric information and/or a type of non-biometric authentication information. Requiring the user to authenticate before displaying application icons for a plurality of hidden applications, in response to detecting user selection of a control to unhide the hidden applications, improves the privacy and security of the hidden applications by authenticating the user before displaying the application icons.

In some embodiments, deactivating the hidden state for the first application in accordance with the determination that the received authentication information is consistent with the authorized authentication information comprises (14034) temporarily deactivating the hidden state until respective criteria are met (and, optionally, activating or re-activating the hidden state again when the respective criteria are no longer met). For example, as described with reference to FIG. 12F, the device 100 displays menu 1211 with options for unhiding the applications for a selected length of time. For example, the hidden state is deactivated for a preset amount of time (e.g., 1 minute, 5 minutes, 10 minutes, or other amount of time). In some embodiments, deactivating the hidden state for the first application comprises temporarily setting the first application to the unhidden state (e.g., while a set of unlock criteria are met). For example, the first application is maintained in the unhidden state for a preset amount of time, until the first application is closed, minimized, or otherwise deactivated, until the computer system is powered down, locked, or otherwise disabled, or whichever of the preceding occurs first. In some embodiments, the request to unhide the first application comprises selection of a user interface control (e.g., displayed in a system setting user interface). In some embodiments, the user interface control is a control to unhide all hidden applications on the computer system. Automatically displaying the application icons for a plurality of hidden applications for a temporary amount of time, in response to detecting user selection of a control to unhide the hidden applications, before redisplaying the application icons as hidden application icons reduces the number of user inputs required to re-hide the application icons and improves the privacy and security of the hidden applications by hiding the applications after the temporary amount of time without requiring additional user inputs.

In some embodiments, temporarily deactivating the hidden state comprises (14036) deactivating the hidden state until one or more user-specified criteria are met. For example, as described with reference to FIG. 12F, the device 100 displays menu 1211 with options for unhiding the applications until the device 100 leaves a location (leave home) or satisfies other context-based criteria. For example, the one or more user-specified criteria may include an amount of time (e.g., 30 seconds, 1 minute, 5 minutes, 30 minutes, 1 hour, 1 day, or one week, or other amount of time), a location-based criterion (e.g., while within a particular geofence, at a particular geolocation, until entering a particular geolocation, and/or a computer system state criterion (e.g., until the computer system is locked or powered down). Temporarily displaying application icons for hidden applications in an unhidden state, such as until a context of the computer system is met, before redisplaying the application icons as hidden application icons reduces the number of user inputs required to re-hide the application icons and improves the privacy and security of the hidden applications by re-hiding the applications without requiring additional user inputs.

In some embodiments, while the hidden state is temporarily deactivated for the first application, the computer system detects (14038), via the one or more input devices, one or more inputs (e.g., one or more tap inputs, tap and hold inputs, air tap gestures, air pinch gestures, and/or other types of user inputs) corresponding to a second request to perform a second system operation for which content corresponding to the first application is contextually relevant; and in response to detecting the one or more inputs corresponding to a request to perform the second system operation, outputs, via the one or more output generation components, a result of the second system operation, including using content from one or more sources other than the first application without using the content corresponding to the first application. In some embodiments, even while the application icons are unhidden, as described with reference to FIGS. 12A-12C, the one or more system functions do not have access to the content of the hidden applications (e.g., as described with reference to FIGS. 10A-10C. In some embodiments, temporarily unhiding the first application causes temporary display of an icon for the first application, but content of the first application continues to be excluded from system operations. In some embodiments, in response to activation of a first control element, the first application is unhidden for a first set of actions (e.g., displaying an icon and/or widget for the first application), and in response to activation of a second control element, the first application is unhidden for a second set of actions, where the second set of actions are a superset of the first set of actions. Preventing one or more system functions from accessing hidden applications, even while the application icons for the hidden applications are displayed in the unhidden state, improves the privacy and security of the data and content of the applications while providing improved visual feedback by temporarily displaying application icons for the hidden applications.

In some embodiments, while the first application is in the hidden state, the computer system detects (14040), via the one or more input devices, one or more inputs (e.g., one or more tap inputs, tap and hold inputs, air tap gestures, air pinch gestures, and/or other types of user inputs) corresponding to selection of a hidden applications folder; and in response to detecting the one or more inputs corresponding to selection of the hidden applications folder, causes display, via the one or more output generation components, of a hidden applications user interface that includes a set of representations (e.g., icons or other user interface elements) for respective hidden applications on the computer system, the set of representations including a representation for the first application. For example, as described with reference to FIGS. 10N-10Q, the application folder 1005 is hidden as application folder 1066. In another example, the hidden category 1080-1 corresponds to a hidden application folder displayed in the application library user interface. In some embodiments, the hidden applications folder is displayed in an application library user interface. In some embodiments, the set of representations for the respective hidden applications on the computer system are caused to be displayed in response to the user selection of the hidden applications folder in accordance with the user being authenticated with the computer system. In some embodiments, the hidden applications folder comprises a locked folder. For example, the hidden applications folder is in a locked state that requires authentication of a user in order to be accessed. Displaying application icons for a plurality of hidden applications in response to detecting user selection of a folder of hidden applications reduces the number of user inputs required to view the unhidden applications by enabling the user to select one folder to view a plurality of application icons that were hidden.

In some embodiments, the computer system causes (14042) display of a same representation of the hidden applications folder regardless of whether any applications on the computer system are in the hidden state. For example, as described with reference to FIG. 10V, the hidden category 1080-1 is displayed in the application library user interface whether or not one or more applications of the device 100 are hidden. In some embodiments, the hidden applications folder is displayed with a same appearance regardless of whether any applications are hidden and regardless of a number of hidden applications. In some embodiments, the hidden applications folder is displayed with a same icon regard of whether it is currently empty whereas other folders on the computer system have respective first appearances when the other folders are empty and respective second appearances when the other folders are not empty. Displaying a representation of a hidden folder in a same manner whether or not the hidden folder includes one or more hidden applications prevents unauthorized users from deducing whether or not applications of the computer system are hidden, while providing an authorized user easy access to the hidden applications, if any.

In some embodiments, the hidden applications user interface is displayed (14044) in response to detecting, via the one or more input devices, one or more inputs (e.g., one or more tap inputs, tap and hold inputs, air tap gestures, air pinch gestures, and/or other types of user inputs) corresponding to selection of the hidden applications folder and in accordance with a determination that a user of the computer system is authenticated. In some embodiments, in response to detecting the one or more inputs corresponding to selection of the hidden applications folder and in accordance with a determination that the user of the computer system is not authenticated, the computer system initiates a process for obtaining authentication information. In some embodiments, the computer system optionally requests (e.g., by outputting an audio, visual, and/or tactile prompt for) authentication information from the user. In some embodiments, the computer system obtains, via the one or more input devices, authentication information. In some embodiments, the authentication information is obtained via one or more user inputs, such as via a passcode entry and/or placement of a finger on a fingerprint scanner. In some embodiments, the authentication information is obtained automatically without requiring explicit user inputs (e.g., by performing facial scanning or other biometric authentication that does not require explicit user input). In some embodiments, in response to obtaining, via the one or more input devices (e.g., a keyboard, touch-sensitive surface, and/or one or more biometric sensors), the authentication information, the computer system: in accordance with a determination that the received authentication information is consistent with (or matches) authorized authentication information, displays, via the one or more display generation components, the hidden applications user interface; and in accordance with a determination that the received authentication information is inconsistent with the authorized authentication information, forgoes displaying the hidden applications user interface in response to the user selection of the hidden applications folder. In some embodiments, the authentication information comprises biometric information from a user of the computer system. For example, as described with reference to FIGS. 10V-10X, the device 100 performs an authentication process before revealing the application icons in the hidden category 1080-2. Requiring the user to authenticate before displaying application icons for a plurality of hidden applications in a hidden folder, in response to detecting user selection of the hidden folder, improves the privacy and security of the hidden applications by authenticating the user before displaying the application icons.

In some embodiments, while displaying the hidden applications user interface, the computer system detects (14046), via the one or more input devices, one or more inputs (e.g., one or more tap inputs, tap and hold inputs, air tap gestures, air pinch gestures, and/or other types of user inputs) corresponding to selection of a first representation of the set of representations, the first representation corresponding to a fourth application; and in response to detecting the one or more inputs corresponding to selection of the first representation, displays, via the one or more output generation components, the fourth application without obtaining additional authentication information from the user. For example, as described with reference to FIGS. 10X-10Y, after the messenger application icon is displayed within the hidden category 1080-2, no additional authentication is required for displaying the application user interface 510-1 for the messenger application. In another example, as described with reference to FIG. 10S, after the application icons are displayed in the expanded view 1074 of the hidden application folder, in response to one or more user inputs corresponding to requests to open and/or interact with the application icons, the device 100 performs one or more operations without requiring additional authentication from the user. In some embodiments, in accordance with the determination that the received authentication information is consistent with authorized authentication information, the user is authenticated for each of the respective hidden applications. In some embodiments, in accordance with the determination that the received authentication information is consistent with authorized authentication information, the user is authenticated for a preset amount of time (e.g., 1 minute, 5 minutes, 10 minutes, or other amount of time) for access to the hidden applications folder and the applications represented within the hidden applications folder. Providing the user with access to one or more hidden applications that have been temporarily unhidden within the hidden applications folder, after authenticating the user to view the hidden applications folder, without requiring the user to provide additional authentication reduces the number of inputs required for the user to access the hidden applications.

In some embodiments, the computer system detects (14048), via the one or more input devices, one or more inputs (e.g., one or more tap inputs, tap and hold inputs, air tap gestures, air pinch gestures, and/or other types of user inputs) corresponding to a first request to close the hidden applications user interface; and in response to detecting the one or more inputs corresponding to the first user request to close the hidden applications user interface, closes the hidden applications user interface and sets the hidden applications folder to a locked state. For example, in FIGS. 10T-1OU, after the expanded view 1074 of the application folder is minimized, the application folder is redisplayed as hidden, including hiding the one or more application icons within the hidden application folder, and requires additional authentication to reopen the application folder into the expanded view 1074. In some embodiments, closing the hidden applications user interface comprises ceasing to display the contents of the hidden applications folder (e.g., the set of representations for the respective hidden applications on the computer system). In some embodiments, setting the hidden applications folder to the locked state comprises requiring authentication of the user for a subsequent activation of the hidden applications folder. Automatically re-hiding the one or more applications in the hidden applications folder in response to the user closing the hidden applications folder, improves the privacy and security of the hidden applications without requiring the user to individually re-hide each application in the hidden applications folder.

In some embodiments, while displaying the hidden applications user interface, the computer system detects (14050), via the one or more input devices, one or more inputs (e.g., one or more drag inputs, tap inputs, tap and hold inputs, air tap gestures, air pinch gestures, and/or other types of user inputs) corresponding to a request to move a representation of a fifth application into the hidden applications user interface, the fifth application being in the unhidden state; and in response to detecting the one or more inputs corresponding to a request to move the representation of the fifth application into the hidden applications user interface, the computer system adds the representation of the fifth application to the hidden applications user interface and sets the fifth application to the hidden state. For example, as described with reference to FIGS. 10Q-10R, the user input 1070 drags the application icon 1068 into the hidden folder 1066. In some embodiments, the first user input comprises a drag-and-drop input. In some embodiments, the first user input corresponds to a move operation. In some embodiments, the first user input corresponds to a cut-and-paste operation. As an example, application icons may be dragged from a home screen user interface into the hidden applications user interface, and in response to being dropped into the hidden applications user interface, the corresponding application is set to the hidden state. Adding a respective application into a hidden applications folder by dragging the respective application into the hidden applications folder provides additional control options for the user to hide the respective application without displaying controls that clutter the user interface.

In some embodiments, detecting the one or more inputs corresponding to the request to perform a system operation comprises (14052) detecting one or more inputs corresponding to a search query for performing a search operation based on the search query; and outputting the result of the system operation in response to detecting the one or more inputs corresponding to the request to perform a system operation comprises outputting search results for the search operation based on the search query, wherein: in accordance with a determination that the first application is in the hidden state, the search results for the search operation do not include the content corresponding to the first application; and in accordance with a determination that the first application is in the unhidden state, the search results for the search operation include the content corresponding to the first application (e.g., in accordance with a determination that the content corresponding to the first application is relevant to the search query). For example, as described with reference to FIGS. 10A-10D, in some embodiments, the system function is a search operation. For example, the system operation comprises a search for content stored on the computer system. In some embodiments, the system operation comprises a search of content associated with a user of the computer system. In some embodiments, the search operation is performed in response to receiving a user query (e.g., via a web browser, a search application, a virtual assistant, an operating system, or other component). In some embodiments, the search operation is performed by a second application on the computer system. Preventing a search operation from accessing content from the hidden applications when generating the search results improves the privacy and security of the hidden applications such that results do not include private information from the hidden applications.

In some embodiments, detecting the one or more inputs corresponding to the request to perform a system operation comprises (14054) detecting one or more inputs corresponding to a request (e.g., a voice command and/or text input) directed to a digital assistant to perform a digital assistant operation (e.g., as described with reference to FIGS. 10A-10D); and outputting the result of the system operation in response to detecting the one or more inputs corresponding to the request to perform a system operation comprises outputting a result of the digital assistant operation, wherein: in accordance with a determination that the first application is in the hidden state, the result of the digital assistant operation is obtained by the digital assistant without using the content corresponding to the first application; and in accordance with a determination that the first application is in the unhidden state, the result of the digital assistant operation is obtained by the digital assistant using the content corresponding to the first application. A digital assistant (also referred to herein as a virtual assistant) may be an application, module, and/or software capable of analyzing the user instructions to identify tasks and provide assistance with completing the identified tasks. For example, a digital assistant may be an application, e.g., implemented in part on the computer system and in part on a set of server computers accessed by the computer system via a communications network such as the internet, that uses semantic analysis to analyze text, recognize terms and interpret the intended meaning. In some embodiments, processing by the digital assistant is performed at the computer system and/or at the set of server computers. In some embodiments, the digital assistant operation corresponds to a task being performed by a digital assistant. As discussed above, the task can be any type of action with which a digital assistant can provide assistance. Preventing a virtual assistant operation from accessing content from the hidden applications when performing one or more virtual assistant functions improves the privacy and security of the hidden applications such that the outputs of the virtual assistant do not include private information from the hidden applications.

In some embodiments, detecting the one or more inputs corresponding to the request to perform a system operation comprises (14056) detecting one or more inputs corresponding to a request for one or more recommendations. In some embodiments, the request for one or more recommendations is automatically generated in response to detecting one or more user inputs, for example in response to detecting a user input to view a search user interface, optionally before a search query is entered by the user. In some embodiments, outputting the result of the system operation in response to detecting the one or more inputs corresponding to the request to perform a system operation comprises outputting one or more recommendation results obtained by performing a recommendation operation, wherein: in accordance with a determination that the first application is in the hidden state, the recommendation results are obtained by the recommendation operation without using the content corresponding to the first application; and in accordance with a determination that the first application is in the unhidden state, the recommendation results are obtained by the recommendation operation using the content corresponding to the first application. For example, as described with reference to FIGS. 10A-10D, the system function is a recommendation operation. Preventing a recommendation operation from accessing content from the hidden applications when generating one or more recommendations improves the privacy and security of the hidden applications such that recommendations do not include private information from the hidden applications.

In some embodiments, the recommendation operation suggests content for a user of the computer system (e.g., media content, application content, or other types of content). In some embodiments, the recommendation operation comprises generating a recommendation for the user based on content from one or more applications. In some embodiments, the recommendation operation is performed in response to a query or other input from the user. In some embodiments, the recommendation operation generates a recommendation for the user based on a user profile, a user history, user content, and/or other types of information. In some embodiments, the recommendation operation is performed by a second application on the computer system.

In some embodiments, detecting the one or more inputs corresponding to the request to perform a system operation comprises (14058) detecting one or more inputs corresponding to a request to perform an operation using artificial intelligence and/or machine learning (e.g., one or more user inputs corresponding to inputting text, whereby autocompletion and/or autocorrection is performed using AI and/or machine learning (e.g., to include terms that appear in one or more applications are displayed as suggestions for autocompletion)). For example, in a journaling application, in some embodiments, in response to detecting a request for a journaling prompt, content from one or more other applications is suggested (e.g., using AI and/or machine learning). In some embodiments, outputting the result of the system operation in response to detecting the one or more inputs corresponding to the request to perform a system operation comprises outputting one or more results obtained using artificial intelligence and/or machine learning, wherein: in accordance with a determination that the first application is in the hidden state, the results are obtained using artificial intelligence and/or machine learning without using the content corresponding to the first application; and in accordance with a determination that the first application is in the unhidden state, the results are obtained using artificial intelligence and/or machine learning using the content corresponding to the first application (e.g., as described with reference to FIGS. 10A-10D). In some embodiments, the system operation corresponds to generating training data for an artificial intelligence (AI) and/or machine learning (ML) component, whereby the content from the first application is excluded from the training data in accordance with a determination that the first application is in the hidden state and the content from the first application is included in the training data in accordance with a determination that the first application is in the unhidden state). In some embodiments, the system operation corresponds to providing information (e.g., application content and other types of information) as an input to the AI and/or ML component. Preventing a machine learning operation, including during training of a machine learning model, from accessing content from the hidden applications when performing one or more functions that use machine learning improves the privacy and security of the hidden applications such that results of the machine learning operation do not include private information from the hidden applications.

In some embodiments, detecting the one or more inputs corresponding to the request to perform a system operation comprises (14060) detecting a request from a sixth application to access application content from the first application; and outputting the result of the system operation in response to detecting the one or more inputs corresponding to the request to perform a system operation comprises determining whether or not to provide the sixth application with access to the application content from the first application, wherein: in accordance with a determination that the first application is in the hidden state, the sixth application is not provided with access to the content corresponding to the first application; and in accordance with a determination that the first application is in the unhidden state, the sixth application is provided with access the content corresponding to the first application (e.g., as described with reference to FIGS. 10A-10D). For example, the sixth application may be an image viewer application and the content from the other applications may be images from other applications (e.g., the first application) (e.g., as described with reference to FIGS. 5A-5C). As another example, the sixth application may be a messaging application and the content from the other applications may be contact information for contacts associated with the other applications. In some embodiments, the sixth application is a social media application that requests access to content and/or data from the first application (e.g., messages, contacts, photos, and/or other content). Preventing a respective application from accessing content from the hidden applications improves the privacy and security of the hidden applications such that respective application cannot display or otherwise use private information from the hidden applications.

In some embodiments, detecting the one or more inputs corresponding to the request to perform a system operation comprises (14062) detecting one or more inputs to display a user interface (e.g., a request to display a share sheet user interface within a seventh application or another user interface) that includes one or more extensions corresponding to one or more applications; and outputting the result of the system operation in response to detecting the one or more inputs corresponding to the request to perform a system operation comprises displaying the user interface that includes the one or more extensions corresponding to the one or more applications, wherein: in accordance with a determination that the first application is in the hidden state, the one or more extensions do not include an extension for the first application; and in accordance with a determination that the first application is in the unhidden state, the one or more extensions include an extension for the first application (e.g., as described with reference to FIGS. 10A-10D). For example, the result of the system operation includes displaying one or more application extensions in a share sheet user interface (e.g., as described with reference to FIGS. 5A-5F) or other user interface. For example, the share sheet user interface, one or more application extensions corresponding to sharing content of a seventh application with one or more other applications (e.g., for a photos application, the one or more application extensions include other photos applications and/or messaging applications to share a photo in the photos application with the other photos applications and/or via the messaging applications (e.g., to send to another device)). In some embodiments, if a first messaging application is in the hidden state, the one or more application extensions include one or more extensions for other messaging applications without including an extension for the first messaging application. Similarly, in response to detecting a user input corresponding to a request to share a document (e.g., from the seventh application), the computer system displays the share sheet user interface that includes one or more application extensions for document viewing applications and/or messaging applications, if a first file browser application is in the hidden state, the one or more application extensions do not include an extension for the first file browser application (e.g., and/or extensions for other applications that are hidden). Preventing a respective application from accessing content from the hidden applications improves the privacy and security of the hidden applications such that the respective application cannot display or otherwise use private information from the hidden applications.

In some embodiments, the computer system displays (14064), via the one or more output generation components, a representation of the first application on a first user interface (e.g., an application icon and/or widget for the first application in the home screen user interface and/or in the widget user interface). In some embodiments, while displaying the representation of the first application in the first user interface, the computer system detects, via the one or more input devices, one or more inputs (e.g., one or more tap inputs, tap and hold inputs, air tap gestures, air pinch gestures, and/or other types of user inputs) directed to the representation of the first application; and in response to detecting the one or more inputs directed to the representation of the first application: in accordance with a determination that the second user input is a first type of input, the computer system displays, via the one or more output generation components, an option to activate the hidden state for the first application; and in accordance with a determination that the second user input is not the first type of input, the computer system forgoes displaying the option to activate the hidden state for the first application. For example, the device 100 displays the quick actions menu 712 based on the type of user input 710 directed to the application icon 424. For example, the first type of input may be a tap input, a tap-and-hold input, or other type of input. In some embodiments, in response to detecting the first user input and in accordance with the determination that the first user input is the first type of input, the computer system causes a context menu to be displayed for the first application, where the context menu includes the option to activate the hidden state. In some embodiments, the first user interface is a home screen user interface. In some embodiments, the first user interface is an application library interface. In some embodiments, the option to activate the hidden state for the first application is an option to toggle a visible state of the first application. In some embodiments, the option to activate the hidden state for the first application is displayed in response to the first user input, in accordance with the determination that the first user input is the first type of input, and in accordance with a determination that the first application is in the unhidden (e.g., visible) state. Displaying a menu that includes an option to hide and/or unhide a respective application provides additional control options for the user.

In some embodiments, the computer system detects (14066), via the one or more input devices, one or more inputs (e.g., one or more tap inputs, tap and hold inputs, air tap gestures, air pinch gestures, and/or other types of user inputs) corresponding to a request to activate a hidden state for an application folder that includes a plurality of applications; and in response to detecting the one or more inputs corresponding to the request to activate the hidden state for the application folder, activates the hidden state for the application folder (e.g., as described with reference to FIGS. 10N-10Q to hide the application folder 1005). In some embodiments, the user request to activate the hidden state for the application folder is a user request to hide the application folder. In some embodiments, the one or more inputs include a first input, such as a long press input, directed to an icon for the application folder and in response to detecting the first input, the computer system displays a context menu (e.g., quick actions menu 1053) that includes an option to require authentication for the application folder. In some embodiments, the one or more inputs include a second input, such as a tap input or other selection input, directed to the option to require authentication for the application folder and in response to the second input, the computer system displays a second menu that includes an option to hide the application folder (e.g., and/or require authentication for the application folder); and the one or more inputs includes a third input directed to the option to hide the application folder, wherein activating the hidden state for the application folder is performed in response to detecting the third input. In some embodiments, the application folder is a folder containing one or more activatable application icons. Enabling the user to hide an application folder that includes one or more applications improves the privacy and security of applications that are included in the folder of applications.

In some embodiments, in response to detecting the second user request, the computer system activates (14068) the hidden state for the plurality of applications within the application folder (e.g., activating the hidden state for some or all of the plurality of applications within the application folder). For example, as described with reference to FIGS. 10Q-10R, the application icon 1068 is hidden in response to the user input 1070 corresponding to a request to add the application icon 1068 to the hidden folder 1066. In some embodiments, in response to detecting the user request to activate the hidden state for application folder, the system activates the hidden state for any applications represented within the application folder, such that content of the applications within the application folder are not accessible to one or more system functions while they are in the hidden state, authentication is required to access the applications, including viewing the application icons representing the applications (e.g., in the home screen user interface and/or in the application library user interface). Enabling the user to hide an application folder that includes one or more applications, and automatically hiding the one or more applications within the folder in response to a user request to hide the application folder reduces the number of inputs required to hide multiple applications.

In some embodiments, while the application folder is in the hidden state, the computer system detects (14070), via the one or more input devices, one or more user inputs (e.g., one or more tap inputs, tap and hold inputs, air tap gestures, air pinch gestures, and/or other types of user inputs) corresponding to a request to move a representation of a seventh application into the application folder; and in response to detecting the third user input, the computer system sets the seventh application to the hidden state (e.g., and moves the representation of the seventh application into the application folder, including ceasing display of the representation of the seventh application at its previous position (e.g., moving the representation of the seventh application from its position in the home screen user interface to a position within the application folder). For example, in accordance with a determination that the seventh application is in the application folder that is in the hidden state, the representation of the seventh application is hidden). For example, as described with reference to FIGS. 10Q-10R, in response to detecting the user input 1070, the application icon 1068 is added to the hidden folder 1066. In some embodiments, the user input comprises a drag-and-drop input, for example, a first portion of the user input (e.g., a touch input or other selection input) is detected as being directed to the representation of the seventh application, and the user input is maintained such that a second portion of the user input moves (e.g., drags) across the user interface that displays the representation of the seventh application, whereby the representation of the seventh application is displayed as moving, in the user interface, in accordance with a magnitude and/or direction of the user input, and in response to detecting an end of the user input at a location corresponding to the application folder, the computer system adds (e.g., “drops”) the seventh application to the application folder. In some embodiments, the user input corresponds to a move operation (e.g., to move the seventh application into the application folder). In some embodiments, the user input corresponds to a cut-and-paste operation. As an example, application icons may be dragged from a home screen user interface into the application folder while the application folder is in the hidden state, and in response to being dropped into the application folder, the corresponding application is set to the hidden state. Adding a respective application to a hidden application folder and automatically updating the respective application to the hidden state improves the privacy and security of the respective application without requiring additional user input to explicitly hide the respective application.

In some embodiments, while the application folder is in the hidden state, the computer system detects (14072), via the one or more input devices, one or more inputs (e.g., one or more tap inputs, tap and hold inputs, air tap gestures, air pinch gestures, and/or other types of user inputs) corresponding to a request to move a representation of an eighth application out of the application folder; and in response to detecting the one or more inputs corresponding to a request to move the representation of the eighth application out of the application folder, sets the eighth application to the unhidden state (e.g., wherein one or more system functions have access to content corresponding to the eighth application while the eighth application is in the unhidden state, and the one or more system functions do not have access to the content corresponding to the eighth application while the eighth application is in the hidden state). In some embodiments, while the eighth application is in the unhidden state, the eighth application is not displayed in the hidden category of the application library user interface and an application icon for the eighth application is visible (e.g., not hidden) in one or more system user interface (e.g., the home screen user interface, the application library user interface, the settings user interface and/or other user interfaces). In some embodiments, the second user input comprises a drag-and-drop input, for example, a first portion of the user input (e.g., a touch input or other selection input) is detected as being directed to the representation of the eighth application while the representation of the eighth application is in the application folder, and the user input is maintained such that a second portion of the user input moves (e.g., drags) across the user interface (e.g., away from the displayed application folder), whereby the representation of the eighth application is displayed as moving, in the user interface, in accordance with a magnitude and/or direction of the user input, and in response to detecting an end of the user input at a location outside of the displayed application folder, the computer system removes the eighth application from the application folder and adds it to a location in the user interface (e.g., in the home screen user interface) corresponding to the end of the user input. In some embodiments, the second user input corresponds to a move operation (e.g., to move the eighth application out of the application folder). In some embodiments, the second user input corresponds to a cut-and-paste operation. In some embodiments, moving the representation of the eighth application out of the application folder comprises moving the representation of the eighth application to a home screen user interface. As an example, application icons may be dragged out of the application folder while the application folder is in the hidden state, and in response to being moved out of the application folder, the corresponding application is set to the unhidden state. For example, as described with reference to FIGS. 10S-10T, in response to detecting the user input 1076, the application icon 1068 is removed from the hidden folder 1066. Removing a respective application from a hidden application folder and automatically updating the respective application to the unhidden state once outside of the hidden application folder reduces the number of inputs required to move the respective application and set the respective application to the unhidden state.

In some embodiments, the computer system detects (14074), via the one or more input devices, a request to hide a respective application. In some embodiments, the request to hide the respective application includes detecting one or more user inputs corresponding to a request to activate a hidden state for an application folder that includes the respective application. In some embodiments, the request to hide the respective application includes detecting one or more user inputs selecting an option to hide the respective application that is displayed in a quick actions menu (e.g., in the home screen user interface and/or the application library user interface). In some embodiments, in response to detecting, via the one or more input devices, the request to hide the respective application, the computer system: hides the respective application; and hides one or more widgets corresponding to the application (e.g., one or more widgets that include information from the application or that are generated by the application). For example, the widget 711-3 corresponds to a hidden application icon 1040 such that content of the widget 711-3 is not displayed in the home screen user interface 492. Automatically setting one or more widgets that are associated with a hidden application to the hidden state, without requiring further user input, reduces the number of inputs required to hide content of the one or more widgets without requiring the user to manually set the one or more widgets to the hidden state.

In some embodiments, activating the hidden state for the widget comprises hiding (e.g., ceasing to display) the widget. In some embodiments, activating the hidden state for the widget comprises changing the appearance of the widget (e.g., to a default, generic, and/or non-descriptive appearance). In some embodiments, activating the hidden state for the widget comprises ceasing to display content of the corresponding application within the widget.

In some embodiments, in accordance with activating the hidden state for the first application, the computer system sets (14076) one or more settings for the first application to a private state; and while the first application is in the hidden state, the computer system requires the one or more settings to be in the private state. For example, as described with reference to FIG. 11F, one or more settings for the hidden application are not modifiable while the application is hidden. For example, settings for a hidden application are set to a private setting, and are restricted from being changed unless the application is unhidden. In some embodiments, the one or more settings include one or more privacy settings and/or security settings. Automatically causing one or more settings for an application to be turned off or otherwise set to private while the application is in the hidden state reduces the number of inputs required to configure settings for a hidden application and improves the privacy and security of the hidden application without requiring additional user inputs.

In some embodiments, the computer system detects (14078), via the one or more input devices, one or more inputs (e.g., one or more tap inputs, tap and hold inputs, air tap gestures, air pinch gestures, and/or other types of user inputs) corresponding to a request to display a multitasking user interface; and in response to detecting the one or more inputs corresponding to the request to display the multitasking user interface, displays, via the one or more output generation components, a multitasking user interface that includes one or more representations of applications that were recently open on the computer system, including: in accordance with a determination that the first application is in the unhidden state, the one or more representations include a first representation for the first application that includes an application identifier for the first application (e.g., and the one or more representations optionally include one or more representations for one or more applications other than the first application, wherein the respective representations for a respective application includes an identifier and/or content for the respective application if the respective application is in the unhidden state and does not include an identifier and/or content for the respective application if the respective application is in the hidden state); and in accordance with a determination that the first application is in the hidden state, the one or more representations include a second representation for the first application that does not include the application identifier for the first application, as described with reference to FIGS. 10Z-10AC. In some embodiments, the second representation is visually obscured to block any identifying information for the first application, including content and/or a preview of the application user interface for the first application (e.g., and the one or more representations optionally include one or more representations for one or more applications other than the first application, wherein the respective representations for a respective application includes an identifier and/or content for the respective application if the respective application is in the unhidden state and does not include an identifier and/or content for the respective application if the respective application is in the hidden state). For example, the recently open applications in computer system include application user interfaces that are displayed in the environment, and optionally applications that are open or were recently open that are not displayed in the environment (e.g., are minimized or hidden). In some embodiments, the third user input is a gesture on a home screen user interface. In some embodiments, the one or more representations are ordered (e.g., in a stack or other layout) based on a recency of use of the respective applications associated with the representations (e.g., a representation for the most recently used application is displayed at the top of the stack or other layout). In some embodiments, the representation of an application includes a preview of the application user interface of the application in accordance with a determination that the application is in the unhidden state. In some embodiments, the first application is in the hidden state and two or more applications are in the unhidden state, such that the representations of the two or more applications include respective application content (e.g., previews of the application user interfaces) while the second representation for the first application does not include a preview or other content for the first application. In some embodiments, the two or more applications are in the hidden state, optionally including the first application, and one or more applications are in the unhidden state, wherein the representations for the two or more applications in the hidden state do not include respective previews or other content from the respective two or more applications, and the representations for the one or more applications in the unhidden state include respective previews or other content from the respective one or more applications. Displaying a representation of a hidden application in a multitasking user interface without displaying an indication that identifies the hidden application enables the user to navigate, via the multitasking user interface, to the hidden application while maintaining privacy and security of the hidden application.

In some embodiments, an upward swipe gesture that starts from the bottom edge of the home screen user interface causes the computer system to display the first page of the home screen user interface or display the multitasking user interface (also referred to an application switcher user interface). In some embodiments, different criteria (e.g., criteria based on the speed, direction, duration, distance, intensity, and/or other characteristics) are used to determine whether to navigate to the first page of the home screen user interface or to the multitasking user interface in response to detecting the upward swipe gesture that starts from the bottom edge of the home screen user interface. For example, in some embodiments, a short flick and a slow and long swipe cause the multifunction device to navigate to the first page of the home screen user interface, while a slow and medium length swipe causes the multifunction device to display the multitasking user interface.

In some embodiments, the computer system detects (14080), via the one or more input devices, one or more inputs (e.g., one or more tap inputs, tap and hold inputs, air tap gestures, air pinch gestures, and/or other types of user inputs) corresponding to a request to display a multitasking user interface; and in response to detecting the one or more inputs corresponding to the request to display the multitasking user interface, the computer system displays, via the one or more output generation components, a multitasking user interface that includes one or more representations of applications that were recently open on the computer system, including: in accordance with a determination that the first application is in the unhidden state, the one or more representations include a first representation for the first application that includes an application identifier for the first application; and in accordance with a determination that the first application is in the hidden state, the one or more representations do not include a representation for the first application (e.g., the representation of the first application is removed from the multitasking view either immediately when the first application is closed or after some time threshold has elapsed since the first application was last viewed). In some embodiments, in accordance with the determination that the first application is in the hidden state and in accordance with a determination that the one or more criteria have not been met, the computer system maintains the second representation in the multitasking user interface. In some embodiments, the one or more criteria are based on one or more user preferences, hidden application settings, and/or other types of information. In some embodiments, removing the second representation comprises ceasing to display the second representation in the multitasking user interface. For example, as described with reference to FIG. 10AC, representations for applications that are in the hidden state are optionally not displayed in the multitasking user interface 488. Displaying a multitasking user interface without displaying a representation of a hidden application improves the privacy and security of the hidden application by preventing unauthorized users from viewing the hidden application in the multitasking user interface.

In some embodiments, the computer system detects (14082), via the one or more input devices, one or more inputs (e.g., one or more tap inputs, tap and hold inputs, air tap gestures, air pinch gestures, and/or other types of user inputs) corresponding to a request to display a multitasking user interface; and in response to detecting the one or more inputs corresponding to the request to display the multitasking user interface, the computer system displays, via the one or more output generation components, a multitasking user interface that includes one or more representations of applications that were recently open on the computer system, including: in accordance with a determination that the first application is in the unhidden state, the one or more representations include a first representation for the first application that includes an application identifier for the first application; and in accordance with a determination that the first application is in the hidden state, and less than a threshold amount of time (e.g., 1 minute, 3 minutes, 8 minutes, or other amount of time) has elapsed since the first application was last viewed, the one or more representations include a representation for the first application (e.g., the first representation or a second representation that obscures an identity of the first application and/or obscures content of the first application); and in accordance with a determination that the first application is in the hidden state, and more than the threshold amount of time has elapsed since the first application was last viewed, the one or more representations do not include a representation for the first application (e.g., the representation of the first application has been removed from the multitasking user interface after the threshold amount of time has elapsed). For example, as described with reference to FIG. 10AC, a representation of a hidden application that has been recently used (e.g., within the last 2 minutes, 5 minutes, 30 minutes, 1 hour, or another amount of time) is included in the multitasking user interface 488, while a representation of a hidden application that has not been recently used (e.g., within the last 2 minutes, 5 minutes, 30 minutes, 1 hour, or another amount of time) is not included in the multitasking user interface 488. Displaying a multitasking user interface without displaying a representation of a hidden application if the hidden application has not been recently viewed improves the privacy and security of the hidden application by preventing unauthorized users from viewing the hidden application in the multitasking user interface.

It should be understood that the particular order in which the operations in FIGS. 14A-14J have been described is merely an example and is not intended to indicate that the described order is the only order in which the operations could be performed. One of ordinary skill in the art would recognize various ways to reorder the operations described herein. Additionally, it should be noted that details of other processes described herein with respect to other methods described herein (e.g., method 13000) are also applicable in an analogous manner to method 14000 described above with respect to FIGS. 14A-14J. For example, the authentication information, one or more inputs, applications, locked states, and/or hidden states described above with reference to method 14000 optionally have one or more of the characteristics of the authentication information, one or more inputs, applications, locked states, and/or hidden states described herein with reference to other methods described herein (e.g., method 13000). For brevity, these details are not repeated here.

The operations described above with reference to FIGS. 13A-13F and 14A-14J are, optionally, implemented by components depicted in FIGS. 1A-1B. For example, detection operation 13002,-detecting operation 14002, and outputting operation 14006 are, optionally, implemented by event sorter 170, event recognizer 180, and event handler 190. Event monitor 171 in event sorter 170 detects a contact on touch-sensitive display 112, and event dispatcher module 174 delivers the event information to application 136-1. A respective event recognizer 180 of application 136-1 compares the event information to respective event definitions 186, and determines whether a first contact at a first location on the touch-sensitive surface (or whether rotation of the device) corresponds to a predefined event or sub-event, such as selection of an object on a user interface, or rotation of the device from one orientation to another. When a respective predefined event or sub-event is detected, event recognizer 180 activates an event handler 190 associated with the detection of the event or sub-event. Event handler 190 optionally uses or calls data updater 176 or object updater 177 to update the application internal state 192. In some embodiments, event handler 190 accesses a respective GUI updater 178 to update what is displayed by the application. Similarly, it would be clear to a person having ordinary skill in the art how other processes can be implemented based on the components depicted in FIGS. 1A-1B.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

What is claimed is:

1. A method, comprising:
at a computer system with one or more input devices and one or more output generation components:
detecting, via the one or more input devices, one or more inputs corresponding to a request from outside of a first application to access content corresponding to the first application; and
in response to detecting the request to access the content corresponding to the first application:
in accordance with a determination that the first application is in a locked state:
requesting authentication information from a user of the computer system; and
in response to receiving, via the one or more input devices, the authentication information and in accordance with a determination that the received authentication information is consistent with authorized authentication information, allowing access to the content corresponding to the first application without opening the first application; and
in accordance with a determination that the first application is in an unlocked state, allowing access to the content corresponding to the first application without requesting the authentication information from the user of the computer system and without opening the first application.

2. The method of claim 1, wherein the authentication information comprises biometric information from the user of the computer system.

3. The method of claim 1, further comprising, prior to detecting the one or more inputs corresponding to the request to access the content corresponding to the first application, causing presentation, via the one or more output generation components, of a notification from the first application; and
wherein the request to access the content corresponding to the first application comprises a user input corresponding to selection of the notification.

4. The method of claim 3, wherein the notification includes a subset of notification information from the first application without including other notification information from the first application.

5. The method of claim 3, wherein:
the notification is presented with one or more attributes;
in accordance with a determination that the first application is in the unlocked state, the notification is presented with a first set of values for the one or more attributes, the first set of values corresponding to the first application; and
in accordance with a determination that the first application is in the locked state, the notification is presented with a set of default values, wherein the set of default values are different than the first set of values.

6. The method of claim 1, wherein the content corresponding to the first application comprises a file folder.

7. The method of claim 1, wherein the one or more inputs corresponding to the request to access the content corresponding to the first application corresponds to a request to display a sharing user interface of a second application, and wherein the content corresponding to the first application comprises contact information for one or more potential recipients of shared information.

8. The method of claim 1, further comprising, in response to receiving, via the one or more input devices, the authentication information and in accordance with a determination that the received authentication information is inconsistent with the authorized authentication information, causing display, via the one or more output generation components, of a user interface that includes an option to retry authentication of the user.

9. The method of claim 1, wherein the first application is a files application configured to manage files of one or more other applications, including a third application; and
the method further comprises:
detecting, via the one or more input devices, one or more inputs corresponding to a second request from within the third application to access one or more files of the third application; and
in response to detecting the one or more inputs corresponding to the second request, allowing access to the one or more files of the third application regardless of whether the first application is in the locked state.

10. The method of claim 1, wherein the one or more inputs corresponding to the request to access the content corresponding to the first application is a request generated using a digital assistant executing at least in part on the computer system.

11. The method of claim 1, further comprising:
detecting, via the one or more input devices, one or more inputs corresponding to a request to activate the first application; and
in response to detecting the one or more inputs corresponding to the request to activate the first application:
in accordance with a determination that the first application is in the locked state, requiring second authentication information before allowing the first application to activate; and
in accordance with a determination that the first application is in the unlocked state, allowing the first application to activate without requesting the second authentication information from the user.

12. The method of claim 11, further comprising:
in response to detecting the one or more inputs corresponding to the request to activate the first application, displaying, via the one or more output generation components, a first portion of an indication that the first application has started to open; and
in accordance with the determination that the first application is in the locked state, requiring additional authentication before allowing the first application to activate comprises displaying, via the one or more output generation components, a second portion of the indication that the first application has started to open.

13. The method of claim 11, wherein the second authentication information is biometric authentication information; and
the method further comprises, in response to detecting the one or more inputs corresponding to the request to activate the first application and in accordance with the determination that the first application is in the locked state, automatically obtaining the biometric authentication information from the user.

14. The method of claim 11, further comprising, while receiving the second authentication information and/or determining whether the second authentication information is consistent with the authorized authentication information, causing display, via the one or more output generation components, of an authentication status user interface that indicates a status of an authentication process corresponding to the second authentication information.

15. The method of claim 14, wherein the authentication status user interface is displayed overlaid over at least a portion of a user interface of the first application.

16. The method of claim 14, wherein the authentication status user interface is displayed within a status region that displays information about one or more operations currently being performed by the computer system.

17. The method of claim 1, further comprising:
after authenticating the user, detecting, via the one or more input devices, one or more inputs corresponding to a third request to access the content corresponding to the first application; and
in response to detecting the one or more inputs corresponding to the third request:
in accordance with a determination that less than a threshold amount of time has passed since authenticating the user, allowing access to the content corresponding to the first application without requesting additional authentication information from the user; and
in accordance with a determination that more than the threshold amount of time has passed since authenticating the user:
requesting second authentication information from the user; and
in response to receiving, via the one or more input devices, the second authentication information and in accordance with a determination that the second authentication information is consistent with authorized authentication information, allowing access to the content corresponding to the first application.

18. The method of claim 17, further comprising:
while the computer system is in the locked state, requesting biometric information from the user of the computer system in response to detecting, via the one or more input devices, an input corresponding to a request to unlock the computer system; and
in response to receiving, via the one or more input devices, the biometric information from the user and in accordance with a determination that the received biometric information is consistent with authorized biometric information, unlocking the computer system and authenticating the user.

19. The method of claim 18, further comprising:
in response to receiving, via the one or more input devices, the biometric information from the user and in accordance with a determination that the received biometric information is not consistent with authorized biometric information, maintaining the computer system in the locked state.

20. The method of claim 1, further comprising:
causing display, via the one or more output generation components, of an icon for the first application on a first user interface;
detecting, via the one or more input devices, a first user input directed to the icon; and
in response to detecting the first user input:
in accordance with a determination that the first user input is a first type of input, causing display, via the one or more output generation components, of an option to activate the locked state for the first application; and
in accordance with a determination that the first user input is not the first type of input, forgoing causing display of the option to activate the locked state for the first application.

21. The method of claim 1, further comprising:
causing display, via the one or more output generation components, of an icon for the first application on a first user interface;
detecting, via the one or more input devices, a first user input directed to the icon; and
in response to detecting the first user input:
in accordance with a determination that the first user input is a first type of input, causing display, via the one or more output generation components, of an option to activate the unlocked state for the first application; and
in accordance with a determination that the first user input is not the first type of input, forgoing causing display of the option to activate the locked state for the first application.

22. The method of claim 1, further comprising:
detecting, via the one or more input devices, one or more inputs corresponding to a request to activate the locked state for the first application;
in response to detecting the one or more inputs corresponding to request to activate the locked state, causing display, via the one or more output generation components, of a user interface with information indicating a set of applications that use data from the first application.

23. The method of claim 22, wherein the user interface with information indicating the set of applications that use the data from the first application further comprises a set of selectable elements configured to lock respective applications of the set of applications; and
the method further includes:
detecting, via the one or more input devices, a second user input at a location corresponding to a selectable element for a fourth application; and
in response to detecting the second user input at the location corresponding to the selectable element for the fourth application, activating the locked state for the fourth application.

24. The method of claim 1, further comprising causing display, via the one or more output generation components, of an icon for the first application on a home screen user interface, wherein:
in accordance with a determination that the first application is in the locked state, causing the icon to be displayed with a first set of one or more attributes; and
in accordance with a determination that the first application is in the unlocked state, causing the icon to be displayed with a second set of one or more attributes that is different than the first set of one or more attributes.

25. The method of claim 1, further comprising, in accordance with activating the locked state for the first application, activating the locked state for one or more widgets corresponding to the first application.

26. The method of claim 1, further including:
detecting, via the one or more input devices, one or more inputs corresponding to a request to perform a system operation for which content corresponding to the first application is contextually relevant;
in response to detecting the one or more inputs corresponding to a request to perform the system operation, outputting, via the one or more output generation components, a result of the system operation, including:
in accordance with a determination that the first application is in the locked state, outputting, via the one or more output generation components, a result of the system operation using content from one or more sources other than the first application without using the content corresponding to the first application; and
in accordance with a determination that the first application is in the unlocked state, outputting, via the one or more output generation components, a result of the system operation using content from the one or more sources other than the first application and also using the content corresponding to the first application.

27. A computer system, comprising:
one or more input devices;
one or more output generation components;
one or more processors; and
memory storing one or more programs, wherein the one or more programs are configured to be executed by the one or more processors, the one or more programs including instructions for:
detecting, via the one or more input devices, one or more inputs corresponding to a request from outside of a first application to access content corresponding to the first application; and
in response to detecting the request to access the content corresponding to the first application:
in accordance with a determination that the first application is in a locked state:
requesting authentication information from a user of the computer system; and
in response to receiving, via the one or more input devices, the authentication information and in accordance with a determination that the received authentication information is consistent with authorized authentication information, allowing access to the content corresponding to the first application without opening the first application; and
in accordance with a determination that the first application is in an unlocked state, allowing access to the content corresponding to the first application without requesting the authentication information from the user of the computer system and without opening the first application.

28. A computer readable storage medium storing one or more programs, the one or more programs comprising instructions that, when executed by a computer system with one or more input devices and one or more output generation components, cause the computer system to perform operations including:
detecting, via the one or more input devices, one or more inputs corresponding to a request from outside of a first application to access content corresponding to the first application; and
in response to detecting the request to access the content corresponding to the first application:
in accordance with a determination that the first application is in a locked state:
requesting authentication information from a user of the computer system; and
in response to receiving, via the one or more input devices, the authentication information and in accordance with a determination that the received authentication information is consistent with authorized authentication information, allowing access to the content corresponding to the first application without opening the first application; and
in accordance with a determination that the first application is in an unlocked state, allowing access to the content corresponding to the first application without requesting the authentication information from the user of the computer system and without opening the first application.
